(19) United States
(12) Patent Application Publication
(10) Pub. No.: US 2023/0371568 A1
(43) Pub. Date: Nov. 23, 2023

(54) FOOD PRODUCTION SYSTEM, COMPOSITIONS, AND METHODS OF USING THE SAME

(71) Applicant: ARIZONA BOARD OF REGENTS ON BEHALF OF ARIZONA STATE UNIVERSITY, Scottsdale, AZ (US)

(72) Inventors: Ivan Ermanoski, Scottsdale, AZ (US); Ellen B. Stechel, Scottsdale, AZ (US)

(21) Appl. No.: 18/199,277

(22) Filed: May 18, 2023

Related U.S. Application Data
(60) Provisional application No. 63/343,248, filed on May 18, 2022.

(51) Int. Cl. A23L 31/00

(52) U.S. Cl. CPC A23L 31/00

(57) ABSTRACT

This invention is directed to systems, compositions, and methods of producing food.

This application claims priority from U.S. Provisional Application No. 63/343,248 filed on May 18, 2022, the entire contents of which are incorporated herein by reference.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF THE INVENTION

This invention is directed to systems, compositions, and methods of producing food.

### BACKGROUND OF THE INVENTION

The human food system is photosynthesis-based. In other words, food calories consumed by humans today originate as plant (i.e., photosynthetic) matter/biomass. Examples are plant foods (e.g., grains, cereals, tubers, fruits, etc.), which are produced via the photosynthesis process, and account for the majority of the world's calorie intake. Photosynthetic biomass is used as feed for livestock or as substrate for fungi or forms the basis of the marine food chain—part of the human civilization food system. Whilst there is a perception that domestic animals are the most inefficient link in the human food chain, photosynthesis in plants is responsible for the majority of the energy loss going from sunlight to edible calories.

### SUMMARY OF THE INVENTION

Aspects of the invention are drawn towards a non-biomass nutrient-cultivating substrate comprising an inorganic carrier material and an abiotic nutrient mixture, wherein the nutrient mixture comprises water and at least one non-biomass carbon source. In embodiments, the inorganic carrier material comprises a porous material. In embodiments, the inorganic carrier material comprises mineral wool, zeolite, mesoporous metal oxides, fiberglass, vermiculite, a synthetic polymer, or a combination thereof. In embodiments, the synthetic polymer comprises polyurethane. In embodiments, the nutrient mixture further comprises a nitrogen source, a promoter, an emulsifier, a micronutrient source, an acidifier, or a combination thereof. In embodiments, the carbon source comprises a hydrocarbon. In embodiments, the hydrocarbon comprises mineral oil, paraffin, petroleum, a petroleum product, or a combination thereof. In embodiments, the nitrogen source comprises urea. In embodiments, the micronutrient source comprises an iron source, a phosphorus source, a calcium source, a potassium source, a sodium source, a chloride source, a magnesium source, a zinc source, an iodine source, a sulfur source, a cobalt source, a copper source, a fluoride source, a manganese source, a selenium source, a boron source, or a combination thereof. In embodiments, the promoter comprises non-biomass vanillin, iron, or a combination thereof. In embodiments, the acidifier comprises ferrous sulfate.

Aspects of the invention are drawn towards a nutrient production system comprising an inorganic carrier material, an abiotic nutrient mixture, and a metabolization source, wherein the abiotic nutrient mixture comprises water and at least one non-biomass carbon source. In embodiments, the inorganic carrier material comprises mineral wool, zeolite, mesoporous metal oxides, fiberglass, vermiculite, or a synthetic polymer. In embodiments, the abiotic nutrient mixture further comprises a nitrogen source, a promoter, an emulsifier, a mineral source, or a combination thereof. In embodiments, the metabolization source comprises source comprises a saprophytic organism. In embodiments, the saprophytic organism comprises mold, mushroom, yeast, penicillium, and mucor, or a combination thereof. In embodiments, the mushroom comprises an oyster mushroom, Pleurotus ostreatus, Pleurotus pulmonarius, Ganoderma lucidum, Pleurotus columbinus, Pleurotus diamor, Pleurotus eryngii, Amillaria gallica, Cantharellus cibarius, honey mushroom, white-rot fungi, Lentinula edodes, or a shiitake mushroom.

Aspects of the invention are drawn towards a method of producing a food product, the method comprising: producing the nutrient mixture described herein, wherein the nutrient mixture comprises a non-biomass carbon source; soaking the inorganic carrier material described herein in the nutrient mixture to create a cultivation substrate; and cultivating at least one saprophytic organism on the cultivation substrate, wherein the saprophytic organism metabolizes the cultivation substrate to produce a food product. In embodiments, the food product comprises the saprophytic organism, a derivative thereof, or a product thereof. In embodiments, the derivative or product thereof comprises an oil, a liquid, a gel, a powder, or a combination thereof.

In some embodiments, disclosed is a non-photosynthetic nutrient-cultivating substrate comprising an inorganic carrier material and an abiotic nutrient mixture, wherein the abiotic nutrient mixture comprises water and at least one synthetically produced carbon-containing compound. The substrate can be a porous material. In some embodiments, the substrate is mineral wool, zeolite, mesoporous metal oxides, fiberglass, vermiculite, pumice, and the like. In some embodiments, the abiotic nutrient mixture can also comprise a mineral source. In some embodiments, the synthetically produced carbon-containing compound comprises a hydrocarbon, an alcohol, carboxylic acid, an amide, an amine, an aldehyde, a polyol, an alkane, an alkene, an alkyne, an ether, an ester, a ketone, a carbohydrate, or a combination thereof. The synthetically produced carbon-containing compound can be derived from an inorganic carbon source, an inorganic hydrogen source, an inorganic nitrogen source, or a combination thereof. The inorganic sources can be chemically reacted to produce the carbon-containing compound. In some embodiments, the inorganic sources are chemically reacted using a Fischer-Tropsch process, a Sabatier reaction, Methanation, a Haber-Bosch process, water splitting, or a Birkeland-Eyde process. The inorganic carbon source can be derived from carbon dioxide, carbon monoxide, cyanide, cyanate, carbonate, a carbon allotrope, or a combination thereof. The inorganic hydrogen source can be derived from dihydrogen monoxide, hydrogen monoxide, or a combination thereof. The inorganic nitrogen source can be derived from dinitrogen. The mineral source can comprise micronutrients, triple superphosphate, iron, phosphorus, potassium, potash, or a combination thereof. The synthetically produced carbon-containing compound can comprise propylene glycol, n-alkanes, and paraffin. In some embodiments, the substrate comprises a carbon to nitrogen ratio of about 20:1 to about 200:1. In some embodiments, the substrate comprises about 66% water, about 17% mineral wool, about 7% peptone, about 8% propylene glycol, and wherein the remaining 2% comprises micronutrients, potash, triple superphosphate, or a combination thereof. The substrate can comprise about 66.38% water, about 17.12% mineral wool, about 0.58% micronutrients, about 0.16% potash, about 0.03% triple superphosphate, about 7.44% peptone, and about 8.29% propylene glycol. The substrate can comprise about 48.38% paraffin, about 42.33% water, about 8.47 mineral wool, about 0.45% urea, about 0.28% micronutrients, about 0.08% potash, and about 0.01% diammonium phosphate. The substrate can comprise about 48.12% paraffin, about 42.10% water, about 8.42% mineral wool, about 0.99% ammonium sulfate, about 0.28% micronutrients, about 0.08% muriate of potash, and about 0.01% diammonium phosphate.

Also disclosed are methods for producing a food product without photosynthesis. In some embodiments, the method comprises producing a nutrient mixture, wherein the nutrient mixture comprises a synthetically fabricated carbon source; soaking an inorganic carrier material in the nutrient mixture to create a cultivation substrate; and cultivating at least one saprophytic organism on the cultivation substrate, wherein the saprophytic organism metabolizes the cultivation substrate to create a food product. The saprophytic organism can be mold, mushroom, yeast, penicillium, mucor, or combinations thereof. A mushroom can comprise an oyster mushroom, Pleurotus ostreatus, Pleurotus pulmonarius, Ganoderma lucidum, Pleurotus columbinus, Pleurotus diamor, Pleurotus eryngii, Amillaria gallica, Cantharellus cibarius, honey mushroom, white-rot fungi, Lentinula edodes, shiitake mushroom, and the like. The nutrient mixture can comprise micronutrients, triple superphosphate, iron, phosphorus, potassium, potash, or a combination thereof. The organic carrier material can comprise mineral wool zeolite, mesoporous metal oxides, fiberglass, vermiculite, or pumice. The food product can comprise the saprophytic organism, a derivative thereof, or a product thereof. The derivative or product thereof can comprise oils, liquids, gels, or powders.

Also disclosed are methods of using inorganic matter to create a food source. The method can comprise subjecting an inorganic feedstock to an energy source to create an organic feedstock; and feeding the organic feedstock to an organism that is capable of metabolizing the organic feedstock into a food source. The energy source can be solar energy or non-solar energy. The non-solar energy can be nuclear energy, wind energy, geothermal energy, or hydropower. The inorganic feedstock can comprise CO₂, H₂O, N₂, or a combination thereof. The saprophytic organism can be mold, mushroom, yeast, penicillium, and mucor, or a combination thereof. The mushroom can comprise an oyster mushroom the mushroom comprises an oyster mushroom, Pleurotus ostreatus, Pleurotus pulmonarius, Ganoderma lucidum, Pleurotus columbinus, Pleurotus diamor, Pleurotus eryngii, Amillaria gallica, Cantharellus cibarius, honey mushroom, white-rot fungi, Lentinula edodes, or a shiitake mushroom. The food source can comprise the organism, a derivative thereof, or a product thereof. The derivative or product thereof can comprise oils, liquids, gels, or powders.

Also disclosed are nutrient production systems. These systems can comprise an inorganic carrier material, an abiotic nutrient mixture, and a metabolization source, wherein the abiotic nutrient mixture comprises water and at least one synthetically produced carbon-containing compound. The inorganic carrier material can comprise mineral wool, zeolite, mesoporous metal oxides, fiberglass, vermiculite, or pumice. The abiotic nutrient mixture can be a mineral source. The synthetically produced carbon-containing compound can comprise a hydrocarbon, an alcohol, carboxylic acid, an amide, an amine, an aldehyde, a polyol, an alkane, an alkene, an alkyne, an n-alkane, an ether, an ester, a ketone, a carbohydrate, or a combination thereof. The synthetically produced carbon-containing compound can be derived (e.g., by conducting a chemical reaction or series thereof) from an inorganic carbon source, an inorganic hydrogen source, an inorganic nitrogen source, or a combination thereof. In embodiments, the chemical reaction or series of reactions can comprise a Fischer-Tropsch process, a Sabatier reaction, Methanation, a Haber-Bosch process, water splitting, or a Birkeland-Eyde process. The inorganic carbon source can be derived from carbon dioxide, carbon monoxide, cyanide, cyanate, carbonate, a carbon allotrope, or a combination thereof. The inorganic hydrogen source can be derived from dihydrogen monoxide, hydrogen monoxide, or a combination thereof. The inorganic nitrogen source can be derived from dinitrogen. The mineral source can comprise micronutrients, triple superphosphate, iron, phosphorus, potassium, potash, or a combination thereof. The synthetically produced carbon-containing compound can comprise propylene glycol and n-alkane. The n-alkane can comprise paraffin, n-icosane, n-henicosane, n-docosane, n-tricosane, n-tetracosane, n-pentacosane, n-hexacosane, n-heptacosane, n-octacosane, n-nonacosane, n-triacontane, n-hentriacontane, n-dotriacontane, n-tritriacontane, n-tetratriacontane, n-pentatriacontane, n-hexatriacontane, n-heptatriacontane, n-octatriacontane, n-nonatriacontane, and n-tetracontane or a combination thereof. The substrate can comprise a carbon to nitrogen ratio of about 20:1 to about 200:1. The substrate can comprise about 66% water, about 17% mineral wool, about 7% peptone, about 8% propylene glycol, and wherein the remaining 2% comprises micronutrients, potash, triple superphosphate, or a combination thereof. The substrate can comprise about 66.39% water, 17.12% mineral wool, 0.58% micronutrients, 0.16% potash, 0.03% triple superphosphate, 7.44% peptone, 8.29% propylene glycol. The substrate can comprise about 48.38% paraffin, about 42.33% water, about 8.47 mineral wool, about 0.45% urea, about 0.28% micronutrients, about 0.08% potash, and about 0.01% diammonium phosphate. The substrate can comprise about 48.12% paraffin, about 42.10% water, about 8.42% mineral wool, about 0.99% ammonium sulfate, about 0.28% micronutrients, about 0.08% muriate of potash, and about 0.01% diammonium phosphate. The metabolization source can comprise a saprophytic organism. The saprophytic organism can comprise mold, mushroom, yeast, penicillium, and mucor, or a combination thereof. The mushroom can comprise an oyster mushroom, Pleurotus ostreatus, Pleurotus pulmonarius, Ganoderma lucidum, Pleurotus columbinus, Pleurotus diamor, Pleurotus eryngii, Amillaria gallica, Cantharellus cibarius, honey mushroom, white-rot fungi, Lentinula edodes, or a shiitake mushroom.

Also disclosed is an abiotic nutrient mixture or organic feedstock as disclosed above.

Other objects and advantages of this invention will become readily apparent from the ensuing description.

### BRIEF DESCRIPTION OF THE FIGURES

FIG. 1 shows a schematic illustrating a non-limiting example of the non-photosynthetic food system. While the system does not exclude the possibility of a photosynthetic-based component, it does not require it.

FIG. 2 panels A-H each show a digital photograph of a non-limiting example of inoculated substrate.

### DETAILED DESCRIPTION OF THE INVENTION

Aspects of the invention are drawn a non-photosynthetic food system which can produce food for human and animal consumption without the use of photosynthesis.

Detailed descriptions of one or more preferred embodiments are provided herein. It is to be understood, however, that the present invention can be embodied in various forms. Therefore, specific details disclosed herein are not to be interpreted as limiting, but rather as a basis for the claims and as a representative basis for teaching one skilled in the art to employ the present invention in any appropriate manner.

The singular forms “a”, “an” and “the” include plural reference unless the context clearly dictates otherwise. The use of the word “a” or “an” when used in conjunction with the term “comprising” in the claims and/or the specification can mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly, “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c. Wherever the terms “a” or “an” are used, “one or more” is understood, unless such interpretation is nonsensical in context.

As used herein the term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

Non-Biomass Food System & Products Thereof

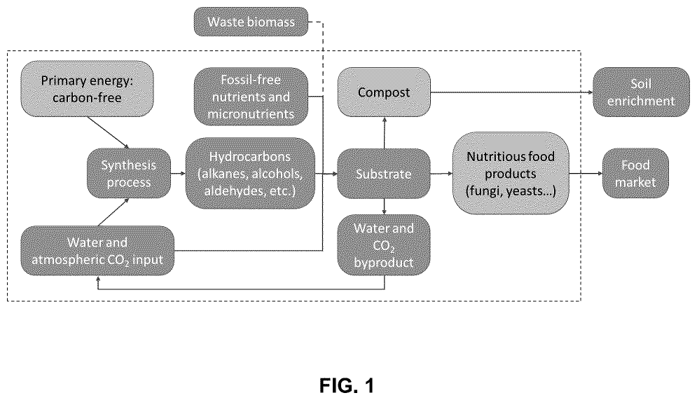

Aspects of the invention are directed towards a non-photosynthetic food system (see FIG. 1). As used herein, the term “non-photosynthetic” can refer to not involving or not requiring photosynthesis. As used herein, the term “photosynthesis” can refer to the process by which plants and organisms use sunlight to synthesize foods (e.g., glucose) from carbon dioxide and water. For example, photosynthesis can convert light energy into chemical energy. For example, plants and other organisms can convert carbon dioxide, water, and inorganic salts into carbohydrates. In embodiments, non-photosynthetic can refer to converting water, carbon dioxide, and/or other inorganically and/or non-biomass sourced compounds into carbohydrates, nutrients, and/or food without employing photosynthesis. As used herein, the term “non-photosynthetically derived” can refer to a process or substance that is not require photosynthesis.

Aspects of the invention are drawn towards a non-biomass foody system. As used herein, the term “biomass” can refer to carbonaceous material derived from modern living organisms (e.g., living within the past 100 years), comprising plant-based biomass and animal-based biomass. As used herein, the term “modern living organisms” can refer to organisms that were living within about the last 100 years. For example, biomass does not include fossil-based carbonaceous materials such as coal, petroleum, petroleum products, natural gas, or a combination thereof. As used herein, the term “non-biomass” can refer to carbonaceous materials not encompassed by the term “biomass” as described herein. For example, non-biomass comprises anthracite, bituminous coal, subbituminous coal, lignite, petroleum coke, asphaltenes, petroleum, natural gas, petroleum products, liquid petroleum residues, or combinations thereof. As used herein, the term “organic” can refer to a substance derived from living organisms. As used herein, the terms “inorganic” can refer to a substance not consisting of or deriving from modern living matter (e.g., living within the past 100 years). As used herein, the term “modern living matter” can refer to material that was living within about the last 100 years. As used herein, inorganic compounds described herein can refer to compounds which contain carbons and/or carbon-hydrogen bonds but are not derived from modern living matter. In embodiments, inorganic compounds described herein can refer to compounds that contain carbon and/or carbon-hydrogen bonds or compounds that do not contain carbon and/or carbon-hydrogen bonds if they are not derived from modern living matter (e.g., living within the past 100 years).

Aspects of the invention are drawn towards a non-photosynthetic food system. As used herein, the terms “food system” and “system” can be used interchangeably. As used herein, the term “food system” can refer to compositions, processes, and products thereof for cultivating, generating, and/or producing food. As used herein, the term “food” can refer to a substance that is ingested, drank, eaten, or otherwise taken into the body to sustain life, provide energy, and/or promote growth. As used herein, the terms “food” and “nutrient” can be used interchangeably. For example, the term “nutrient” can refer to a substance that can be used by an organism to survive, grow, and/or reproduce.

Aspects of the invention are drawn towards a food system which utilizes a non-photosynthetically derived nutrient-cultivating substrate. Aspects of the invention are drawn towards a food system which utilizes a non-biomass nutrient-cultivating substrate. As used herein, the terms “nutrient-cultivating substrate”, “substrate”, “nutrient substrate”, and “cultivating substrate” can be used interchangeably. As used herein, the term “derive” can refer to producing or obtaining from a source. For example, derive can refer to receiving or obtaining from a source or origin. In embodiments, deriving can comprise conducting a chemical reaction or series of chemical reactions. As used herein, the term “non-photosynthetically derived” can refer to any product of a process that does not involve or require photosynthesis. As used herein, the term “non-biomass” derived can refer to any product of a process that does not involve and/or require biomass. In embodiments, the food system comprises an inorganic carrier material, a non-biomass carrier material, a non-biomass nutrient mixture, an abiotic nutrient mixture, a metabolization source, or a combination thereof.

As used herein, the term “substrate” can refer to a material, platform, or medium for a process or system. For example, the process is food cultivation. For example, the substrate can be used to cultivate food. In embodiments, the substrate comprises an inorganic carrier material, a non-biomass carrier material, a non-biomass nutrient mixture, an abiotic nutrient mixture, or a combination thereof.

As used herein, the term “carrier material” can refer to a material which provides an environment for inoculants (e.g., saprophytic organisms) to grow and/or cultivate. In embodiments, the carrier material can comprise a porous material. In embodiments, the carrier material can comprise a non-porous material. As used herein, the term “porous” can refer to possessing pores and/or possessing void space. In embodiments, porous can refer to a material that can be permeable by air or water. As used herein, the term “porosity” can refer to the fraction of void space within a porous article. In embodiments, the carrier material can comprise a high-surface area material. As used herein, the term “surface area” can refer to the total area the surface of an object occupies. In embodiments, the material can comprise a high surface area per unit of material. As used herein, the term “surface area” can refer to “specific surface area”. For example, “specific surface area” can refer to the surface area of a material per unit of mass. As used herein, the term “high surface area” can refer to about 0.1 m²/g to about 10 m²/g. In embodiments, surface area can be determined by Brunauer-Emmett-Teller (BET) surface area analysis. For example, the carrier material can provide a high-surface area environment to hold nutrients and water in a dispersed state. In embodiments, the carrier material can absorb the nutrients and water.

As used herein the term “inorganic” can refer to not comprising of or being derived from modern living matter. Herein, the carrier material described can be inorganic. Herein, the carrier material can be non-biomass substance. As used herein, the term “non-biomass substance” can refer to a material that is not produced from modern living organisms (e.g., living within the past 100 years), comprising plant-based biomass and animal-based biomass. Herein, the carrier material can be abiotic. As used herein, the term “abiotic” can refer to a non-living material. In embodiments, the carrier material comprises mineral wool, zeolite, mesoporous metal oxides, fiber glass, vermiculite, pumice, a synthetic polymer, or another porous, abiotic material. In embodiments the synthetic polymer comprises an inorganic polymer, an organic polymer, or a copolymer thereof. In embodiments, the polymer comprises a fluoropolymer, a polyanhydride, a polyketone, a polyester, a polyolefin, a vinyl polymer, or a combination thereof. In embodiments, the polymer comprises a polyethylene, a polyurethane, a polypropylene, a polystyrene, a polyvinyl chloride, a synthetic rubber, a neoprene, a nylon, a polyacrylonitrile, a silicone, a phenol formaldehyde resin, a polyvinyl butyral, or a copolymer thereof.

As used herein, the term “abiotic” can refer to a factor or component that is not derived from modern living organisms (e.g., living within the past 100 years). As used herein, the term “abiotic nutrient mixture” can refer to a nutrient mixture that is not derived from modern living organisms (e.g., living within the past 100 years).

In embodiments, the abiotic nutrient mixture comprises water and at least one synthetically produced and/or non-biomass carbon source. In embodiments, the carbon source comprises a carbon-containing compound, a carbon-containing composition, or a combination thereof. In embodiments, the abiotic nutrient mixture comprises non-biomass nutrients. For example, the non-biomass nutrients can comprise vanillin, potash, diammonium phosphate, urea, peptone, a boron source, a calcium source, a copper source, an iron source, a magnesium source, a manganese source, a zinc source, or any combination thereof. As used herein, the term “synthetically produced” can refer to anything produced artificially. As used herein, the term “artificially” can refer to something that occurs by means of human intervention rather than occurring naturally. For example, synthetically produced can refer to something that is produced by chemical synthesis or a chemical reaction.

In embodiments, the carbon source can refer to a hydrocarbon, an alcohol, carboxylic acid, a carbohydrate, an amide, an amine, an aldehyde, a polyol, an alkane, an alkene, an alkyne, an ether, an ester, a ketone, a carbohydrate, or a combination thereof. In embodiments, the alkane comprises n-alkanes. In embodiments, the n-alkane comprises n-icosane, n-henicosane, n-docosane, n-tricosane, n-tetracosane, n-pentacosane, n-hexacosane, n-heptacosane, n-octacosane, n-nonacosane, n-triacontane, n-hentriacontane, n-dotriacontane, n-tritriacontane, n-tetratriacontane, n-pentatriacontane, n-hexatriacontane, n-heptatriacontane, n-octatriacontane, n-nonatriacontane, and n-tetracontane. In embodiments, the carbon source comprises paraffin, mineral oil (baby oil), petroleum, and petroleum products. As used herein, paraffin can comprise a mixture of n-alkanes. In embodiments, the carbon-containing compound can be derived from a non-biomass source, an inorganic carbon source, a non-biomass hydrogen source, an inorganic hydrogen source, an inorganic nitrogen source, a non-biomass nitrogen source, or a combination thereof. As used herein, the term “inorganic carbon” can refer to carbon that is not derived from organic sources. For example, the carbon is derived from a reaction of abiotic compounds. For example, the carbon is extracted from ores and minerals. In embodiments, the carbon is derived from a non-biomass source. As used herein, the term “non-biomass carbon” can refer to carbon which is not derived from derived from modern living organisms (e.g., within the past 100 years), comprising plant-based biomass and animal-based biomass. For example, the carbon source is derived from petroleum or coal. For example, the carbon source comprises graphene, xylitol, mannitol, maltitol, sorbitol, propylene glycol, ethylene glycol, and hydroquinone. Non-limiting examples of carbon are carbon oxides such as carbon monoxide and carbon dioxide; polyatomic ions, cyanide, cyanate, thiocyanate, carbonate and carbide in carbon. In embodiments, the inorganic carbon source is derived from carbon dioxide, carbon monoxide, cyanide, cyanate, carbonate, a carbon allotrope, or a combination thereof.

In embodiments, the carbon source comprises less than about 0.0001%, about 0.0001%, about 0.0025%, about 0.003%, about 0.004%, about 0.005%, about 0.006%, about 0.007%, about 0.008%, about 0.009%, about 0.010%, about 0.015%, about 0.02%, about 0.025%, about 0.03%, about 0.035%, about 0.04%, about 0.045%, about 0.05%, about 0.055%, about 0.06%, about 0.065%, about 0.07%, about 0.075%, about 0.08%, about 0.085%, about 0.09%, about 0.095%, about 0.1%, about 0.15%, about 0.2%, about 0.25%, about 0.3%, about 0.35%, about 0.4%, about 0.45%, about 0.5%, about 0.55%, about 0.6%, about 0.65%, about 0.7%, about 0.75%, about 0.8%, about 0.85%, about 0.9%, about 0.95%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7% about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 5%, about 6%, about 7%, about 8%, about 9%, about 10%, about 11%, about 12%, about 13%, about 14%, about 15%, about 20%, about 21%, about 22%, about 23%, about 24%, about 25%, or greater than about 25% of the water in the nutrient mixture.

In embodiments, the nutrient mixture comprises a nitrogen source. In embodiments, the nitrogen source is non-biomass nitrogen source. For example, the non-biomass nitrogen source comprises a nitrogen containing compound or nitrogen containing composition. For example, the non-biomass nitrogen source can comprise urea, diammonium phosphate, ammonia, ammonium citrate, ammonium nitrate, potassium nitrate, or a combination thereof. In some embodiments, the media can be supplemented with peptone. In embodiments, the nitrogen source can be derived from dinitrogen. In embodiments, inorganic hydrogen source can be derived from dihydrogen monoxide, hydrogen monoxide, or a combination thereof.

In embodiments, the nitrogen source comprises less than about 0.0001%, about 0.0001%, about 0.0025%, about 0.003%, about 0.004%, about 0.005%, about 0.006%, about 0.007%, about 0.008%, about 0.009%, about 0.010%, about 0.015%, about 0.02%, about 0.025%, about 0.03%, about 0.035%, about 0.04%, about 0.045%, about 0.05%, about 0.055%, about 0.06%, about 0.065%, about 0.07%, about 0.075%, about 0.08%, about 0.085%, about 0.09%, about 0.095%, about 0.1%, about 0.15%, about 0.2%, about 0.25%, about 0.3%, about 0.35%, about 0.4%, about 0.45%, about 0.5%, about 0.55%, about 0.6%, about 0.65%, about 0.7%, about 0.75%, about 0.8%, about 0.85%, about 0.9%, about 0.95%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7% about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 5%, about 6%, about 7%, about 8%, about 9%, about 10%, about 11%, about 12%, about 13%, about 14%, about 15%, about 20%, about 21%, about 22%, about 23%, about 24%, about 25%, or greater than about 25% of the carbon source by atom count.

In embodiments, the one or more carbon sources can be used as the only carbon source by the metabolization sources described herein. In some embodiments, the non-biomass and/or inorganic carbon-containing compounds can be used in combination with other carbon sources in the systems disclosed herein.

In embodiments, the carbon source can be derived from a chemical reaction or series thereof. For example, the chemical reaction or series thereof can comprise Fischer-Tropsch process, Sabatier reaction, Methanation, Haber-Bosch process, water splitting, Birkeland-Eyde process, a nitrogen fixation process, or a carbon fixation process. In embodiments, the carbon source is generated from a reaction or series of reactions that can generate a carbon-containing compound from an abiotic source.

In embodiments, if hydrocarbons are available, they can be used with or without further reactions. In embodiments, the hydrocarbons can be petroleum products and/or petroleum byproducts.

In embodiments, the non-biomass and/or synthetically produced carbon source can comprise propylene glycol, paraffin, n-icosane, n-henicosane, n-docosane, n-tricosane, n-tetracosane, n-pentacosane, n-hexacosane, n-heptacosane, n-octacosane, n-nonacosane, n-triacontane, n-hentriacontane, n-dotriacontane, n-tritriacontane, n-tetratriacontane, n-pentatriacontane, n-hexatriacontane, n-heptatriacontane, n-octatriacontane, n-nonatriacontane, and n-tetracontane.

In embodiments, the nutrient mixture can further comprise a micronutrient source. For example, the micronutrient source can comprise a micronutrient mixture, an individual micronutrient, or a combination thereof. As used herein, the term “micronutrient” can refer to vitamins and minerals. As used herein, the terms “micronutrient” and “mineral” can be used interchangeably. As used herein, the term “mineral” can refer to a compound or a composition. In embodiments, the micronutrient can comprise one or more inorganic species. For example, micronutrient can comprise calcium, phosphorus, potassium, sodium, chloride, magnesium, iron, zinc, iodine, sulfur, cobalt, copper, fluoride, manganese, selenium, or any compound containing an atom or ion thereof. In embodiments, the micronutrient can comprise triple superphosphate, iron, phosphorus, potassium, potash, or a combination thereof.

In some embodiments, the micronutrient mixture can comprise less than about 0.001%, about 0.001%, about 0.05%, about 0.1%, about 0.15%, about 0.2%, about 0.25%, about 0.3%, about 0.35%, about 0.4%, about 0.45%, about 0.5%, about 0.55%, about 0.6%, about 0.65%, about 0.7%, about 0.75%, about 0.8%, about 0.85%, about 0.9%, about 0.95%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7% about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 5%, about 6%, about 7%, about 8%, about 9%, about 10%, about 11%, about 12%, about 13%, about 14%, about 15%, about 20%, about 21%, about 22%, about 23%, about 24%, about 25%, or greater than about 25% of the elements contained in the micronutrient mixture.

In embodiments, the micronutrient mixture can comprise less than about 0.0001%, about 0.0001%, about 0.0025%, about 0.003%, about 0.004%, about 0.005%, about 0.006%, about 0.007%, about 0.008%, about 0.009%, about 0.010%, about 0.015%, about 0.02%, about 0.025%, about 0.03%, about 0.035%, about 0.04%, about 0.045%, about 0.05%, about 0.055%, about 0.06%, about 0.065%, about 0.07%, about 0.075%, about 0.08%, about 0.085%, about 0.09%, about 0.095%, about 0.1%, about 0.15%, about 0.2%, about 0.25%, about 0.3%, about 0.35%, about 0.4%, about 0.45%, about 0.5%, about 0.55%, about 0.6%, about 0.65%, about 0.7%, about 0.75%, about 0.8%, about 0.85%, about 0.9%, about 0.95%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7% about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 5%, about 6%, about 7%, about 8%, about 9%, about 10%, about 11%, about 12%, about 13%, about 14%, about 15%, about 20%, about 21%, about 22%, about 23%, about 24%, about 25%, or greater than about 25% of the water in the nutrient mixture by weight.

In embodiments, the nutrient mixture can further comprise a promoter. As used herein, the term “promoter” can refer to a growth promoter. For example, the promoter can increase size, amount, and development of a metabolization source described herein. The promoter described herein can encompass any non-biomass compound or composition that increases the size, amount, and/or development of metabolization source and/or food product. In some embodiments, the promoter can comprise vanillin, iron, or a combination thereof. For example, the vanillin can comprise a synthetically produced vanillin.

In embodiments, the promoter can comprise less than about 0.0001%, about 0.0001%, about 0.0025%, about 0.003%, about 0.004%, about 0.005%, about 0.006%, about 0.007%, about 0.008%, about 0.009%, about 0.010%, about 0.015%, about 0.02%, about 0.025%, about 0.03%, about 0.035%, about 0.04%, about 0.045%, about 0.05%, about 0.055%, about 0.06%, about 0.065%, about 0.07%, about 0.075%, about 0.08%, about 0.085%, about 0.09%, about 0.095%, about 0.1%, about 0.15%, about 0.2%, about 0.25%, about 0.3%, about 0.35%, about 0.4%, about 0.45%, about 0.5%, about 0.55%, about 0.6%, about 0.65%, about 0.7%, about 0.75%, about 0.8%, about 0.85%, about 0.9%, about 0.95%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7% about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 5%, about 6%, about 7%, about 8%, about 9%, about 10%, about 11%, about 12%, about 13%, about 14%, about 15%, about 20%, about 21%, about 22%, about 23%, about 24%, about 25%, or greater than about 25% of the water by weight in the nutrient mixture.

In embodiments, the nutrient mixture further comprises an emulsifier. As used herein, the term “emulsifier” can refer to an additive which can promote the formation and stabilization of an emulsion. In embodiments, the emulsifier can comprise any non-biomass emulsifier. For example, the emulsifier can comprise a compound with an HLB value of about 3 to about 18. For example, the emulsifier can comprise any emulsifier known in the art. For example diethylene glycol, propylene glycol monocaproate, propylene glycol monocaprylate, propylene glycol monocaprate, propylene glycol monolaurate, propylene glycol monostearate, propylene glycol monopalmitate, polyethylene glycol lauryl ether, polyethylene glycol oleyl ether, polyethylene glycol hexadecyl ether, sorbitan monopalmitate, sorbitan monostearate, sorbitan monooleate, sorbitan monolaurate, transcutol P, gelucire 50/13, gelucire 44/14, gelucire 43/01, lecithin, cetearyl alcohol, fatty acid esters, caprylocaproyl polyoxyl-8 glycerides, macrogolglycerol ricinoleate, behentrimonium methosulfate (BTMS), or a combination thereof.

In embodiments, the emulsifier can be present in the nutrient mixture in less than about 0.1%, about 0.1%, about 0.2%, about 0.3%, about 0.4%, about 0.5%, about 0.6%, about 0.7%, about 0.8%, about 0.9%, about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, about 10%, about 11%, about 12%, about 13%, about 14%, about 15%, about 16%, about 17%, about 18%, about 19%, about 20%, or greater than about 20% of the hydrocarbons by weight.

In embodiments, the nutrient mixture can comprise an acidifier. For example, the acidifier can comprise any composition that can acidify a solution. For example, the acidifier can comprise ferrous sulfate, a buffer solution, or a combination thereof. For example, the buffer solution can have a pH of 7. For example, the buffer solution can comprise water, potassium phosphate monobasic, sodium hydroxide, hydrogen chloride, in any amount or any combination thereof. For example, the buffer solution can comprise about 99.15% water, about 0.72% potassium phosphate monobasic, and about 0.13% sodium hydroxide. For example, the buffer solution can comprise about 98.5% water and about 1.5% HCl. For example, the buffer solution can comprise about 3.125% to about 15.625% of the water weight of the nutrient mixture. For example, the buffer solution can comprise about 1,111% to about 5,555% of the nitrogen content. For example, the HCl buffer can comprise about 0.1% to about 1% of the water weight of the nutrient mixture. For example, the HCl buffer can comprise about 38.28% to about 382.79% of the nitrogen content. For example, the ferrous sulfate comprises ferrous sulfate heptahydrate.

In embodiments, the substrate comprises a carbon to nitrogen (C:N) ratio of about less than about 20:0.01, about 20:0.01, about 20:0.1, about 20:1, about 23:1, about 25:1, about 30:1, about 35:1, about 40:1, about 45:1, about 50:1, about 55:1, about 60:1, about 65:1, about 70:1, about 75:1, about 80:1, about 85:1, about 90:1, about 95:1, about 100:1, about 105:1, about 110:1, about 115:1, about 120:1, about 125:1, about 150:1, about 175:1, about 180:1, about 200:1, about 225:1, about 250:1, about 275:1, about 300:1, about 325:1, about 350:1, about 375:1, about 400:1, about 425:1, about 450:1, about 475:1, about 500:1, about 550:1, about 600:1, about 650:1, about 700:1, about 750:1, about 800:1, about 850:1, about 900:1, about 950:1, about 1000:1, about 1050:1, about 1100:1, about 1150:1, about 1200:1, about 1250:1, about 1300:1, about 1350:1, about 1400:1, about 1500:1, about 1600:1, about 1700:1, about 1800:1, about 1900:1, about 2000:1, about 2500:1, about 3000:1, about 3500:1, about 4000:1, about 4500:1, about 5000:1, or greater than 5000:1.

For example, the substrate can comprise about 48.38% paraffin, about 42.33% water, about 8.47 mineral wool, about 0.45% urea, about 0.28% micronutrients, about 0.08% potash, and about 0.01% diammonium phosphate. For example, the substrate can comprise about 48.12% paraffin, about 42.10% water, about 8.42% miner wool, about 0.99% ammonium sulfate, about 0.28% micronutrients, about 0.08% muriate of potash, and about 0.01% diammonium phosphate. For example, the substrate can comprise about 66% water, about 17% mineral wool, about 7% peptone, about 8% propylene glycol, and wherein the remaining about 2% comprises micronutrients, potash, triple superphosphate, or a combination thereof. For example, the substrate can comprise about 66.39% water, about 17.12% mineral wool, about 0.58% micronutrients, about 0.16% potash, about 0.03% triple superphosphate, about 7.44% peptone, and about 8.29% propylene glycol. In embodiments, the ranges described herein can vary by about 25%. In embodiments, the nitrogen containing compounds can be increased or decreased by about a factor of 10.

Aspects of the invention are drawn towards a metabolization source in the food system. As used herein, the terms “metabolization source” and “metabolism source” can be used interchangeably. In embodiments, the metabolism source can metabolize the cultivation substrate or portion thereof to create a food product. As used herein, the term “metabolization source” can refer to a source of metabolism. As used herein, the term “metabolism” can refer to the sum of physical and chemical processes in an organism by which its material substance is produced, maintained, and destroyed, and by which energy is made available. For example, metabolism can refer to chemical reactions which convert a substrate into energy. For example, the metabolization source can convert a substrate into food and/or nutrients.

In embodiments, the metabolism source can comprise saprophytic organisms. As used herein, the terms “saprophytic organism” and “saprophytes” can be used interchangeably. As used herein, the term “saprophyte” can refer to an organism which can obtain nutrients by absorbing dissolved organic material. For example, the saprophytic organism can comprise mold, mushroom, yeast, penicillium, and mucor, or a combination thereof. For example, the mushroom can comprise an oyster mushroom, Pleurotus ostreatus, Pleurotus pulmonarius, Ganoderma lucidum, Pleurotus columbinus, Pleurotus diamor, Pleurotus eryngii, Amillaria gallica, Cantharellus cibarius, honey mushroom, white-rot fungi, Lentinula edodes, or a shiitake mushroom. In some embodiments, saprophytes can comprise certain fungi, bacteria or archaeans. In embodiments, a saprophytic organism can metabolize a substrate described herein to generate food or nutrients. For example, a saprophytic organism can metabolize a non-biomass substrate described herein and be consumed as food or nutrients. For example, a saprophytic organism can metabolize a substrate and produce a compound to be consumed as food or nutrients. In embodiments, the carbon-containing compounds in the abiotic nutrient mixture can comprise paraffin, mineral oil (baby oil), or a combination thereof. In embodiments, proportions in of elements in the nutrient mixture can be selected based upon the saprophytic organism. In embodiments, the saprophytic organism can be further adapted to increase yields and/or nutritional quality on the substrate. For example, the adaptations can comprise selective breeding and/or genetic modifications.

In embodiments, the metabolism source can comprise an insect. In embodiments the insect comprises an insect capable of degrading polymers and/or carbon chains. For example, the insects can comprise crickets, roaches, and larvae. For example, the larvae can comprise moth and fly larvae.

Aspects of the invention are drawn towards formulations for producing food from a non-biomass food system. Non-limiting, exemplary examples of formulations can be found in Table 1.

Aspects of the invention are drawn towards products of a non-biomass and/or non-photosynthetic food system. In embodiments, the non-photosynthetic food comprises a non-biomass and/or abiotic food or nutrient. In embodiments, a metabolism source described herein can metabolize a cultivation substrate described herein to create a food or nutrition product. For example, the metabolism source can be consumed as food. For example, the metabolism source can be prepared and/or processed to produce an extract. As used herein, the term “extract” can refer to a substance made by extracting a raw material or part thereof. For example, the raw material can comprise a saprophytic organism or a part thereof. In embodiments, the extract can be produced by any extraction method known in the art. For example, the extraction methods comprises maceration, infusion, percolation, decoction, Soxhlet extraction, hot continuous extraction, microwave-assisted extraction (MAE), ultrasound-assisted extraction (UAE), sonication extraction, solvent extraction, accelerated solvent extraction (ASE), supercritical fluid extraction (SFE), enzyme-assisted extraction (EAE), extraction of volatile organic compounds, purge and trap (dynamic headspace), and solid phase microextraction. For example, the extract can comprise oils. For example, the oils can comprise mushroom-derived oils and/or yeast-derived oils. For example, the extract can comprise powders. For example, the powders can comprise mushroom-derived powders and/or yeast-derived powders.

Methods

Aspects of the invention are directed towards methods of producing a food product without the using of biomass. Aspects of the invention are directed towards methods of producing a food product without the use of photosynthesis. In embodiments, the method comprises producing a nutrient mixture as described herein. For example, the nutrient mixture comprises a non-biomass carbon source and/or a synthetically produced carbon sources as described herein. In embodiments, a carrier material is soaked in the nutrient mixture to produce a cultivation substrate as described herein. In further embodiments, at least one saprophytic organism is cultivated on the cultivation substrate, wherein the saprophytic organism metabolizes the cultivation substrate or portion thereof to create a food product.

Aspects of the invention are drawn towards preparing a substrate. In embodiments, a substrate can be prepared by soaking a non-biomass and/or an inorganic carrier material (as described herein) in a nutrient mixture (as described herein). In embodiments, the nutrient mixture can comprise a carbon-containing source (to provide energy and carbon), a source of nitrogen, and other nutrients. In embodiments, the carrier material can comprise a material that is porous and/or has a high surface area to hold the nutrients and water in a dispersed which allows access by a metabolization source (as described herein). In embodiments, the carrier material can allow for aeration if the metabolization source requires or benefits from aeration. In embodiments, preparation can depend upon the solubility of the carbon source. For example, a water soluble carbon source can be dissolved in water. For example, a non-water soluble carbon source can be liquified by heating. In all embodiments, ingredients can be homogenously dispersed. In an embodiment, the substrate can be sterilized prior to inoculation with the metabolization source. For example, the sterilization procedure can comprise autoclaving the substrate.

Aspects of the invention are drawn towards using non-biomass and/or inorganic matter to create a food source. In embodiments, non-biomass and/or inorganic feedstock can be subjected to energy to create an organic feedstock. For example, the inorganic feedstock can comprise CO₂, H₂O, N₂, or a combination thereof. For example, the non-biomass feedstock can comprise a non-biomass carbon source, a non-biomass nitrogen source, and a non-biomass hydrogen source. For example, the non-biomass carbon source can comprise hydrocarbons, petroleum, petroleum jelly, mineral oil (baby oil), paraffin or a combination thereof. In embodiments, the energy source can be solar or non-solar. For example, the non-solar energy source can comprise nuclear energy, wind energy, geothermal energy, or hydropower.

Kits

Aspects of the invention are directed towards kids comprising non-biomass food sources. Aspects of the invention are directed towards kits comprising a non-photosynthetic food system or components thereof and instructions for use thereof. In embodiments the kit can comprise a nutrient cultivating substrate, an non-biomass nutrient mixture, a metabolization source, or any combination thereof. The kit can further comprise instructions for use thereof. In some embodiments, the metabolization source will be provided as spores.

### EXAMPLES

Examples are provided below to facilitate a more complete understanding of the invention. The following examples illustrate the exemplary modes of making and practicing the invention. However, the scope of the invention is not limited to specific embodiments disclosed in these Examples, which are for purposes of illustration only, since alternative methods can be utilized to obtain similar results.

### Example 1

### Example 1—Non-Photosynthetic Food

The non-photosynthetic food system (“System”) (FIG. 1) serves to produce food for human (or animal) consumption without the use of photosynthesis. The System accomplishes this production by abiotic (synthetic) production of hydrogen-, carbon-, and nitrogen-containing compounds, to use as a medium or substrate (with the mineral/nutrient enrichment) for the growth of food/feed organisms. One example of the approach is the cultivation of saprophytic fungi (e.g., oyster or shiitake mushrooms) on substrates that contain no or minimal biomass.

The entire human food system is photosynthesis-based. In other words, food calories consumed by humans today originate as plant (i.e., photosynthetic) matter/biomass. Examples are plant foods (e.g., grains, cereals, tubers, fruits, etc.), which are produced via the photosynthesis process, and account for the majority of the world's calorie intake. Photosynthetic biomass is used as feed for livestock or as substrate for fungi, or forms the basis of the marine food chain—part of the human civilization food system. Whilst there is a perception that domestic animals are the most inefficient link in the human food chain, photosynthesis in plants is responsible for the majority of the energy loss going from sunlight to edible calories. The theoretical energy efficiency of photosynthesis is ˜26%. The actual percentage of solar energy stored by plants is less than the maximum energy efficiency of photosynthesis. An agricultural crop in which the biomass (total dry weight) stores as much as 1 percent of total solar energy received on an annual area-wide basis is exceptional, although a few cases of higher yields (perhaps as much as 3.5 percent in sugarcane) have been reported. There are several reasons for this difference between the maximum efficiency of photosynthesis and the actual energy stored in biomass. First, more than half of the incident sunlight is composed of wavelengths too long to be absorbed, and some of the remainder is reflected or lost to the leaves. Consequently, plants can at best absorb only about 34 percent of the incident sunlight. Second, plants must carry out a variety of physiological processes in such non-photosynthetic tissues as roots and stems; these processes, as well as cellular respiration, use up stored energy. Third, rates of photosynthesis in bright sunlight sometimes exceed the needs of the plants, resulting in the formation of excess sugars and starch. When this excess occurs, the regulatory mechanisms of the plant slow down the process of photosynthesis, allowing more absorbed sunlight to go unused. Fourth, in some plants, energy is wasted by the process of photorespiration. The growing season can last only a few months of the year; sunlight received during other seasons is not used. Furthermore, it is noted that if only agricultural products (e.g., seeds, fruits, and tubers, rather than total biomass) are considered as the end product of the energy-conversion process of photosynthesis, the efficiency falls even further. The inefficiencies described herein result in real-world sunlight-to-food conversion of <0.1%, and an area needed to produce 1000 kcal of food per annum of ˜1 m² for major staples such as rice, root vegetables, soybeans, or wheat. Put in land requirement context, this efficiency (or lack thereof), along with the additional energy conversions due to the omnivore diet and processing that further decreases the overall sunlight-to-food efficiency, translates into a land requirement of 13,000 m²/person. Without wishing to be bound by theory, a vegetarian diet puts the land requirement at 1000 m²/person. It is important to appreciate that current food plant yields already benefit from a synthetic process, for example, atmospheric nitrogen fixation via the Haber-Bosch process. Without Haber-Bosch, the yield-limiting step can be (and used to be) biological nitrogen fixation—a chemically difficult and energetically uphill reaction, owing to the strength of the triple molecular bond of gaseous nitrogen. In this sense, our method extends the use of synthetic fixation to the also (though not quite as) difficult reaction of hydrogen fixation from water. While land area requirements are not the only issue where improvement is possible, they can be significant, as swaths of Earth's ecosystems have been and are being destroyed to make way for agriculture—with catastrophic consequences. Herein, we improve on the food system efficiency, to where the (solar-driven) sunlight-to-food efficiency exceeds 1%, and the land area requirement falls below 100 m²/person, while at the same time expanding nutritional options and allowing for improved public health. Beyond terrestrial applications, our approach allows food production in outer space or on other celestial bodies, where system efficiency, size, and weight are paramount.

A non-limiting, exemplary distinguishing characteristic of our approach is that it does not employ photosynthesis to convert water (H₂O) and carbon dioxide (CO₂) into carbohydrates and other nutrients and foods. Rather (FIG. 1), it uses synthetic processes to convert H₂O and CO₂ into hydrogen-, carbon-, and nitrogen-containing compounds (hydrocarbons, alkanes, alcohols, aldehydes, amines, amides, etc.), to use as a medium or substrate (with the proper mineral/micronutrient enrichment) for the growth of food/feed organisms. One example of the approach is the cultivation of saprophytic fungi (e.g., oyster or shiitake mushrooms) on substrates that contain no or minimal plant biomass. In this example, primary energy (which can be solar, wind, nuclear, etc.) is used to power synthetic processes to split H₂O, CO₂, N₂, and other inorganic feedstocks, and convert them, for example, into hydrocarbons or other carbon-containing compounds. Saprophytic fungi, such as oyster mushrooms (among other organisms), metabolize hydrocarbons and other carbon-containing compounds and convert them to fungal carbohydrates (i.e., sugars), protein, and fat. In nature the feed/substrate carbon-containing compounds can be lignin, cellulose, hemicellulose, etc. In the non-photosynthetic approach, the feed is derived from abiotic chemical synthesis processes, analogous to synthetic (Haber-Bosch) nitrogen fixation.

We describe a method and system for food production that does not require or involve photosynthetic conversion of inorganic to organic matter and can be powered by any source of energy (i.e., not required to be light or sunlight). When powered by solar energy, the method allows more than a 100-fold decrease in the land requirement for food production relative to current practices. The method provides nutritious food production, including complete protein, without any arable land, or without sunlight.

Currently, food is photosynthesis-derived, i.e., it either consists of plant matter or is derived from plant matter. Efficiency limitations (land area requirement) and other inherent limitations pose a ceiling to the amount of food a photosynthesis-based food system can provide, and an even sharper limit to what it can provide sustainably (i.e., without environmental degradation). Our food production approach does not require photosynthesis at any stage. It therefore aims to augment our food system by adding a component that eliminates or decreases photosynthesis/plant matter as the necessary basis. Non-limiting, exemplary improvements comprise the overall energy efficiency of the process (˜100× improvement), the land area it requires (˜1% of present), avoided need for arable land (or even sunlight), and significantly lower environmental impact. There are also secondary benefits, such as the ability of local and/or hyperlocal food production, which can increase food security and equitable availability, improve freshness and nutritional quality, decrease losses to spoilage during transport, and substantially decrease food transport costs and necessary infrastructure.

Benefits of a fungi based dietary component, as one non-limiting example of our approach, extend beyond energy and resource efficiency. For example, fungi offer a variety of species. Saprophytic fungi are the largest group of fungi species, with multiple species in the Pleurotus (oyster mushroom) genus alone. Fungi further offer a variety of nutritional profiles, with surprisingly high levels of key nutrients. As used herein, the term “nutritional profile” can refer to a food composition by category (e.g. carbohydrates, proteins, fats, vitamins, minerals, amino acids, and/or fiber). For example, mushroom species can contain essential amino acids (i.e., a complete protein source)—a key attribute given that complete proteins are most often animal-derived and can be resource-intensive to produce. In terms of micronutrients, mushrooms also can be one of the dietary sources of non-animal-derived vitamin D, a nutrient which can be under-consumed in the United States. They also often include a healthier fatty acid profile (with less saturated fat and more mono- and poly-unsaturated fats present) and can offer multiple other health benefits via a host of functional components such as beta-glucans and antioxidants. Without wishing to be bound by theory, saprophytes can possess higher levels of polyunsaturated fatty acids in comparison to foods of vegetal and animal origin.

Compared to current practices, non-photosynthetic food production:
Is 100× more energy efficient;
Requires less land area;
Requires no arable land;
Can be powered by any source of primary energy;
Can sustainably support a growing human population;
Can provide a healthier nutritional profile, especially per resource input, than current practice.

### Example 2

Non-Limiting Exemplary Process

In the fungi example, a substrate can be prepared by soaking an inorganic carrier material, such as mineral wool or pumice, with the desired nutrient mixture which can comprise (but is not limited to): hydrocarbon and/or other carbon-containing compounds (to provide energy and carbon), a source of nitrogen (such as urea), as well as other nutrient minerals (providing iron, phosphorus, potassium, etc.), and water. For example, the carrier material choice can provide a porous, comparatively high-surface area environment, to hold the nutrients and water in a dispersed state that allows access to it by the mycelium and for aeration, as mycelium needs oxygen. For example, the “comparatively high-surface area” environment can comprise a range of about 0.1 m²/g to about 10 m²/g. This arrangement also mimics the natural environment for fungal growth: fungi can grow on decaying wood and similar porous biomass. While the remainder of the cultivation process can be similar to that with biomass substrates, without wishing to be bound by theory, using abiotic materials in the substrate can lower the risk of substrate contamination with other organisms that can grow on it. This can be due to the abiotic nutrients themselves, but also can be due to few, if any, organisms being capable of metabolizing them. In this sense, an abiotic substrate can also offer process simplifications in terms of not requiring a sterile inoculation and growth environment.

In our P. ostreatus (oyster mushroom) work, we can replace the energy content of biomass with abiotic hydrocarbons or other abiotic carbon-containing compounds. Because different carbon-containing compounds have different energy contents, the recipes can vary from compound to compound. As an example, for propylene glycol a substrate can consist of 66.39% water, 17.12% mineral wool, 0.58% micronutrients, 0.16% potash, 0.03% triple superphosphate, 7.44% peptone, 8.29% propylene glycol. These ratios can vary on the precise nutrient requirements for different species and strains of the culture in question.

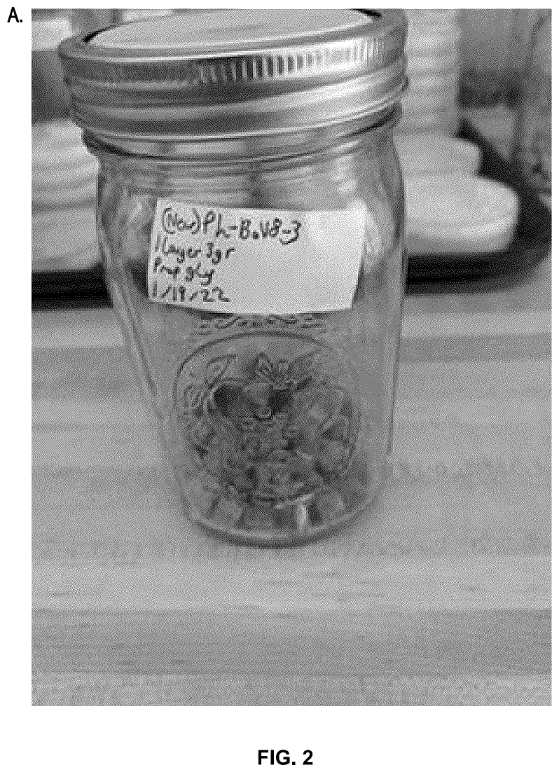

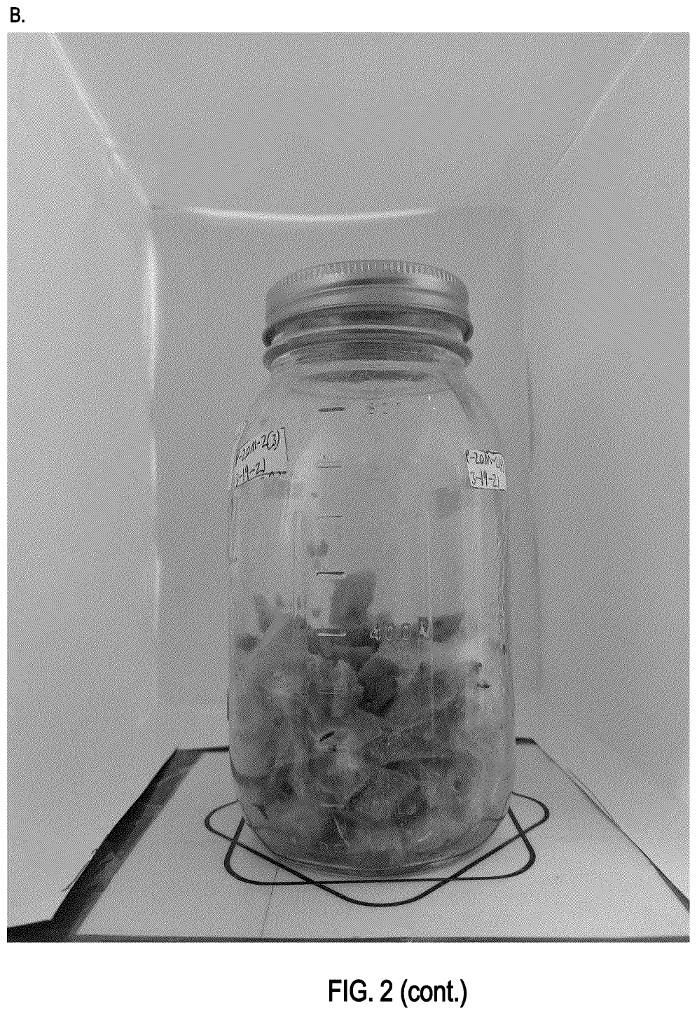

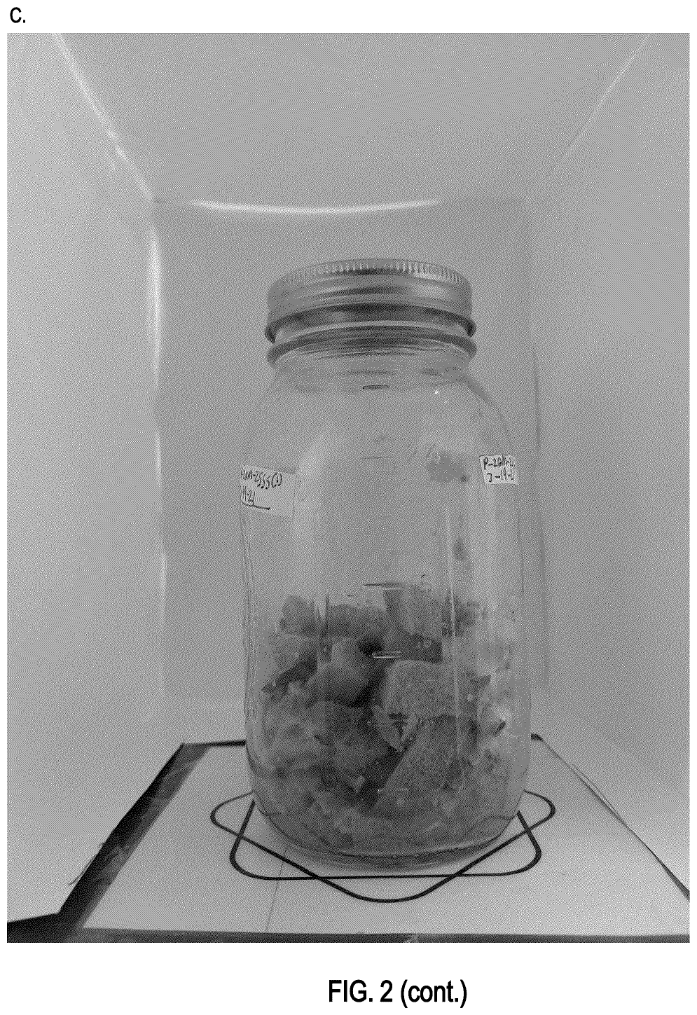

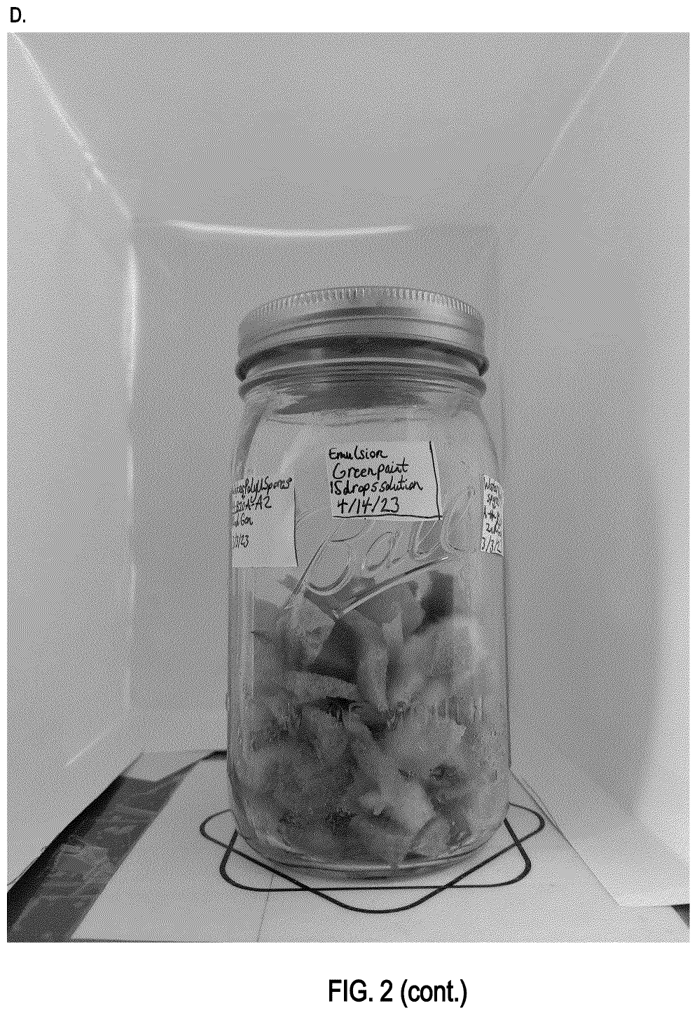

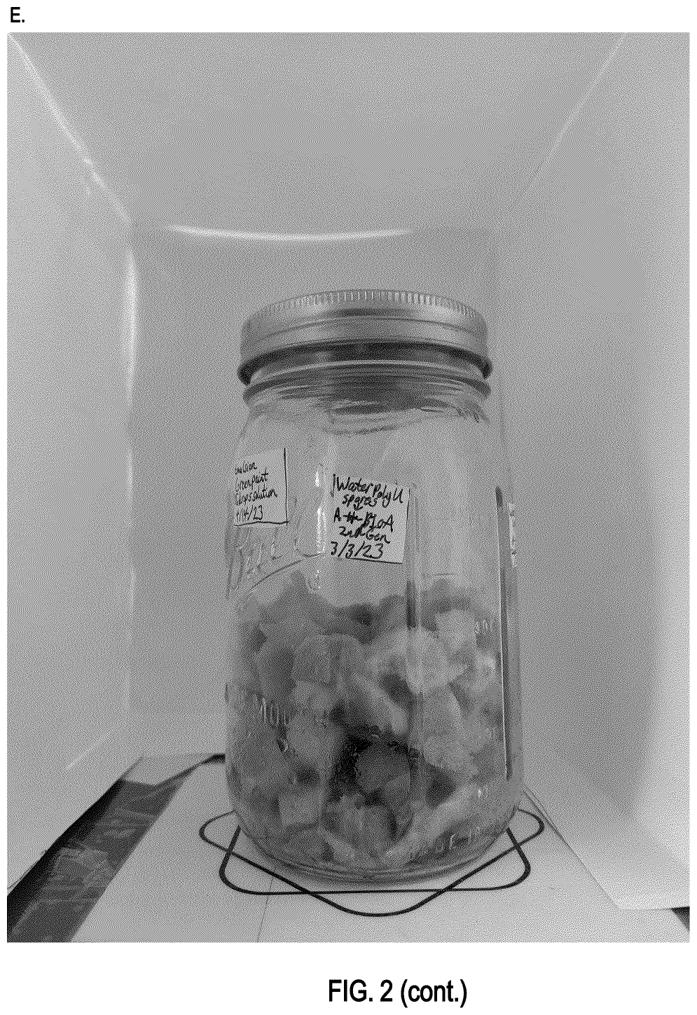

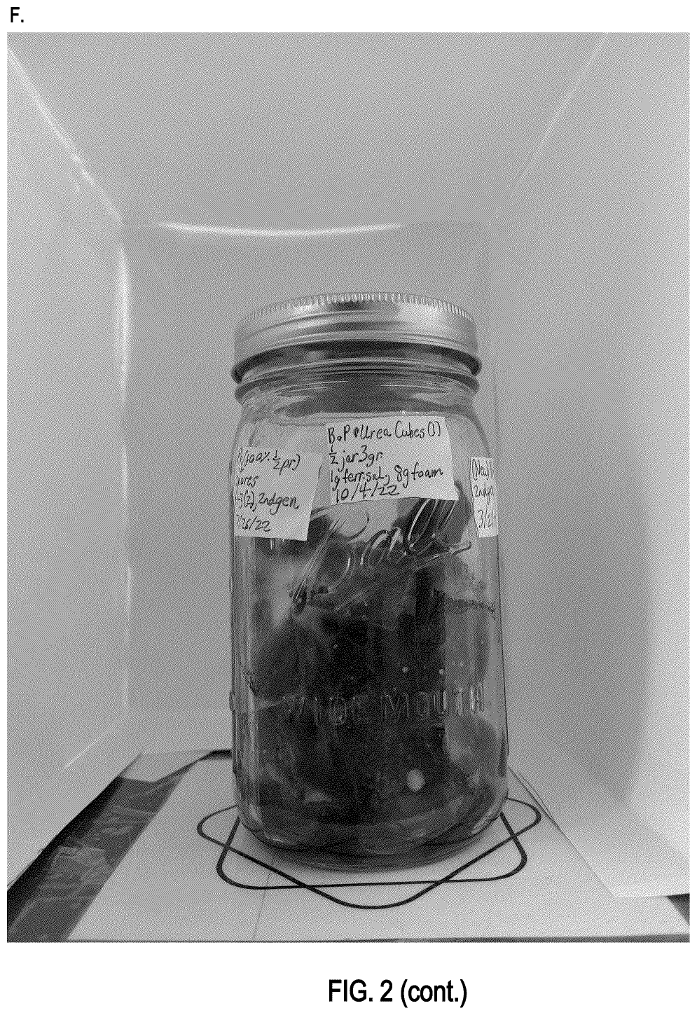

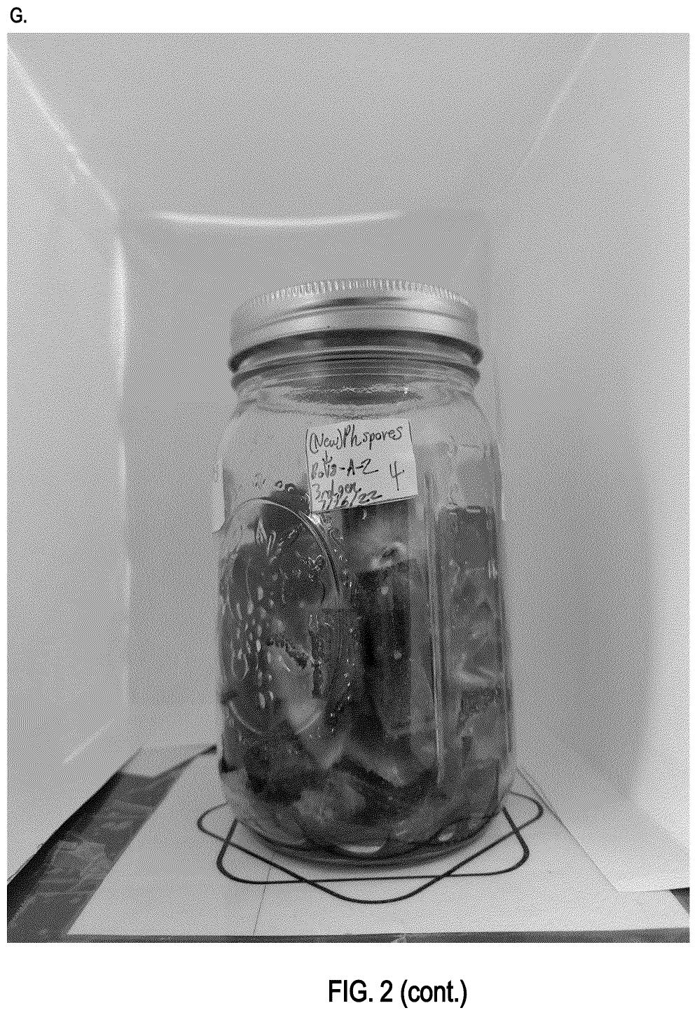

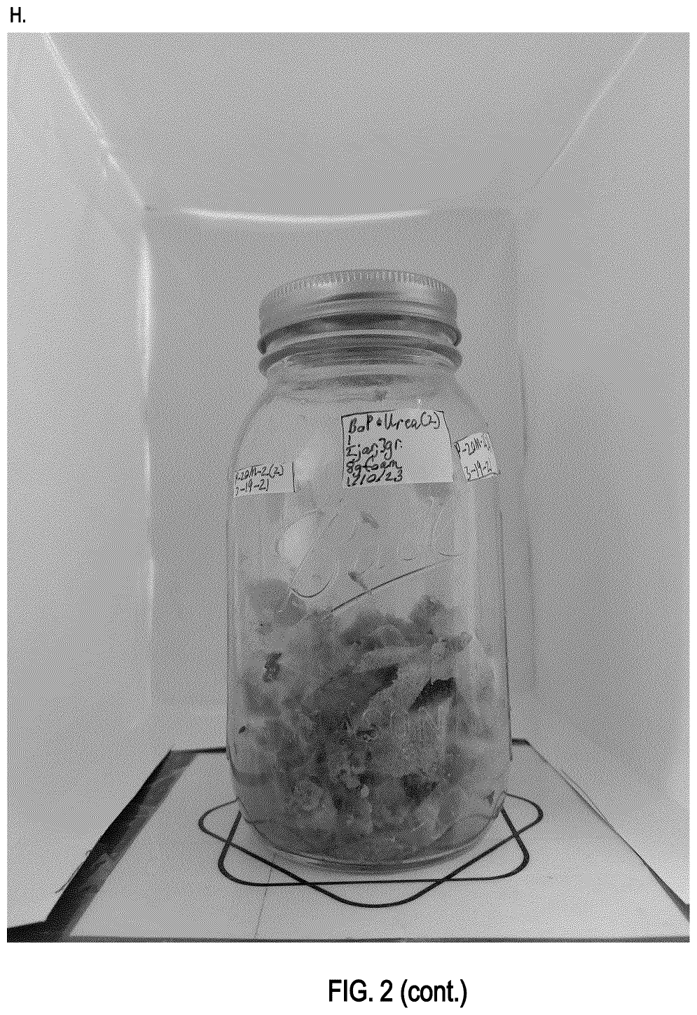

Preparation also depends on the solubility of the carbon-containing compound in water, which can be the main substrate ingredient. For a soluble carbon-containing compound, for example propylene glycol or paraffin, the carbon-containing compound and the other ingredients are mixed with water, after which the mineral wool cubes (FIG. 2) are allowed to soak up the solution, to distribute the solution in the mineral wool.

For a non-soluble hydrocarbon or abiotic carbon-containing compound, a preparation example can be to liquefy the compound by heating, and soaking the mineral wool. This step can then be followed by soaking in the remainder of the ingredients in an aqueous solution. In either case, the goal is good dispersion of ingredients into the porous base, so that they can be accessed by growing mycelium. For example, “good dispersion” can refer to an even or about even distribution.

The substrate can then be sterilized in an autoclave, in a jar or a bag. In an embodiment, during sterilization, the jar or bag can be closed, except for a filtered opening that allows gas exchange, but prevents biological contaminant ingress (e.g. molds). The final step can be inoculation, where live mycelium is placed, under sterile conditions, into the substrate jar or bag and allowed to propagate. The remainder of the process can be identical or identical in part to cultivation on a biomass-based substrate.

### Example 3

Non-Limiting, Exemplary Process

Described herein are hydrocarbon-based substrates developed for edible mushrooms. Hydrocarbons in the experiment series can comprise petroleum jelly (e.g., Vaseline®), paraffin, baby oil, or a combination thereof, and the amount of hydrocarbons can vary. Other carbon sources can comprise xylitol, mannitol, maltitol, sorbitol, propylene glycol, ethylene glycol, and hydroquinone. Carbon sources used as controls (e.g., biomass carbon sources) can comprise corn starch, glucose, cotton seed hulls, and alder fuel pellets. Nitrogen supplementation presented a conundrum in that additional nitrogen is necessary for mushroom growth but adding this nitrogen to the mix can hinder any initial growth on the substrate. We solved this problem by implementing peptone and urea, and by adding ferrous sulfate to acidify the substrate. In embodiments, the peptone can be replaced by a non-biomass nitrogen source. Said substrate had become alkaline from the initial addition of nitrogen. Access to air was also tested by varying the amount of time that air can circulate between the jars and their surroundings; by changing the type of solid in the jars, from rockwool to polyurethane foams; and by experimenting with the sizes of the jars themselves. Throughout this process, the amount of water added was also examined as a factor of growth. Finally, vanillin was added to the mix as a promoter, and assorted emulsifiers comprising lecithin, diethylene glycol, and BTMS-25 were tested to create an emulsion that can uniformly soak into the solid chosen. In embodiments, any non-biomass emulsifier can be added. In embodiments, the promoter can be a non-biomass promoter. In embodiments, the vanillin can be synthetically produced. In embodiments, the promoter can comprise iron. For example, the vanillin can be produced from a petrochemical precursor. These substrates were inoculated with an assortment of cultured edible white-rot mushrooms, comprising P. pulmonarius, P. columbinus, P. ostreatus, and L. edodes.

### Example 4

Non-Limiting, Exemplary Emulsion Experimental Preparation Procedure

Described herein is a procedure to prepare a non-biomass nutrient mixture and substrate for mycelium/mushroom growth, and then to inoculate the substrate with mycelium.
1. Boil 200 g water in an electric kettle. Add to large beaker (at least 600 mL) once it cools to 60° C. Measure the following ingredients (baby oil, nutrient solution, behtrimonium methosulfate cetearyl alcohol (BTMS-25), and ferrous sulfate) while water is cooling. Add and blend these ingredients while the water is still warm (45-60° C.).
2. Measure 6 g mineral oil (e.g., Johnson's® baby oil) into a 50 mL beaker. Pour into the beaker with the water, near but not touching the sides.
3. Shake closed vial of concentrated nutrient solution until no particles are visible, then add 1.8497 g to the mineral oil-water mix.
a. To make concentrated nutrient solution, mix in a 50 mL beaker:
   i. 7.4318 g water
   ii. 0.3571 g vanillin powder
   iii. 1.6813 g micronutrient mix fertilizer (e.g., from Jackpot®)-comprising boron, calcium, copper, iron, magnesium, manganese, and zinc.
   iv. 0.4568 g 0-0-60 muriate of potash (potassium chloride)
   v. 0.0829 g L.D. Carlson diammonium phosphate
   vi. 1 g 46-0-0 urea
b. Heat at 40° C. and spin at 600 rpm on stir plate until solution forms, adding water to replace evaporated water.
4. Add 0.6 g BTMS-25 (e.g., from Lisse Cosmetics®), crushed and chopped into ˜1 mm³-sized pieces.
5. Add 0.24 g ferrous sulfate heptahydrate (e.g., from Greenway Biotech®).
6. Using an AuxCusio immersion blender with a whisk attachment on power setting II, blend for 2 minutes at a time, until emulsion is stable (does not separate into multiple layers) for at least 1 minute. Blending can add up to about 12 cumulative minutes. Unplug the blender and let it cool down if it starts to heat excessively.
7. Blend full emulsion for a final 2 minutes, then immediately pour equal amounts (50 g each) of emulsion into four medium-sized beakers, 200-300 mL.
8. If using white polyurethane foam, place 8 g foam into each of four quart-size mason jars. If using black foam, cut polyurethane foam (e.g., from Fabbay®) into 1″×0.5″×0.5″ prisms and place 4 g foam into each of four quart-size mason jars.
9. Blend a 50 g emulsion for 1 minute, then immediately pour into a mason jar of foam. Use the blade attachment of the immersion blender (not attached to the blender) to press the foam into the bottom of the jar and soak up the emulsion. Use tongs or tweezers to mix foam up, and press again. Repeat mixing and pressing until the foam has soaked up the emulsion.
10. Repeat step 9 with the other 3 emulsions and mason jars.
11. Use a metal hole punch to punch 3 holes in an equilateral triangular shape in the mason jars' lids. Place the lids on the jars so that the seals are face-up. Add 90 mm mycological mason jar filters, shiny side face-up, on top of the lids. Close each jar with the lid rings with a 90° turn, so that the lid setup is closed, but not tight, on the jar. Cover each with a 4.5″ diameter circle of aluminum foil.
12. Boil jars for 30 minutes.
13. Place jars in front of flow hood for at least 2 hours. If emulsion has drained to the bottom, strain into a separate jar placed on a scale in front of the flow hood. Measure and record amount each emulsion has drained.
14. Inoculate jars with mycelium

### Example 5

In some embodiments, the formulation can comprise one or more hydrocarbons in about 1-10% of the water by weight and the nitrogen in about 1%-4% of the hydrocarbon by atom count (C/N ratio).

In embodiments micronutrients can comprise about 0.004%-0.025%, potash 0.038%-0.2%, and phosphorus 0.007%-0.03% of the water by weight. Vanillin can comprise about 1% of the water by weight. In embodiments, the lower numbers can be nutrients found in the emulsions, and the higher numbers can be before emulsion testing. In some embodiments, ferrous sulfate can range about 255%-555% of nitrogen by weight (using the nitrogen content of each source rather than the source itself). In embodiments, ferrous sulfate can comprise about 4,343% of the nitrogen content. For example, ferrous sulfate can comprise about 270-370% of the nitrogen content.

TABLE 1
Non-Limiting, Exemplary Experimental Formulations

| | Solid | | | Water | | Hydrocarbon | Nutrient | | | | |
|---|---|---|---|---|---|---|---|---|---|---|---|
| | Mass | Mushroom | | Mass | Hydrocarbon | Mass | Solution | | | | Other |
| Solid Type | (g) | Species | Mushroom strain(s) | (g) | Type | (g) | Mass (g) | Nitrogen | Acidifier | Mediator | Ingredients |
| Rockwool | 6.5 | P. | Ph (100% ½ prop. Spores) A-3 | 32 | Paraffin | 27 | 0.3056 w/ | 2.5 g | None | None | None |
| | | pulmonarius | Mar. 21, 2022; new Ph-A-3 Dec. 6, 2021; Ph | | | | Triple | peptone | | | |
| | | | spores-BoV8 | | | | phosphate | | | | |
| | | | A-2 (Dec. 2, 2021); Ph-BoV8-3 | | | | rock powder | | | | |
| | | | (Dec. 6, 2021) | | | | (TSP) | | | | |
| Rockwool | 6.5 | P. | Ph (100% ½ prop. Spores) A-3 | 32 | None | 0 | 0.3056 | 2.5 g | None | None | None |
| | | pulmonarius | Mar. 21, 2022; new Ph-A-3 Dec. 6, 2021; Ph | | | | (w/TSP) | peptone | | | |
| | | | spores-BoV8 | | | | | | | | |
| | | | A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 | 32 | None | 0 | 0.3056 | 2.5 g | None | None | 21.68 g |
| | | pulmonarius | Mar. 21, 2022; new Ph-A-3 Dec. 6, 2021; Ph | | | | (w/TSP) | peptone | | | Corn |
| | | | spores-BoV8 | | | | | | | | starch |
| | | | A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 | 32 | Paraffin | 27 | 0.3056 | None | None | None | None |
| | | pulmonarius | Mar. 21, 2022; new Ph-A-3 Dec. 6, 2021; Ph | | | | w/diammonium | | | | |
| | | | spores-BoV8 | | | | phosphate | | | | |
| | | | A-2 (Dec. 2, 2021); Ph-BoV8-3 | | | | (DAP) | | | | |
| | | | (Dec. 6, 2021) | | | | | | | | |
| Rockwool | 6.5 | P. | Ph (100% ½ prop. Spores) A-3 | 32 | Paraffin | 27 | 0.3056 | None | None | None | None |
| | | pulmonarius | Mar. 21, 2022; new Ph-A-3 Dec. 6, 2021; Ph | | | | (w/DAP) | | | | |
| | | | spores-BoV8 | | | | | | | | |
| | | | A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 | 32 | Paraffin | 13 | 0.3056 | None | None | None | None |
| | | pulmonarius | Mar. 21, 2022; new Ph-A-3 Dec. 6, 2021; Ph | | | | (w/DAP) | | | | |
| | | | spores-BoV8 | | | | | | | | |
| | | | A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 | 32 | None | 0 | 0.3056 | None | None | None | None |
| | | pulmonarius | Mar. 21, 2022; new Ph-A-3 Dec. 6, 2021; Ph | | | | (w/DAP) | | | | |
| | | | spores-BoV8 | | | | | | | | |
| | | | A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 | 32 | Paraffin | 27 | 0.3056 | None | None | None | None |
| | | pulmonarius | Jan. 21, 2022; new Ph-A-3 Dec. 6, 2021; Ph | | | | (w/DAP) | | | | |
| | | | spores-BoV8 | | | | | | | | |
| | | | A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 | 32 | Paraffin | 27 | 0.3056 | None | None | None | None |
| | | pulmonarius | Jan. 21, 2022; new Ph-A-3 Dec. 6, 2021; Ph | | | | (w/DAP) | | | | |
| | | | spores-BoV8 | | | | | | | | |
| | | | A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 | 32 | None | 0 | 0.3056 | None | None | None | None |
| | | pulmonarius | Jan. 21, 2022; new Ph-A-3 Dec. 6, 2021; Ph | | | | (w/DAP) | | | | |
| | | | spores-BoV8 | | | | | | | | |
| | | | A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 | 32 | Paraffin | 13 | 0.3056 | None | None | None | None |
| | | pulmonarius | Jan. 21, 2022; new Ph-A-3 Dec. 6, 2021; Ph | | | | (w/DAP) | | | | |
| | | | spores-BoV8 | | | | | | | | |
| | | | A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (2) | 32 | None | 0 | 0.3056 | None | None | None | 1 g |
| | | pulmonarius | Jan. 21, 2022; new Ph-A-3 Dec. 6, 2021; Ph | | | | (w/TSP) | | | | Glucose |
| | | | spores- | | | | | | | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (2) | 32 | None | 0 | 0.3056 | None | None | None | 1 g |
| | | pulmonarius | Jan. 21, 2022; new Ph-A-3 Dec. 6, 2021; Ph | | | | (w/TSP) | | | | Glucose |
| | | | spores- | | | | | | | | no filter |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (2) | 32 | None | 0 | 0.3056 | None | None | None | 0.14 g |
| | | pulmonarius | Jan. 21, 2022; new Ph-A-3 Dec. 6, 2021; Ph | | | | (w/TSP) | | | | Glucose |
| | | | spores- | | | | | | | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (2) | 32 | None | 0 | 0.3056 | None | None | None | 0.14 g |
| | | pulmonarius | Jan. 21, 2022; new Ph-A-3 Dec. 6, 2021; Ph | | | | (w/TSP) | | | | Glucose |
| | | | spores- | | | | | | | | no filter |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (2) | 32 | Paraffin | 30 | 0.3056 | 1 g | None | None | None |
| | | pulmonarius | Jan. 21, 2022; new Ph-A-3 Dec. 6, 2021; Ph | | | | (w/TSP) | peptone | | | |
| | | | spores- | | | | | | | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (2) | 32 | Paraffin | 30 | 0.3056 | 1 g | 1 g | None | None |
| | | pulmonarius | Jan. 21, 2022; new Ph-A-3 Dec. 6, 2021; Ph | | | | (w/TSP) | peptone | buffer | | |
| | | | spores- | | | | | | pH 7 | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (2) | 32 | Paraffin | 30 | 0.3056 | 1 g | 5 g | None | None |
| | | pulmonarius | Jan. 21, 2022; new Ph-A-3 Dec. 6, 2021; Ph | | | | (w/TSP) | peptone | buffer | | |
| | | | spores- | | | | | | pH 7 | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (2) | 32 | Paraffin | 30 | 0.3056 | 1 g | 2 g | None | None |
| | | pulmonarius | Jan. 21, 2022; new Ph-A-3 Dec. 6, 2021; Ph | | | | (w/TSP) | peptone | buffer | | |
| | | | spores- | | | | | | PH 7 | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (2) | 32 | Paraffin | 30 | 0.3056 | 0.6 g | None | None | None |
| | | pulmonarius | Jan. 21, 2022; new Ph-A-3 Dec. 6, 2021; Ph | | | | (w/DAP) | ammonium | | | |
| | | | spores- BoV8-A-2 (Dec. 2, 2021); Ph- | | | | | sulfate | | | |
| | | | BoV8-3 (Dec. 6, 2021) | | | | | | | | |
| Rockwool | 6.5 | P. | Ph (100% ½ prop. Spores) A-3 (2) | 32 | Paraffin | 30 | 0.3056 | 1.2 g | None | None | None |
| | | pulmonarius | Jan. 21, 2022; new Ph-A-3 Dec. 6, 2021; Ph | | | | (w/DAP) | ammonium | | | |
| | | | spores- BoV8-A-2 (Dec. 2, 2021); Ph- | | | | | sulfate | | | |
| | | | BoV8-3 (Dec. 6, 2021) | | | | | | | | |
| Rockwool | 6.5 | P. | Ph (100% ½ prop. Spores) A-3 (2) | 32 | None | 0 | 0.3056 | 0.6 g | None | None | None |
| | | pulmonarius | Jan. 21, 2022; new Ph-A-3 Dec. 6, 2021; Ph | | | | (w/DAP) | ammonium | | | |
| | | | spores- BoV8-A-2 (Dec. 2, 2021); Ph- | | | | | sulfate | | | |
| | | | BoV8-3 (Dec. 6, 2021) | | | | | | | | |
| Rockwool | 6.5 | P. | Ph (100% ½ prop. Spores) A-3 (2) | 32 | None | 0 | 0.3056 | 1.2 g | None | None | None |
| | | pulmonarius | Jan. 21, 2022; new Ph-A-3 Dec. 6, 2021; Ph | | | | (w/DAP) | ammonium | | | |
| | | | spores- BoV8-A-2 (Dec. 2, 2021); Ph- | | | | | sulfate | | | |
| | | | BoV8-3 (Dec. 6, 2021) | | | | | | | | |
| Rockwool | 6.5 | P. | Ph (100% ½ prop. Spores) A-3 (3) | 32 | Paraffin | 27 | 0.3056 | None | None | None | None |
| | | pulmonarius | Jan. 21, 2022; new Ph-A-3 Dec. 6, 2021; Ph | | | | (w/DAP) | | | | |
| | | | spores- | | | | | | | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (3) | 32 | Paraffin | 27 | 0.3056 | None | None | None | None |
| | | pulmonarius | Jan. 21, 2022; new Ph-A-3 Dec. 6, 2021; Ph | | | | (w/DAP) | | | | |
| | | | spores- | | | | | | | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (3) | 32 | Paraffin | 13 | 0.3056 | None | None | None | None |
| | | pulmonarius | Jan. 21, 2022; new Ph-A-3 Dec. 6, 2021; Ph | | | | (w/DAP) | | | | |
| | | | spores- | | | | | | | | |
| | | | BoV8-A-2 (Dec. 2, 2021); Ph-BoV8-3 | | | | | | | | |
| | | | (Dec. 6, 2021) | | | | | | | | |
| **Rockwool | 6.5 | P. | Ph (100% ½ prop. Spores) A-3 (3) | 32 | Paraffin | 13 | 0.3056 | None | None | None | None |
| | | pulmonarius | Jan. 21, 2022; new Ph-A-3 Dec. 6, 2021; Ph | | | | (w/DAP) | | | | |
| | | | spores- | | | | | | | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (2) | 32 | Paraffin | 27 | 0.3056 | 0.2 g | None | None | None |
| | | pulmonarius | Jan. 21, 2022; new Ph-A-3 Dec. 6, 2021; Ph | | | | (w/TSP) | peptone | | | |
| | | | spores- | | | | | (1 cube) | | | |
| | | | BoV8-A-2 (Dec. 2, 2021); Ph-BoV8-3 | | | | | | | | |
| | | | (Dec. 6, 2021) | | | | | | | | |
| **Rockwool | 6.5 | P. | Ph (100% ½ prop. Spores) A-3 (2) | 32 | Paraffin | 13 | 0.3056 | 0.2 g | None | None | None |
| | | pulmonarius | Jan. 21, 2022; new Ph-A-3 Dec. 6, 2021; Ph | | | | (w/TSP) | peptone | | | |
| | | | spores- | | | | | (1 cube) | | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (2) | 32 | None | 0 | 0.3056 | 0.2 g | None | None | None |
| | | pulmonarius | Jan. 21, 2022; new Ph-A-3 Dec. 6, 2021; Ph | | | | (w/TSP) | peptone | | | |
| | | | spores- | | | | | (1 cube) | | | |
| | | | BoV8-A-2 (Dec. 2, 2021); Ph-BoV8-3 | | | | | | | | |
| | | | (Dec. 6, 2021) | | | | | | | | |
| Yellow | 3.9 | None | None | 26 | Paraffin | 15 | 0.2483 | 0.2 g | None | None | None |
| polyurethane | | | | | | | (w/TSP) | peptone | | | |
| sponge | | | | | | | | | | | |
| Yellow | 3.8 | None | None | 26 | Paraffin | 15 | 0.2483 | 0.08 g | None | None | None |
| polyurethane | | | | | | | (w/TSP) | ammonium | | | |
| sponge | | | | | | | | sulfate | | | |
| Yellow | 3.9 | None | None | 26 | Paraffin | 15 | 0.2483 | None | None | None | None |
| polyurethane | | | | | | | (w/TSP) | | | | |
| sponge | | | | | | | | | | | |
| Yellow | 3.4 | None | None | 26 | None | 0 | 0.2483 | None | None | None | None |
| polyurethane | | | | | | | (w/TSP) | | | | |
| sponge | | | | | | | | | | | |
| Yellow | 4.2 | P. | Ph (100% ½ prop. Spores) A-3 (1) | 13 | Paraffin | 7.5 | 0.1242 | 0.8 g | None | None | None |
| polyurethane | | pulmonarius | Jan. 21, 2022; new Ph-A-3 Dec. 6, 2021; Ph | | | | (w/TSP) | peptone | | | |
| sponge | | | spores- BoV8-A-2 (Dec. 2, 2021); Ph- | | | | | | | | |
| | | | BoV8-3 (Dec. 6, 2021) | | | | | | | | |
| Yellow | 3.7 | P. | Ph (100% ½ prop. Spores) A-3 (1) | 13 | Paraffin | 7.5 | 0.1242 | 0.32 g | None | None | None |
| polyurethane | | pulmonarius | Jan. 21, 2022; new Ph-A-3 Dec. 6, 2021; Ph | | | | (w/TSP) | ammonium | | | |
| sponge | | | spores- BoV8-A-2 (Dec. 2, 2021); Ph- | | | | | sulfate | | | |
| | | | BoV8-3 (Dec. 6, 2021) | | | | | | | | |
| Yellow | 3.9 | P. | Ph (100% ½ prop. Spores) A-3 (1) | 13 | Paraffin | 7.5 | 0.1242 | None | None | None | None |
| polyurethane | | pulmonarius | Jan. 21, 2022; new Ph-A-3 Dec. 6, 2021; Ph | | | | (w/TSP) | | | | |
| sponge | | | spores- BoV8-A-2 (Dec. 2, 2021); Ph- | | | | | | | | |
| | | | BoV8-3 (Dec. 6, 2021) | | | | | | | | |
| Yellow | 3.5 | P. | Ph (100% ½ prop. Spores) A-3 (1) | 13 | None | 0 | 0.1242 | None | None | None | None |
| polyurethane | | pulmonarius | Jan. 21, 2022; new Ph-A-3 Dec. 6, 2021; Ph | | | | (w/TSP) | | | | |
| sponge | | | spores- BoV8-A-2 (Dec. 2, 2021); Ph- | | | | | | | | |
| | | | BoV8-3 (Dec. 6, 2021) | | | | | | | | |
| Rockwool | 6.5 | P. | Ph (100% ½ prop. Spores) A-3 (1) | 32 | Paraffin | 30 | 0.3056 | None | 0.7817 g | None | None |
| | | pulmonarius | Jan. 21, 2022; new Ph-A-3 Dec. 6, 2021; Ph | | | | (w/TSP) | | ferrous | | |
| | | | spores- | | | | | | sulfate | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (1) | 32 | Paraffin | 30 | 0.3056 | 0.2 g | 0.7817 g | None | None |
| | | pulmonarius | Jan. 21, 2022; new Ph-A-3 Dec. 6, 2021; Ph | | | | (w/TSP) | peptone | ferrous | | |
| | | | spores- | | | | | | sulfate | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (1) | 32 | Paraffin | 30 | 0.3056 | 0.8 g | 0.7817 g | None | None |
| | | pulmonarius | Jan. 21, 2022; new Ph-A-3 Dec. 6, 2021; Ph | | | | (w/TSP) | peptone | ferrous | | |
| | | | spores- | | | | | | sulfate | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (1) | 32 | None | 0 | 0.3056 | 0.2 g | 0.7817 g | None | None |
| | | pulmonarius | Jan. 21, 2022; new Ph-A-3 Dec. 6, 2021; Ph | | | | (w/TSP) | peptone | ferrous | | |
| | | | spores- | | | | | | sulfate | | |
| | | | BoV8-A-2 (Dec. 2, 2021); Ph-BoV8-3 | | | | | | | | |
| | | | (Dec. 6, 2021) | | | | | | | | |
| **Rockwool | 6.5 | P. | Ph (100% ½ prop. Spores) A-3 (1) | 32 | Paraffin | 30 | 0.3056 | None | None | None | None |
| | | pulmonarius | Jan. 21, 2022; new Ph-A-3 Dec. 6, 2021; Ph | | (on walls) | | (w/DAP) | | | | |
| | | | spores- | | | | | | | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (1) | 32 | Paraffin | 30 | 0.3056 | None | None | None | None |
| | | pulmonarius | Jan. 21, 2022; new Ph-A-3 Dec. 6, 2021; Ph | | (on walls) | | (w/DAP) | | | | |
| | | | spores- | | | | | | | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (1) | 32 | Paraffin | 20 | 0.3056 | 0.8 g | None | None | None |
| | | pulmonarius | Jan. 21, 2022; new Ph-A-3 Dec. 6, 2021; Ph | | | | (w/TSP) | peptone | | | |
| | | | spores- | | | | | | | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (1) | 32 | Paraffin | 20 | 0.3056 | 0.8 g | None | None | None |
| | | pulmonarius | Jan. 21, 2022; new Ph-A-3 Dec. 6, 2021; Ph | | | | (w/TSP) | peptone | | | |
| | | | spores- | | | | | | | | |
| | | | BoV8-A-2 (Dec. 2, 2021); Ph-BoV8-3 | | | | | | | | |
| | | | (Dec. 6, 2021) | | | | | | | | |
| **Rockwool | 6.5 | P. | Ph (100% ½ prop. Spores) A-3 (1) | 32 | None | 0 | 0.3056 | 0.8 g | None | None | None |
| | | pulmonarius | Jan. 21, 2022; new Ph-A-3 Dec. 6, 2021; Ph | | | | (w/TSP) | peptone | | | |
| | | | spores- | | | | | | | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (1) | 32 | Paraffin | 30 | 0.3056 | None | 0.7817 g | None | None |
| | | pulmonarius | Jan. 21, 2022; new Ph-A-3 Dec. 6, 2021; Ph | | | | (w/DAP) | | ferrous | | |
| | | | spores- | | | | | | sulfate | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (1) | 32 | Paraffin | 30 | 0.3056 | 0.2 g | 0.7817 g | None | None |
| | | pulmonarius | Jan. 21, 2022; new Ph-A-3 Dec. 6, 2021; Ph | | | | (w/DAP) | peptone | ferrous | | |
| | | | spores- | | | | | | sulfate | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (1) | 32 | Paraffin | 30 | 0.3056 | 0.8 g | 0.7817 g | None | None |
| | | pulmonarius | Jan. 21, 2022; new Ph-A-3 Dec. 6, 2021; Ph | | | | (w/DAP) | peptone | ferrous | | |
| | | | spores- | | | | | | sulfate | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (1) | 32 | None | 0 | 0.3056 | 0.2 g | 0.7817 g | None | None |
| | | pulmonarius | Jan. 21, 2022; new Ph-A-3 Dec. 6, 2021; Ph | | | | (w/DAP) | peptone | ferrous | | |
| | | | spores- | | | | | | sulfate | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (1) | 32 | None | 0 | 0.3056 | None | None | None | None |
| | | pulmonarius | Jan. 21, 2022; new Ph-A-3 Dec. 6, 2021; Ph | | | | (w/DAP) | | | | |
| | | | spores- | | | | | | | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (1) | 32 | None | 0 | 0.3056 | None | None | None | None |
| | | pulmonarius | Jan. 21, 2022; new Ph-A-3 Dec. 6, 2021; Ph | | | | (w/DAP) | | | | |
| | | | spores- | | | | | | | | |
| | | | BoV8-A-2 (Dec. 2, 2021); Ph-BoV8-3 | | | | | | | | |
| | | | (Dec. 6, 2021) | | | | | | | | |
| None | 0 | P. | (New) Ph-BoV8-3 (Dec. 6, 2021) | 27 | None | 0 | 0 | 0.2 g | None | None | 15.51 g |
| | | pulmonarius | | | | | | peptone | | | cottonseed |
| | | | | | | | | | | | hulls; |
| | | | | | | | | | | | 5.17 g |
| | | | | | | | | | | | alder |
| | | | | | | | | | | | fuel |
| | | | | | | | | | | | pellets |
| None | 0 | P. | (New) Ph-BoV8-3 (Dec. 6, 2021) | 27 | None | 0 | 0 | 0.8 g | None | None | 15.51 g |
| | | pulmonarius | | | | | | peptone | | | cottonseed |
| | | | | | | | | | | | hulls; |
| | | | | | | | | | | | 5.17 g |
| | | | | | | | | | | | alder |
| | | | | | | | | | | | fuel |
| | | | | | | | | | | | pellets |
| Rockwool | 6.5 | P. | Ph (100% ½ prop. Spores) A-3 (1) | 32 | Paraffin | 20 | 0.3056 | 0.28 g | 1 g | None | None |
| | | pulmonarius | Jan. 21, 2022; new Ph-A-3 Dec. 6, 2021; Ph | | | | (w/DAP) | urea | buffer | | |
| | | | spores- | | | | | | PH 7 | | |
| | | | BoV8-A-2 (Dec. 2, 2021); Ph-BoV8-3 | | | | | | | | |
| | | | (Dec. 6, 2021) | | | | | | | | |
| Rockwool | 6.5 | P. | Ph (100% ½ prop. Spores) A-3 (1) | 32 | None | 0 | 0.3056 | 0.28 g | 1 g | None | None |
| | | pulmonarius | Jan. 21, 2022; new Ph-A-3 Dec. 6, 2021; Ph | | | | (w/DAP) | urea | buffer | | |
| | | | spores- BoV8-A-2 (Dec. 2, 2021); Ph- | | | | | | pH 7; | | |
| | | | BoV8-3 (Dec. 6, 2021) | | | | | | 5 drops | | |
| | | | | | | | | | 1.5% | | |
| | | | | | | | | | HCl | | |
| Rockwool | 6.5 | P. | Ph (100% ½ prop. Spores) A-3 (1) | 32 | Paraffin | 30 | 0.3056 | 0.06 g | None | None | None |
| | | pulmonarius | Jan. 21, 2022; new Ph-A-3 Dec. 6, 2021; Ph | | | | (w/DAP) | ammonium | | | |
| | | | spores- BoV8-A-2 (Dec. 2, 2021); Ph- | | | | | chloride | | | |
| | | | BoV8-3 (Dec. 6, 2021) | | | | | | | | |
| Rockwool | 6.5 | P. | Ph (100% ½ prop. Spores) A-3 (1) | 32 | Paraffin | 30 | 0.3056 | 0.27 g | None | None | None |
| | | pulmonarius | Jan. 21, 2022; new Ph-A-3 Dec. 6, 2021; Ph | | | | (w/DAP) | ammonium | | | |
| | | | spores- BoV8-A-2 (Dec. 2, 2021); Ph- | | | | | chloride | | | |
| | | | BoV8-3 (Dec. 6, 2021) | | | | | | | | |
| Rockwool | 6.5 | P. | Ph (100% ½ prop. Spores) A-3 (1) | 32 | Paraffin | 30 | 0.3056 | 0.34 g | None | None | None |
| | | pulmonarius | Jan. 21, 2022; new Ph-A-3 Dec. 6, 2021; Ph | | | | (w/DAP | ammonium | | | |
| | | | spores- BoV8-A-2 (Dec. 2, 2021); Ph- | | | | | chloride | | | |
| | | | BoV8-3 (Dec. 6, 2021) | | | | | | | | |
| Rockwool | 6.5 | P. | Ph (100% ½ prop. Spores) A-3 (1) | 32 | None | 0 | 0.3056 | 0.27 g | None | None | None |
| | | pulmonarius | Jan. 21, 2022; new Ph-A-3 Dec. 6, 2021; Ph | | | | (w/DAP) | ammonium | | | |
| | | | spores- BoV8-A-2 (Dec. 2, 2021); Ph- | | | | | chloride | | | |
| | | | BoV8-3 (Dec. 6, 2021) | | | | | | | | |
| Rockwool | 6.5 | P. | Ph (100% ½ prop. Spores) A-3 (1) | 32 | Paraffin | 30 | 0.3056 | 0.06 g | 0.78 g | None | None |
| | | pulmonarius | Jan. 21, 2022; new Ph-A-3 2^{nd} gen | | | | (w/DAP) | ammonium | ferrous | | |
| | | | Mar. 2, 2022; Ph spores BoV-A-2 2^{nd} gen | | | | | chloride | sulfate | | |
| | | | Mar. 2, 2022; new Ph-BoV8-3 2^{nd} gen | | | | | | | | |
| | | | Mar. 2, 2022 | | | | | | | | |
| Rockwool | 6.5 | P. | Ph (100% ½ prop. Spores) A-3 (1) | 32 | Paraffin | 30 | 0.3056 | 0.27 g | 0.78 g | None | None |
| | | pulmonarius | Jan. 21, 2022; new Ph-A-3 2^{nd} gen | | | | (w/DAP) | ammonium | ferrous | | |
| | | | Mar. 2, 2022; Ph spores BoV-A-2 2^{nd} gen | | | | | chloride | sulfate | | |
| | | | Mar. 2, 2022; new Ph-BoV8-3 2^{nd} gen | | | | | | | | |
| | | | Mar. 2, 2022 | | | | | | | | |
| Rockwool | 6.5 | P. | Ph (100% ½ prop. Spores) A-3 (1) | 32 | Paraffin | 30 | 0.3056 | 0.34 g | 0.78 g | None | None |
| | | pulmonarius | Jan. 21, 2022; new Ph-A-3 2^{nd} gen | | | | (w/DAP) | ammonium | ferrous | | |
| | | | Mar. 2, 2022; Ph spores BoV-A-2 2^{nd} gen | | | | | chloride | sulfate | | |
| | | | Mar. 2, 2022; new Ph-BoV8-3 2^{nd} gen | | | | | | | | |
| | | | Mar. 2, 2022 | | | | | | | | |
| Rockwool | 6.5 | P. | Ph (100% ½ prop. Spores) A-3 (1) | 32 | None | 0 | 0.3056 | 0.27 g | 0.78 g | None | None |
| | | pulmonarius | Jan. 21, 2022; new Ph-A-3 2^{nd} gen | | | | (w/DAP) | ammonium | ferrous | | |
| | | | Mar. 2, 2022; Ph spores BoV-A-2 2^{nd} gen | | | | | chloride | sulfate | | |
| | | | Mar. 2, 2022; new Ph-BoV8-3 2^{nd} gen | | | | | | | | |
| | | | Mar. 2, 2022 | | | | | | | | |
| Black | 1.6 | P. | Ph (100% ½ prop. Spores) A-3 (1) | 32 | Paraffin | 15 | 0.3056 | 0.8 g | 0.78 g | None | None |
| Polyurethane | | pulmonarius | Jan. 21, 2022; new Ph-A-3 2^{nd} gen | | | | (w/DAP) | peptone | ferrous | | |
| Foam Disc | | | Mar. 2, 2022; Ph | | | | | | sulfate | | |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Black | 1.6 | P. | Ph (100% ½ prop. Spores) A-3 (1) | 22 | Paraffin | 15 | 0.2101 | 0.8 g | 0.78 g | None | None |
| Polyurethane | | pulmonarius | Jan. 21, 2022; new Ph-A-3 2^{nd} gen | | | | (w/DAP) | peptone | ferrous | | |
| Foam Cubes | | | Mar. 2, 2022; Ph | | | | | | sulfate | | |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Rockwool | 6.5 | P. | Ph (100% ½ prop. Spores) A-3 (1) | 32 | 3:7 BoP | 5 | 0.3056 | None | None | None | None |
| | | pulmonarius | Jan. 21, 2022; new Ph-A-3 2^{nd} gen | | (Baby oil | | (w/DAP) | | | | |
| | | | Mar. 2, 2022; Ph | | to | | | | | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Rockwool | 6.5 | P. | Ph (100% ½ prop. Spores) A-3 (1) | 22 | 3:7 BoP | 5 | 0.3056 | 10 g | None | None | None |
| | | pulmonarius | Jan. 21, 2022; new Ph-A-3 2^{nd} gen | | (Baby oil | | (w/DAP) | coffee | | | |
| | | | Mar. 2, 2022; Ph | | to | | | | | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Rockwool | 6.5 | P. | Ph (100% ½ prop. Spores) A-3 (1) | 12 | 3:7 BoP | 5 | 0.3056 | 20 g | None | None | None |
| | | pulmonarius | Jan. 21, 2022; new Ph-A-3 2^{nd} gen | | (Baby oil | | (w/DAP) | coffee | | | |
| | | | Mar. 2, 2022; Ph | | to | | | | | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Rockwool | 6.5 | P. | Ph (100% ½ prop. Spores) A-3 (1) | 2 | 3:7 BoP | 5 | 0.3056 | 30 g | None | None | None |
| | | pulmonarius | Jan. 21, 2022; new Ph-A-3 2^{nd} gen | | (Baby oil | | (w/DAP) | coffee | | | |
| | | | Mar. 2, 2022; Ph | | to | | | | | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Rockwool | 6.5 | P. | Ph (100% ½ prop. Spores) A-3 (1) | 32 | None | 0 | 0.3056 | None | 0.78g | None | 5 g |
| | | pulmonarius | Jan. 21, 2022; new Ph-A-3 2^{nd} gen | | | | (w/DAP) | | ferrous | | corn |
| | | | Mar. 2, 2022; Ph | | | | | | sulfate | | starch |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Rockwool | 6.5 | P. | Ph (100% ½ prop. Spores) A-3 (1) | 32 | None | 0 | 0.3056 | 0.2 g | 0.78 g | None | 5 g |
| | | pulmonarius | Jan. 21, 2022; new Ph-A-3 2^{nd} gen | | | | (w/DAP) | peptone | ferrous | | corn |
| | | | Mar. 2, 2022; Ph | | | | | | sulfate | | starch |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Rockwool | 6.5 | P. | Ph (100% ½ prop. Spores) A-3 (1) | 32 | None | 0 | 0.3056 | 0.8 g | 0.78 g | None | 5 g |
| | | pulmonarius | Jan. 21, 2022; new Ph-A-3 2^{nd} gen | | | | (w/DAP) | peptone | ferrous | | corn |
| | | | Mar. 2, 2022; Ph | | | | | | sulfate | | starch |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Rockwool | 6.5 | P. | Ph (100% ½ prop. Spores) A-3 (1) | 32 | 3:7 BoP | 5 | 0.3056 | 0.8 g | 0.78 g | None | None |
| | | pulmonarius | Jan. 21, 2022; new Ph-A-3 2^{nd} gen | | (Baby oil | | (w/DAP) | peptone | ferrous | | |
| | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Rockwool | 6.5 | P. | Ph (100% ½ prop. Spores) A-3 (1) | 32 | None | 0 | 0.3056 | 0.8 g | 0.78 g | None | None |
| | | pulmonarius | Jan. 21, 2022; new Ph-A-3 2^{nd} gen | | | | (w/DAP) | peptone | ferrous | | |
| | | | Mar. 2, 2022; Ph | | | | | | sulfate | | |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Rockwool | 6.5 | P. | Ph (100% ½ prop. Spores) A-3 (1) | 32 | None | 0 | 0.3056 | 30 g | None | None | None |
| | | pulmonarius | Jan. 21, 2022; new Ph-A-3 2^{nd} gen | | | | (w/DAP) | coffee | | | |
| | | | Mar. 2, 2022; Ph | | | | | | | | |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Black | 1.6 | P. | Ph (100% ½ prop. Spores) A-3 (1) | 32 | 1:4 BoP | 5 | 0.3056 | 0.8 g | 0.78 g | None | None |
| Polyurethane | | pulmonarius | Jan. 21, 2022; new Ph-A-3 2^{nd} gen | | (Baby oil | | (w/DAP) | peptone | ferrous | | |
| Foam Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (1) | 32 | 2:3 BoP | 5 | 0.3056 | 0.8 g | 0.78 g | None | None |
| Polyurethane | | pulmonarius | Jan. 21, 2022; new Ph-A-3 2^{nd} gen | | (baby oil | | (w/DAP) | peptone | ferrous | | |
| Foam Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (1) | 32 | 1:1 BoP | 5 | 0.3056 | 0.8 g | 0.78 g | None | None |
| Polyurethane | | pulmonarius | Jan. 21, 2022; new Ph-A-3 2^{nd} gen | | (baby oil | | (w/DAP) | peptone | ferrous | | |
| Foam Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (1) | 32 | None | 0 | 0.3056 | 0.8 g | 0.78 g | None | None |
| Polyurethane | | pulmonarius | Jan. 21, 2022; new Ph-A-3 2^{nd} gen | | | | (w/DAP) | peptone | ferrous | | |
| Foam Cubes | | | Mar. 2, 2022; Ph | | | | | | sulfate | | |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Rockwool | 6.5 | P. | Ph (100% ½ prop. Spores) A-3 (1) | 32 | 3:7 BoP | 5 | 0.3056 | 0.8 g | 0.2 g | None | None |
| | | pulmonarius | Jan. 21, 2022; new Ph-A-3 2^{nd} gen | | (Baby oil | | (w/DAP) | peptone | ferrous | | |
| | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Rockwool | 6.5 | P. | Ph (100% ½ prop. Spores) A-3 (1) | 32 | 3:7 BoP | 5 | 0.3056 | 0.8 g | 0.4 g | None | None |
| | | pulmonarius | Jan. 21, 2022; new Ph-A-3 2^{nd} gen | | (Baby oil | | (w/DAP) | peptone | ferrous | | |
| | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Rockwool | 6.5 | P. | Ph (100% ½ prop. Spores) A-3 (1) | 32 | 3:7 BoP | 5 | 0.3056 | 0.8 g | 0.6 g | None | None |
| | | pulmonarius | Jan. 21, 2022; new Ph-A-3 2^{nd} gen | | (Baby oil | | (w/DAP) | peptone | ferrous | | |
| | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Canvas | 3 | P. | Ph (100% ½ prop. Spores) A-3 (1) | 3 | 3:7 BoP | 1.5 | 0.0306 | 0.08 g | 0.08 g | None | None |
| | | pulmonarius | Jan. 21, 2022; new Ph-A-3 2^{nd} gen | | (Baby oil | | (w/DAP) | peptone | ferrous | | |
| | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Canvas | 3 | P. | Ph (100% ½ prop. Spores) A-3 (1) | 2.7 | 2:3 BoP | 1.8 | 0.0306 | 0.08 g | 0.08 g | None | None |
| | | pulmonarius | Jan. 21, 2022; new Ph-A-3 2^{nd} gen | | (Baby oil | | (w/DAP) | peptone | ferrous | | |
| | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Canvas | 3 | P. | Ph (100% ½ prop. Spores) A-3 (1) | 2.7 | 1:1 BoP | 1.8 | 0.0306 | 0.08 g | 0.08 g | None | None |
| | | pulmonarius | Jan. 21, 2022; new Ph-A-3 2^{nd} gen | | (Baby oil | | (w/DAP) | peptone | ferrous | | |
| | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Canvas | 3 | P. | Ph (100% ½ prop. Spores) A-3 (1) | 3.2 | None | 0 | 0.0306 | 0.08 g | 0.08 g | None | None |
| | | pulmonarius | Jan. 21, 2022; new Ph-A-3 2^{nd} gen | | | | (w/DAP) | peptone | ferrous | | |
| | | | Mar. 2, 2022; Ph | | | | | | sulfate | | |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Black | 1.6 | P. | Ph (100% ½ prop. Spores) A-3 (1) | 32 | None | 0 | 0.3056 | 0.08 g | 0.2 g | None | 5 g |
| Polyurethane | | pulmonarius | Jan. 21, 2022; new Ph-A-3 2^{nd} gen | | | | (w/DAP) | peptone | ferrous | | corn |
| Cubes | | | Mar. 2, 2022; Ph | | | | | | sulfate | | starch |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Black | 1.6 | P. | Ph (100% ½ prop. Spores) A-3 (1) | 32 | None | 0 | 0.3056 | 0.08 g | 0.78 g | None | 5 g |
| Polyurethane | | pulmonarius | Jan. 21, 2022; new Ph-A-3 2^{nd} gen | | | | (w/DAP) | peptone | ferrous | | corn |
| Cubes | | | Mar. 2, 2022; Ph | | | | | | sulfate | | starch |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Black | 1.6 | P. | Ph (100% ½ prop. Spores) A-3 (1) | 32 | 2:3 BoP | 3.7 | 0.3056 | 0.8 g | 0.2 g | None | None |
| Polyurethane | | pulmonarius | Jan. 21, 2022; new Ph-A-3 2^{nd} gen | | (Baby oil | | (w/DAP) | peptone | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (1) | 32 | None | 0 | 0.3056 | 0.8 g | 0.2 g | None | None |
| Polyurethane | | pulmonarius | Jan. 21, 2022; new Ph-A-3 2^{nd} gen | | | | (w/DAP) | peptone | ferrous | | |
| Cubes | | | Mar. 2, 2022; Ph | | | | | | sulfate | | |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Black | 1.6 | P. | Ph (100% ½ prop. Spores) A-3 (1) | 32 | 2:3 BoP | 1.3 | 0.3056 | 0.8 g | 0.2 g | None | None |
| Polyurethane | | pulmonarius | Jan. 21, 2022; new Ph-A-3 2^{nd} gen | | (Baby oil | | (w/DAP) | peptone | ferrous | | |
| Disk | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (1) | 32 | None | None | 0.3056 | 0.8 g | 0.2 g | None | None |
| Polyurethane | | pulmonarius | Jan. 21, 2022; new Ph-A-3 2^{nd} gen | | | | (w/DAP) | peptone | ferrous | | |
| Disk | | | Mar. 2, 2022; Ph | | | | | | sulfate | | |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Black | 1.6 | P. | Ph (100% ½ prop. Spores) A-3 (1) | 32 | 2:3 BoP | 5 | 0.3056 | 0.1474 g | 0.1 g | None | None |
| Polyurethane | | pulmonarius | Jan. 21, 2022; new Ph-A-3 2^{nd} gen | | (Baby oil | | (w/DAP) | urea | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (1) | 32 | 2:3 BoP | 5 | 0.3056 | 0.1474 g | 0.2 g | None | None |
| Polyurethane | | pulmonarius | Jan. 21, 2022; new Ph-A-3 2^{nd} gen | | (Baby oil | | (w/DAP) | urea | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (1) | 32 | 2:3 BoP | 5 | 0.3056 | 0.1474 g | 0.4 g | None | None |
| Polyurethane | | pulmonarius | Jan. 21, 2022; new Ph-A-3 2^{nd} gen | | (Baby oil | | (w/DAP) | urea | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Canvas | 3 | P. | Ph (100% ½ prop. Spores) A-3 (2) | 4.5 | 2:3 BoP | 6.7 | 0.0430 | 0.1125 g | 0.028 g | None | None |
| | | pulmonarius | Jan. 21, 2022; new Ph-A-3 2^{nd} gen | | (baby oil | | (w/DAP) | peptone | ferrous | | |
| | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Canvas | 3 | P. | Ph (100% ½ prop. Spores) A-3 (2) | 4.5 | 2:3 BoP | 7 | 0.0430 | 0.1125 g | 0.028 g | None | None |
| | | pulmonarius | Jan. 21, 2022; new Ph-A-3 2^{nd} gen | | (baby oil | | (w/DAP) | peptone | ferrous | | |
| | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Canvas | 3 | P. | Ph (100% ½ prop. Spores) A-3 (2) | 5.3 | 2:3 BoP | 10.5 | 0.0506 | 0.1325 g | 0.0331 g | None | None |
| | | pulmonarius | Jan. 21, 2022; new Ph-A-3 2^{nd} gen | | (baby oil | | (w/DAP) | peptone | ferrous | | |
| | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 2:3 BoP | 5 | 0.3056 | 0.8 g | 0.2 g | None | None |
| Polyurethane | | pulmonarius | Jan. 21, 2022; new Ph-A-3 2^{nd} gen | | (baby oil | | (w/DAP) | peptone | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 2:3 BoP | 5 | 0.3056 | 0.8 g | 0.2 g | None | None |
| Polyurethane | | pulmonarius | Jan. 21, 2022; new Ph-A-3 2^{nd} gen | | (baby oil | | (w/DAP) | peptone | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 2:3 BoP | 5 | 0.3056 | 0.8 g | 0.2 g | None | None |
| Polyurethane | | pulmonarius | Jan. 21, 2022; new Ph-A-3 2^{nd} gen | | (baby oil | | (w/DAP) | peptone | ferrous | | |
| Disk | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 2:3 BoP | 5 | 0.3056 | 0.8 g | 0.2 g | None | None |
| Polyurethane | | pulmonarius | Jan. 21, 2022; new Ph-A-3 2^{nd} gen | | (baby oil | | (w/DAP) | peptone | ferrous | | |
| Disk | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 2:3 BoP | 5 | 0.3056 | 0.8 g | 0.4 g | None | None |
| Polyurethane | | pulmonarius | Jan. 21, 2022; new Ph-A-3 2^{nd} gen | | (baby oil | | (w/DAP) | peptone | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | None | 0 | 0.3056 | 0.8 g | 0.4 g | None | None |
| Polyurethane | | pulmonarius | Jan. 21, 2022; new Ph-A-3 2^{nd} gen | | | | (w/DAP) | peptone | ferrous | | |
| Cubes | | | Mar. 2, 2022; Ph | | | | | | sulfate | | |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 2:3 BoP | 5 | 0.3056 | 0.8 g | 0.4 g | None | None |
| Polyurethane | | pulmonarius | Jan. 21, 2022; new Ph-A-3 2^{nd} gen | | (baby oil | | (w/DAP) | peptone | ferrous | | |
| Disk | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | None | 0 | 0.3056 | 0.8 g | 0.4 g | None | None |
| Polyurethane | | pulmonarius | Jan. 21, 2022; new Ph-A-3 2^{nd} gen | | | | (w/DAP) | peptone | ferrous | | |
| Disk | | | Mar. 2, 2022; Ph | | | | | | sulfate | | |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 1:1 BoP | 5 | 0.3056 | 0.8 g | 0.2 g | None | None |
| Polyurethane | | pulmonarius | Jan. 21, 2022; new Ph-A-3 2^{nd} gen | | (baby oil | | (w/DAP) | peptone | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 1:1 BoP | 5 | 0.3056 | 0.8 g | 0.2 g | None | None |
| Polyurethane | | pulmonarius | Jan. 21, 2022; new Ph-A-3 2^{nd} gen | | (baby oil | | (w/DAP) | peptone | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 1:1 BoP | 5 | 0.3056 | 0.8 g | 0.4 g | None | None |
| Polyurethane | | pulmonarius | Jan. 21, 2022; new Ph-A-3 2^{nd} gen | | (baby oil | | (w/DAP) | peptone | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 1:1 BoP | 5 | 0.3056 | 0.8 g | 0.4 g | None | None |
| Polyurethane | | pulmonarius | Jan. 21, 2022; new Ph-A-3 2^{nd} gen | | (baby oil | | (w/DAP) | peptone | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 1:1 BoP | 5 | 0.3056 | 0.8 g | 0.2 g | None | None |
| Polyurethane | | pulmonarius | Jan. 21, 2022; new Ph-A-3 2^{nd} gen | | (baby oil | | (w/DAP) | peptone | ferrous | | |
| Disk | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 1:1 BoP | 5 | 0.3056 | 0.8 g | 0.2 g | None | None |
| Polyurethane | | pulmonarius | Jan. 21, 2022; new Ph-A-3 2^{nd} gen | | (baby oil | | (w/DAP) | peptone | ferrous | | |
| Disk | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 1:1 BoP | 5 | 0.3056 | 0.8 g | 0.4 g | None | None |
| Polyurethane | | pulmonarius | Jan. 21, 2022; new Ph-A-3 2^{nd} gen | | (baby oil | | (w/DAP) | peptone | ferrous | | |
| Disk | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 1:1 BoP | 5 | 0.3056 | 0.8 g | 0.4 g | None | None |
| Polyurethane | | pulmonarius | Jan. 21, 2022; new Ph-A-3 2^{nd} gen | | (baby oil | | (w/DAP) | peptone | ferrous | | |
| Disk | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 2:3 BoP | 5 | 0.3056 | 0.8 g | 0.4 g | None | None |
| Polyurethane | | pulmonarius | Jan. 21, 2022; new Ph-A-3 2^{nd} gen | | (baby oil | | (w/DAP) | peptone | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 2:3 BoP | 5 | 0.3056 | 0.8 g | 0.4 g | None | None |
| Polyurethane | | pulmonarius | Jan. 21, 2022; new Ph-A-3 2^{nd} gen | | (baby oil | | (w/DAP) | peptone | ferrous | | |
| Disk | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 2:3 BoP | 5 | 0.3056 | 0.14 g | 0.2 g | None | None |
| Polyurethane | | pulmonarius | Jan. 21, 2022; new Ph-A-3 2^{nd} gen | | (baby oil | | (w/DAP) | urea | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 2:3 BoP | 5 | 0.3056 | 0.14 g | 0.2 g | None | None |
| Polyurethane | | pulmonarius | Jan. 21, 2022; new Ph-A-3 2^{nd} gen | | (baby oil | | (w/DAP) | urea | ferrous | | |
| Disk | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 2:3 BoP | 5 | 0.3056 | 0.27 g | 0.2 g | None | None |
| Polyurethane | | pulmonarius | Jan. 21, 2022; new Ph-A-3 2^{nd} gen | | (baby oil | | (w/DAP) | ammonium | ferrous | | |
| Cubes | | | Mar. 2, 2022; Ph spores BoV-A-2 2^{nd} gen | | to | | | chloride | sulfate | | |
| | | | Mar. 2, 2022; new Ph-BoV8-3 2^{nd} gen | | paraffin) | | | | | | |
| | | | Mar. 2, 2022 | | | | | | | | |
| Black | 1.6 | P. | Ph (100% ½ prop. Spores) A-3 (2) | 32 | 2:3 BoP | 5 | 0.3056 | 0.27 g | 0.2 g | None | None |
| Polyurethane | | pulmonarius | Jan. 21, 2022; new Ph-A-3 2^{nd} gen | | (baby oil | | (w/DAP) | ammonium | ferrous | | |
| Disk | | | Mar. 2, 2022; Ph spores BoV-A-2 2^{nd} gen | | to | | | chloride | sulfate | | |
| | | | Mar. 2, 2022; new Ph-BoV8-3 2^{nd} gen | | paraffin) | | | | | | |
| | | | Mar. 2, 2022 | | | | | | | | |
| Black | 3.6 | P. | Ph (100% ½ prop. Spores) A-3 (2) | 72 | None | 0 | 0.6952 | 1.8 g | 0.45 g | None | None |
| Polyurethane | | pulmonarius | Jan. 21, 2022; new Ph-A-3 2^{nd} gen | | | | (w/DAP) | peptone | ferrous | | |
| Cubes | | | Mar. 2, 2022; Ph | | | | | | sulfate | | |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Black | 3.6 | P. | Ph (100% ½ prop. Spores) A-3 (2) | 72 | None | 0 | 0.6952 | 1.8 g | 0.45 g | None | 11.25 g |
| Polyurethane | | pulmonarius | Jan. 21, 2022; new Ph-A-3 2^{nd} gen | | | | (w/DAP) | peptone | ferrous | | corn |
| Cubes | | | Mar. 2, 2022; Ph | | | | | | sulfate | | starch |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Black | 3.6 | P. | Ph (100% ½ prop. Spores) A-3 (2) | 72 | 2:3 BoP | 11.25 | 0.6952 | 1.8 g | 0.45 g | None | None |
| Polyurethane | | pulmonarius | Jan. 21, 2022; new Ph-A-3 2^{nd} gen | | (baby oil | | (w/DAP) | peptone | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 3.6 | P. | Ph (100% ½ prop. Spores) A-3 (2) | 72 | 2:3 BoP | 11.25 | 0.6952 | 1.8 g | 0.45 g | None | None |
| Polyurethane | | pulmonarius | Jan. 21, 2022; new Ph-A-3 2^{nd} gen | | (baby oil | | (w/DAP) | peptone | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Rockwool | 17.2 | P. | Ph (100% ½ prop. Spores) A-3 (2) | 72 | None | 0 | 0.6952 | 1.8 g | 0.45 g | None | None |
| | | pulmonarius | Jan. 21, 2022; new Ph-A-3 2^{nd} gen | | | | (w/DAP) | peptone | ferrous | | |
| | | | Mar. 2, 2022; Ph | | | | | | sulfate | | |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Rockwool | 17.2 | P. | Ph (100% ½ prop. Spores) A-3 (2) | 72 | None | 0 | 0.6952 | 1.8 g | 0.45 g | None | 11.25 g |
| | | pulmonarius | Jan. 21, 2022; new Ph-A-3 2^{nd} gen | | | | (w/DAP) | peptone | ferrous | | corn |
| | | | Mar. 2, 2022; Ph | | | | | | sulfate | | starch |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Rockwool | 17.2 | P. | Ph (100% ½ prop. Spores) A-3 (2) | 72 | 2:3 BoP | 11.25 | 0.6952 | 1.8 g | 0.45 g | None | None |
| | | pulmonarius | Jan. 21, 2022; new Ph-A-3 2^{nd} gen | | (baby oil | | (w/DAP) | peptone | ferrous | | |
| | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Rockwool | 17.2 | P. | Ph (100% ½ prop. Spores) A-3 (2) | 72 | 2:3 BoP | 11.25 | 0.6952 | 1.8 g | 0.45 g | None | None |
| | | pulmonarius | Jan. 21, 2022; new Ph-A-3 2^{nd} gen | | (baby oil | | (w/DAP) | peptone | ferrous | | |
| | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 2:3 BoP | 5 | 0.3056 | 0.8 g | 0.2 g | None | None |
| Polyurethane | | pulmonarius | 2^{nd} gen Jun. 26, 2022; (New) Ph-A-3 2^{nd} | | (baby oil | | (w/DAP) | peptone | ferrous | | |
| Cubes | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen Jun. 26, 2022 | | | | | | | | |
| Black | 1.6 | P. | Ph (100% ½ prop. Spores) A-3 (2) | 32 | 2:3 BoP | 5 | 0.3056 | 0.8 g | 0.2 g | None | None |
| Polyurethane | | pulmonarius | 2^{nd} gen Jun. 26, 2022; (New) Ph-A-3 2^{nd} | | (baby oil | | (w/DAP) | peptone | ferrous | | |
| Cubes | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen Jun. 26, 2022 | | | | | | | | |
| Black | 1.6 | P. | Ph (100% ½ prop. Spores) A-3 (2) | 32 | None | 0 | 0.3056 | 0.8 g | 0.2 g | None | None |
| Polyurethane | | pulmonarius | 2^{nd} gen Jun. 26, 2022; (New) Ph-A-3 2^{nd} | | | | (w/DAP) | peptone | ferrous | | |
| Cubes | | | gen Mar. 2, 2022; (New) Ph spores-BoV8-A-2 | | | | | | sulfate | | |
| | | | 3^{rd} gen Jun. 26, 2022; (new) Ph-BoV8-3 | | | | | | | | |
| | | | 3^{rd} gen Jun. 26, 2022 | | | | | | | | |
| Black | 1.6 | P. | Ph (100% ½ prop. Spores) A-3 (2) | 32 | None | 0 | 0.3056 | 0.8 g | 0.2 g | None | None |
| Polyurethane | | pulmonarius | 2^{nd} gen Jun. 26, 2022; (New) Ph-A-3 2^{nd} | | | | (w/DAP) | peptone | ferrous | | |
| Cubes | | | gen Mar. 2, 2022; (New) Ph spores-BoV8-A-2 | | | | | | sulfate | | |
| | | | 3^{rd} gen Jun. 26, 2022; (new) Ph-BoV8-3 | | | | | | | | |
| | | | 3^{rd} gen Jun. 26, 2022 | | | | | | | | |
| Black | 1.6 | P. | Ph (100% ½ prop. Spores) A-3 (2) | 32 | 2:3 BoP | 5 | 0.3056 | 0.8 g | 0.2 g | None | None |
| Polyurethane | | pulmonarius | 2^{nd} gen Jun. 26, 2022; (New) Ph-A-3 2^{nd} | | (baby oil | | (w/DAP) | peptone | ferrous | | |
| Cubes | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen | | | | | | | | |
| | | | Jun. 26, 2022 | | | | | | | | |
| Black | 1.6 | P. | Ph (100% ½ prop. Spores) A-3 (2) | 32 | 2:3 BoP | 5 | 0.3056 | 0.8 g | 0.2 g | None | None |
| Polyurethane | | pulmonarius | 2^{nd} gen Jun. 26, 2022; (New) Ph-A-3 2^{nd} | | (baby oil | | (w/DAP) | peptone | ferrous | | |
| Cubes | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen Jun. 26, 2022 | | | | | | | | |
| Black | 1.6 | P. | Ph (100% ½ prop. Spores) A-3 (2) | 32 | None | 0 | 0.3056 | 0.8 g | 0.2 g | None | None |
| Polyurethane | | pulmonarius | 2^{nd} gen Jun. 26, 2022; (New) Ph-A-3 2^{nd} | | | | (w/DAP) | peptone | ferrous | | |
| Cubes | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen Jun. 26, 2022 | | | | | | | | |
| Black | 1.6 | P. | Ph (100% ½ prop. Spores) A-3 (2) | 32 | None | 0 | 0.3056 | 0.8 g | 0.2 g | None | None |
| Polyurethane | | pulmonarius | 2^{nd} gen Jun. 26, 2022; (New) Ph-A-3 2^{nd} | | | | (w/DAP) | peptone | ferrous | | |
| Cubes | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Black | 1.6 | P. | Ph (100% ½ prop. Spores) A-3 (2) | 32 | 2:3 BoP | 5 | 0.3056 | 0.8 g | 0.2 g | None | None |
| Polyurethane | | pulmonarius | 2^{nd} gen Jun. 26, 2022; (New) Ph-A-3 2^{nd} | | (baby oil | | (w/DAP) | peptone | ferrous | | |
| Cubes | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen Jun. 26, 2022 | | | | | | | | |
| Black | 1.6 | P. | Ph (100% ½ prop. Spores) A-3 (2) | 32 | 2:3 BoP | 5 | 0.3056 | 0.8 g | 0.2 g | None | None |
| Polyurethane | | pulmonarius | 2^{nd} gen Jun. 26, 2022; (New) Ph-A-3 2^{nd} | | (baby oil | | (w/DAP) | peptone | ferrous | | |
| Cubes | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen Jun. 26, 2022 | | | | | | | | |
| Black | 1.6 | P. | Ph (100% ½ prop. Spores) A-3 (2) | 32 | None | 0 | 0.3056 | 0.8 g | 0.2 g | None | None |
| Polyurethane | | pulmonarius | 2^{nd} gen Jun. 26, 2022; (New) Ph-A-3 2^{nd} | | | | (w/DAP) | peptone | ferrous | | |
| Cubes | | | gen Mar. 2, 2022; (New) Ph spores-BoV8-A-2 | | | | | | sulfate | | |
| | | | 3^{rd} gen Jun. 26, 2022; (new) Ph-BoV8-3 | | | | | | | | |
| | | | 3^{rd} gen Jun. 26, 2022 | | | | | | | | |
| Black | 1.6 | P. | Ph (100% ½ prop. Spores) A-3 (2) | 32 | None | 0 | 0.3056 | 0.8 g | 0.2 g | None | None |
| Polyurethane | | pulmonarius | 2^{nd} gen Jun. 26, 2022; (New) Ph-A-3 2^{nd} | | | | (w/DAP) | peptone | ferrous | | |
| Cubes | | | gen Mar. 2, 2022; (New) Ph spores-BoV8-A-2 | | | | | | sulfate | | |
| | | | 3^{rd} gen Jun. 26, 2022; (new) Ph-BoV8-3 | | | | | | | | |
| | | | 3^{rd} gen Jun. 26, 2022 | | | | | | | | |
| Black | 1.6 | P. | Ph (100% ½ prop. Spores) A-3 (2) | 32 | 2:3 BoP | 5 | 0.3056 | 0.8 g | 0.2 g | None | None |
| Polyurethane | | pulmonarius | 2^{nd} gen Jun. 26, 2022; (New) Ph-A-3 2^{nd} | | (baby oil | | (w/DAP) | peptone | ferrous | | |
| Cubes | | | gen Mar. 2, 2022; (New) Ph spores-BoV8-A-2 | | to | | | | sulfate | | |
| | | | 3^{rd} gen Jun. 26, 2022; (new) Ph-BoV8-3 | | paraffin) | | | | | | |
| | | | 3^{rd} gen Jun. 26, 2022 | | | | | | | | |
| Black | 1.6 | P. | Ph (100% ½ prop. Spores) A-3 (2) | 32 | 2:3 BoP | 5 | 0.3056 | 0.8 g | 0.2 g | None | None |
| Polyurethane | | pulmonarius | 2^{nd} gen Jun. 26, 2022; (New) Ph-A-3 2^{nd} | | (baby oil | | (w/DAP) | peptone | ferrous | | |
| Cubes | | | gen Mar. 2, 2022; (New) Ph spores-BoV8-A-2 | | to | | | | sulfate | | |
| | | | 3^{rd} gen Jun. 26, 2022; (new) Ph-BoV8-3 | | paraffin) | | | | | | |
| | | | 3^{rd} gen Jun. 26, 2022 | | | | | | | | |
| Black | 1.6 | P. | Ph (100% ½ prop. Spores) A-3 (2) | 32 | None | 0 | 0.3056 | 0.8 g | 0.2 g | None | None |
| Polyurethane | | pulmonarius | 2^{nd} gen Jun. 26, 2022; (New) Ph-A-3 2^{nd} | | | | (w/DAP) | peptone | ferrous | | |
| Cubes | | | gen Mar. 2, 2022; (New) Ph spores-BoV8-A-2 | | | | | | sulfate | | |
| | | | 3^{rd} gen Jun. 26, 2022; (new) Ph-BoV8-3 | | | | | | | | |
| | | | 3^{rd} gen Jun. 26, 2022 | | | | | | | | |
| Black | 1.6 | P. | Ph (100% ½ prop. Spores) A-3 (2) | 32 | None | 0 | 0.3056 | 0.8 g | 0.2 g | None | None |
| Polyurethane | | pulmonarius | 2^{nd} gen Jun. 26, 2022; (New) Ph-A-3 2^{nd} | | | | (w/DAP) | peptone | ferrous | | |
| Cubes | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen Jun. 26, 2022 | | | | | | | | |
| Rockwool | 6.5 | P. | Ph (100% ½ prop. Spores) A-3 (2) | 32 | 2:3 BoP | 5 | 0.3056 | 0.8 g | 0.2 g | None | None |
| | | pulmonarius | 2^{nd} gen Jun. 26, 2022; (New) Ph-A-3 2^{nd} | | (baby oil | | (w/DAP) | peptone | ferrous | | |
| | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | 2:3 BoP | 5 | 0.3056 | 0.8 g | 0.2 g | None | None |
| | | pulmonarius | 2^{nd} gen Jun. 26, 2022; (New) Ph-A-3 2^{nd} | | (baby oil | | (w/DAP) | peptone | ferrous | | |
| | | | gen Mar. 2, 2022; (New) Ph spores-BoV8-A-2 | | to | | | | sulfate | | |
| | | | 3^{rd} gen Jun. 26, 2022; (new) Ph-BoV8-3 | | paraffin) | | | | | | |
| | | | 3^{rd} gen Jun. 26, 2022 | | | | | | | | |
| Rockwool | 6.5 | P. | Ph (100% ½ prop. Spores) A-3 (2) | 32 | None | 0 | 0.3056 | 0.8 g | 0.2 g | None | None |
| | | pulmonarius | 2^{nd} gen Jun. 26, 2022; (New) Ph-A-3 2^{nd} | | | | (w/DAP) | peptone | ferrous | | |
| | | | gen Mar. 2, 2022; (New) Ph spores-BoV8-A-2 | | | | | | sulfate | | |
| | | | 3^{rd} gen Jun. 26, 2022; (new) Ph-BoV8-3 | | | | | | | | |
| | | | 3^{rd} gen Jun. 26, 2022 | | | | | | | | |
| Rockwool | 6.5 | P. | Ph (100% ½ prop. Spores) A-3 (2) | 32 | None | 0 | 0.3056 | 0.8 g | 0.2 g | None | None |
| | | pulmonarius | 2^{nd} gen Jun. 26, 2022; (New) Ph-A-3 2^{nd} | | | | (w/DAP) | peptone | ferrous | | |
| | | | gen Mar. 2, 2022; (New) Ph spores-BoV8-A-2 | | | | | | sulfate | | |
| | | | 3^{rd} gen Jun. 26, 2022; (new) Ph-BoV8-3 | | | | | | | | |
| | | | 3^{rd} gen Jun. 26, 2022 | | | | | | | | |
| Rockwool | 6.5 | P. | Ph (100% ½ prop. Spores) A-3 (2) | 32 | 2:3 BoP | 5 | 0.3056 | 0.8 g | 0.2 g | None | None |
| | | pulmonarius | 2^{nd} gen Jun. 26, 2022; (New) Ph-A-3 2^{nd} | | (baby oil | | (w/DAP) | peptone | ferrous | | |
| | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | 2:3 BoP | 5 | 0.3056 | 0.8 g | 0.2 g | None | None |
| | | pulmonarius | 2^{nd} gen Jun. 26, 2022; (New) Ph-A-3 2^{nd} | | (baby oil | | (w/DAP) | peptone | ferrous | | |
| | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | 2:3 BoP | 5 | 0.3056 | 0.8 g | 0.2 g | None | None |
| | | pulmonarius | 2^{nd} gen Jun. 26, 2022; (New) Ph-A-3 2^{nd} | | (baby oil | | (w/DAP) | peptone | ferrous | | |
| | | | gen Mar. 2, 2022; (New) Ph spores-BoV8-A-2 | | to | | | | sulfate | | |
| | | | 3^{rd} gen Jun. 26, 2022; (new) Ph-BoV8-3 | | paraffin) | | | | | | |
| | | | 3^{rd} gen Jun. 26, 2022 | | | | | | | | |
| Rockwool | 6.5 | P. | Ph (100% ½ prop. Spores) A-3 (2) | 32 | 2:3 BoP | 5 | 0.3056 | 0.8 g | 0.2 g | None | None |
| | | pulmonarius | 2^{nd} gen Jun. 26, 2022; (New) Ph-A-3 2^{nd} | | (baby oil | | (w/DAP) | peptone | ferrous | | |
| | | | gen Mar. 2, 2022; (New) Ph spores-BoV8-A-2 | | to | | | | sulfate | | |
| | | | 3^{rd} gen Jun. 26, 2022; (new) Ph-BoV8-3 | | paraffin) | | | | | | |
| | | | 3^{rd} gen Jun. 26, 2022 | | | | | | | | |
| Rockwool | 6.5 | P. | Ph (100% ½ prop. Spores) A-3 (2) | 32 | None | 0 | 0.3056 | 0.8 g | 0.2 g | None | None |
| | | pulmonarius | 2^{nd} gen Jun. 26, 2022; (New) Ph-A-3 2^{nd} | | | | (w/DAP) | peptone | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | None | 0 | 0.3056 | 0.8 g | 0.2 g | None | None |
| | | pulmonarius | 2^{nd} gen Jun. 26, 2022; (New) Ph-A-3 2^{nd} | | | | (w/DAP) | peptone | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | None | 0 | 0.3056 | 0.8 g | 0.2 g | None | None |
| | | pulmonarius | 2^{nd} gen Jun. 26, 2022; (New) Ph-A-3 2^{nd} | | | | (w/DAP) | peptone | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | None | 0 | 0.3056 | 0.8 g | 0.2 g | None | None |
| | | pulmonarius | 2^{nd} gen Jun. 26, 2022; (New) Ph-A-3 2^{nd} | | | | (w/DAP) | peptone | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | 2:3 BoP | 5 | 0.3056 | 0.8 g | 0.2 g | None | None |
| | | pulmonarius | 2^{nd} gen Jun. 26, 2022; (New) Ph-A-3 2^{nd} | | (baby oil | | (w/DAP) | peptone | ferrous | | |
| | | | gen Mar. 2, 2022; (New) Ph spores-BoV8-A-2 | | to | | | | sulfate | | |
| | | | 3^{rd} gen Jun. 26, 2022; (new) Ph-BoV8-3 | | paraffin) | | | | | | |
| | | | 3^{rd} gen Jun. 26, 2022 | | | | | | | | |
| Rockwool | 6.5 | P. | Ph (100% ½ prop. Spores) A-3 (2) | 32 | 2:3 BoP | 5 | 0.3056 | 0.8 g | 0.2 g | None | None |
| | | pulmonarius | 2^{nd} gen Jun. 26, 2022; (New) Ph-A-3 2^{nd} | | (baby oil | | (w/DAP) | peptone | ferrous | | |
| | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | 2:3 BoP | 5 | 0.3056 | 0.8 g | 0.2 g | None | None |
| | | pulmonarius | 2^{nd} gen Jun. 26, 2022; (New) Ph-A-3 2^{nd} | | (baby oil | | (w/DAP) | peptone | ferrous | | |
| | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | 2:3 BoP | 5 | 0.3056 | 0.8 g | 0.2 g | None | None |
| | | pulmonarius | 2^{nd} gen Jun. 26, 2022; (New) Ph-A-3 2^{nd} | | (baby oil | | (w/DAP) | peptone | ferrous | | |
| | | | gen Mar. 2, 2022; (New) Ph spores-BoV8-A-2 | | to | | | | sulfate | | |
| | | | 3^{rd} gen Jun. 26, 2022; (new) Ph-BoV8-3 | | paraffin) | | | | | | |
| | | | 3^{rd} gen Jun. 26, 2022 | | | | | | | | |
| Rockwool | 6.5 | P. | Ph (100% ½ prop. Spores) A-3 (2) | 32 | None | 0 | 0.3056 | 0.8 g | 0.2 g | None | None |
| | | pulmonarius | 2^{nd} gen Jun. 26, 2022; (New) Ph-A-3 2^{nd} | | | | (w/DAP) | peptone | ferrous | | |
| | | | gen Mar. 2, 2022; (New) Ph spores-BoV8-A-2 | | | | | | sulfate | | |
| | | | 3^{rd} gen Jun. 26, 2022; (new) Ph-BoV8-3 | | | | | | | | |
| | | | 3^{rd} gen Jun. 26, 2022 | | | | | | | | |
| Rockwool | 6.5 | P. | Ph (100% ½ prop. Spores) A-3 (2) | 32 | None | 0 | 0.3056 | 0.8 g | 0.2 g | None | None |
| | | pulmonarius | 2^{nd} gen Jun. 26, 2022; (New) Ph-A-3 2^{nd} | | | | (w/DAP) | peptone | ferrous | | |
| | | | gen Mar. 2, 2022; (New) Ph spores-BoV8-A-2 | | | | | | sulfate | | |
| | | | 3^{rd} gen Jun. 26, 2022; (new) Ph-BoV8-3 | | | | | | | | |
| | | | 3^{rd} gen Jun. 26, 2022 | | | | | | | | |
| Rockwool | 6.5 | P. | Ph (100% ½ prop. Spores) A-3 (2) | 32 | None | 0 | 0.3056 | 0.8 g | 0.2 g | None | None |
| | | pulmonarius | 2^{nd} gen Jun. 26, 2022; (New) Ph-A-3 2^{nd} | | | | (w/DAP) | peptone | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | None | 0 | 0.3056 | 0.8 g | 0.2 g | None | None |
| | | pulmonarius | 2^{nd} gen Jun. 26, 2022; (New) Ph-A-3 2^{nd} | | | | (w/DAP) | peptone | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Black | 1.6 | P. | Ph (100% ½ prop. Spores) A-3 (2) | 32 | 1:1 BoP | 5 | 0.3056 | 0.8 g | 0.2 g | None | None |
| Polyurethane | | pulmonarius | 2^{nd} gen Jun. 26, 2022; (New) Ph-A-3 2^{nd} | | (baby oil | | (w/DAP) | peptone | ferrous | | |
| Cubes | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen | | | | | | | | |
| | | | Jun. 26, 2022 | | | | | | | | |
| Black | 1.6 | P. | Ph (100% ½ prop. Spores) A-3 (2) | 32 | 1:1 BoP | 5 | 0.3056 | 0.8 g | 0.2 g | None | None |
| Polyurethane | | pulmonarius | 2^{nd} gen Jun. 26, 2022; (New) Ph-A-3 2^{nd} | | (baby oil | | (w/DAP) | peptone | ferrous | | |
| Cubes | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen | | | | | | | | |
| | | | Jun. 26, 2022 | | | | | | | | |
| Black | 1.6 | P. | Ph (100% ½ prop. Spores) A-3 (2) | 32 | None | 0 | 0.3056 | 0.8 g | 0.2 g | None | None |
| Polyurethane | | pulmonarius | 2^{nd} gen Jun. 26, 2022; (New) Ph-A-3 2^{nd} | | | | (w/DAP) | peptone | ferrous | | |
| Cubes | | | gen Mar. 2, 2022; (New) Ph spores-BoV8-A-2 | | | | | | sulfate | | |
| | | | 3^{rd} gen Jun. 26, 2022; (new) Ph-BoV8-3 | | | | | | | | |
| | | | 3^{rd} gen Jun. 26, 2022 | | | | | | | | |
| Black | 1.6 | P. | Ph (100% ½ prop. Spores) A-3 (2) | 32 | None | 0 | 0.3056 | 0.8 g | 0.2 g | None | None |
| Polyurethane | | pulmonarius | 2^{nd} gen Jun. 26, 2022; (New) Ph-A-3 2^{nd} | | | | (w/DAP) | peptone | ferrous | | |
| Cubes | | | gen Mar. 2, 2022; (New) Ph spores-BoV8-A-2 | | | | | | sulfate | | |
| | | | 3^{rd} gen Jun. 26, 2022; (new) Ph-BoV8-3 | | | | | | | | |
| | | | 3^{rd} gen Jun. 26, 2022 | | | | | | | | |
| Black | 1.6 | P. | Ph (100% ½ prop. Spores) A-3 (2) | 32 | 2:3 BoP | 5 | 0.3056 | 0.14 g | 0.2 g | None | None |
| Polyurethane | | pulmonarius | Jan. 21, 2022; new Ph-A-3 2^{nd} gen | | (baby oil | | (w/DAP) | urea | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 2:3 BoP | 5 | 0.3056 | 0.14 g | 0.2 g | None | None |
| Polyurethane | | pulmonarius | Jan. 21, 2022; new Ph-A-3 2^{nd} gen | | (baby oil | | (w/DAP) | urea | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 2:3 BoP | 5 | 0.3056 | 0.14 g | 0.2 g | None | None |
| Polyurethane | | pulmonarius | Jan. 21, 2022; new Ph-A-3 2^{nd} gen | | (baby oil | | (w/DAP) | urea | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 2:3 BoP | 5 | 0.3056 | 0.14 g | 0.2 g | None | None |
| Polyurethane | | pulmonarius | Jan. 21, 2022; new Ph-A-3 2^{nd} gen | | (baby oil | | (w/DAP) | urea | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | None | 0 | 0.3056 | 0.14 g | 0.2 g | None | None |
| Polyurethane | | pulmonarius | Jan. 21, 2022; new Ph-A-3 2^{nd} gen | | | | (w/DAP) | urea | ferrous | | |
| Cubes | | | Mar. 2, 2022; Ph | | | | | | sulfate | | |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | None | 0 | 0.3056 | 0.14 g | 0.2 g | None | None |
| Polyurethane | | pulmonarius | Jan. 21, 2022; new Ph-A-3 2^{nd} gen | | | | (w/DAP) | urea | ferrous | | |
| Cubes | | | Mar. 2, 2022; Ph | | | | | | sulfate | | |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | None | 0 | 0.3056 | 0.14 g | 0.2 g | None | None |
| Polyurethane | | pulmonarius | Jan. 21, 2022; new Ph-A-3 2^{nd} gen | | | | (w/DAP) | urea | ferrous | | |
| Cubes | | | Mar. 2, 2022; Ph | | | | | | sulfate | | |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | None | 0 | 0.3056 | 0.14 g | 0.2 g | None | None |
| Polyurethane | | pulmonarius | Jan. 21, 2022; new Ph-A-3 2^{nd} gen | | | | (w/DAP) | urea | ferrous | | |
| Cubes | | | Mar. 2, 2022; Ph | | | | | | sulfate | | |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 2:3 BoP | 5 | 0.3056 | 0.14 g | 0.2 g | None | None |
| Polyurethane | | pulmonarius | Jan. 21, 2022; new Ph-A-3 2^{nd} gen | | (baby oil | | (w/DAP) | urea | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | 2:3 BoP | 5 | 0.3056 | 0.14 g | 0.2 g | None | None |
| Polyurethane | | pulmonarius | Jan. 21, 2022; new Ph-A-3 2^{nd} gen | | (baby oil | | (w/DAP) | urea | ferrous | | |
| Cubes | | | Mar. 2, 2022; Ph | | to | | | | sulfate | | |
| | | | spores BoV-A-2 2^{nd} gen Mar. 2, 2022; | | paraffin) | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | None | 0 | 0.3056 | 0.14 g | 0.2 g | None | None |
| Polyurethane | | pulmonarius | Jan. 21, 2022; new Ph-A-3 2^{nd} gen | | | | (w/DAP) | urea | ferrous | | |
| Cubes | | | Mar. 2, 2022; Ph | | | | | | sulfate | | |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| Black | 1.6 | P. | Ph (100% ½ prop. Spores) A-3 (2) | 32 | None | 0 | 0.3056 | 0.14 g | 0.2 g | None | None |
| Polyurethane | | pulmonarius | Jan. 21, 2022; new Ph-A-3 2^{nd} gen | | | | (w/DAP) | urea | ferrous | | |
| Cubes | | | Mar. 2, 2022; Ph | | | | | | sulfate | | |
| | | | spores BoV-A-2 2^{nd} gen Mar. 2, 2022; | | | | | | | | |
| | | | new Ph-BoV8-3 2^{nd} gen Mar. 2, 2022 | | | | | | | | |
| | | | Ph (100% ½ prop. Spores) A-3 (2) | | | | | | | | |
| Rockwool | 6.5 | P. | Ph (100% ½ prop. Spores) A-3 (2) | 32 | 2:3 BoP | 5 | 0.3056 | 0.14 g | 0.2 g | None | None |
| | | pulmonarius | 2^{nd} gen Jun. 26, 2022; (New) Ph-A-3 2^{nd} | | (baby oil | | (w/DAP) | urea | ferrous | | |
| | | | gen Mar. 2, 2022; (New) Ph spores-BoV8-A-2 | | to | | | | sulfate | | |
| | | | 3^{rd} gen Jun. 26, 2022; (new) Ph-BoV8-3 | | paraffin) | | | | | | |
| | | | 3^{rd} gen Jun. 26, 2022 | | | | | | | | |
| Rockwool | 6.5 | P. | Ph (100% ½ prop. Spores) A-3 (2) | 32 | 2:3 BoP | 5 | 0.3056 | 0.14 g | 0.2 g | None | None |
| | | pulmonarius | 2^{nd} gen Jun. 26, 2022; (New) Ph-A-3 2^{nd} | | (baby oil | | (w/DAP) | urea | ferrous | | |
| | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | None | 0 | 0.3056 | 0.14 g | 0.2 g | None | None |
| | | pulmonarius | 2^{nd} gen Jun. 26, 2022; (New) Ph-A-3 2^{nd} | | | | (w/DAP) | urea | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | None | 0 | 0.3056 | 0.14 g | 0.2 g | None | None |
| | | pulmonarius | 2^{nd} gen Jun. 26, 2022; (New) Ph-A-3 2^{nd} | | | | (w/DAP) | urea | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | 2:3 BoP | 5 | 0.3056 | 0.14 g | 0.2 g | None | None |
| | | pulmonarius | 2^{nd} gen Jun. 26, 2022; (New) Ph-A-3 2^{nd} | | (baby oil | | (w/DAP) | urea | ferrous | | |
| | | | gen | | to | | | | sulfate | | |
| | | | Mar. 2, 2022; (New) Ph spores-BoV8-A-2 | | paraffin) | | | | | | |
| | | | 3^{rd} gen Jun. 26, 2022; (new) Ph-BoV8-3 | | | | | | | | |
| | | | 3^{rd} gen Jun. 26, 2022 | | | | | | | | |
| Rockwool | 6.5 | P. | Ph (100% ½ prop. Spores) A-3 (2) | 32 | 2:3 BoP | 5 | 0.3056 | 0.14 g | 0.2 g | None | None |
| | | pulmonarius | 2^{nd} gen Jun. 26, 2022; (New) Ph-A-3 2^{nd} | | (baby oil | | (w/DAP) | urea | ferrous | | |
| | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | 2:3 BoP | 5 | 0.3056 | 0.14 g | 0.2 g | None | None |
| | | pulmonarius | 2^{nd} gen Jun. 26, 2022; (New) Ph-A-3 2^{nd} | | (baby oil | | (w/DAP) | urea | ferrous | | |
| | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | 2:3 BoP | 5 | 0.3056 | 0.14 g | 0.2 g | None | None |
| | | pulmonarius | 2^{nd} gen Jun. 26, 2022; (New) Ph-A-3 2^{nd} | | (baby oil | | (w/DAP) | urea | ferrous | | |
| | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | None | 0 | 0.3056 | 0.14 g | 0.2 g | None | None |
| | | pulmonarius | 2^{nd} gen Jun. 26, 2022; (New) Ph-A-3 2^{nd} | | | | (w/DAP) | urea | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | None | 0 | 0.3056 | 0.14 g | 0.2 g | None | None |
| | | pulmonarius | 2^{nd} gen Jun. 26, 2022; (New) Ph-A-3 2^{nd} | | | | (w/DAP) | urea | ferrous | | |
| | | | gen | | | | | | sulfate | | |
| | | | Mar. 2, 2022; (New) Ph spores-BoV8-A-2 | | | | | | | | |
| | | | 3^{rd} gen Jun. 26, 2022; (new) Ph-BoV8-3 | | | | | | | | |
| | | | 3^{rd} gen Jun. 26, 2022 | | | | | | | | |
| Rockwool | 6.5 | P. | Ph (100% ½ prop. Spores) A-3 (2) | 32 | None | 0 | 0.3056 | 0.14 g | 0.2 g | None | None |
| | | pulmonarius | 2^{nd} gen Jun. 26, 2022; (New) Ph-A-3 2^{nd} | | | | (w/DAP) | urea | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | None | 0 | 0.3056 | 0.14 g | 0.2 g | None | None |
| | | pulmonarius | 2^{nd} gen Jun. 26, 2022; (New) Ph-A-3 2^{nd} | | | | (w/DAP) | urea | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | 2:3 BoP | 5 | 0.3056 | 0.14 g | 0.2 g | None | None |
| | | pulmonarius | 2^{nd} gen Jun. 26, 2022; (New) Ph-A-3 2^{nd} | | (baby oil | | (w/DAP) | urea | ferrous | | |
| | | | gen Mar. 2, 2022; (New) Ph spores-BoV8-A-2 | | to | | | | sulfate | | |
| | | | 3^{rd} gen Jun. 26, 2022; (new) Ph-BoV8-3 | | paraffin) | | | | | | |
| | | | 3^{rd} gen Jun. 26, 2022 | | | | | | | | |
| Rockwool | 6.5 | P. | Ph (100% ½ prop. Spores) A-3 (2) | 32 | 2:3 BoP | 5 | 0.3056 | 0.14 g | 0.2 g | None | None |
| | | pulmonarius | 2^{nd} gen Jun. 26, 2022; (New) Ph-A-3 2^{nd} | | (baby oil | | (w/DAP) | urea | ferrous | | |
| | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | None | 0 | 0.3056 | 0.14 g | 0.2 g | None | None |
| | | pulmonarius | 2^{nd} gen Jun. 26, 2022; (New) Ph-A-3 2^{nd} | | | | (w/DAP) | urea | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Rockwool | 6.5 | P. | Ph (100% ½ prop. Spores) A-3 (2) | 32 | None | 0 | 0.3056 | 0.14 g | 0.2 g | None | None |
| | | pulmonarius | 2^{nd} gen Jun. 26, 2022; (New) Ph-A-3 2^{nd} | | | | (w/DAP) | urea | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Polyurethane | 16 | P. | Ph (100% ½ prop. Spores) A-3 (2) | 157 | None | 0 | 1.52775 | 0.6878 g | 0.9825 g | None | None |
| foam shreds | | pulmonarius | 2^{nd} gen Jun. 26, 2022; (New) Ph-A-3 2^{nd} | | | | (w/DAP) | urea | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Polyurethane | 16 | P. | Ph (100% ½ prop. Spores) A-3 (2) | 157 | None | 0 | 1.52775 | 0.6878 g | 0.9825 g | None | None |
| foam shreds | | pulmonarius | 2^{nd} gen Jun. 26, 2022; (New) Ph-A-3 2^{nd} | | | | (w/DAP) | urea | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Polyurethane | 8 | P. | Ph (100% ½ prop. Spores) A-3 (2) | 157 | None | 0 | 1.52775 | 0.6878 g | 0.9825 g | None | None |
| foam shreds | | pulmonarius | 2^{nd} gen Jun. 26, 2022; (New) Ph-A-3 2^{nd} | | | | (w/DAP) | urea | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Polyurethane | 8 | P. | Ph (100% ½ prop. Spores) A-3 (2) | 157 | None | 0 | 1.52775 | 0.6878 g | 0.9825 g | None | None |
| foam shreds | | pulmonarius | 2^{nd} gen Jun. 26, 2022; (New) Ph-A-3 2^{nd} | | | | (w/DAP) | urea | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Polyurethane | 16 | P. | Ph (100% ½ prop. Spores) A-3 (2) | 157 | 2:3 BoP | 5 | 1.52775 | 0.6878 g | 0.9825 g | None | None |
| foam shreds | | pulmonarius | 2^{nd} gen Jun. 26, 2022; (New) Ph-A-3 2^{nd} | | (baby oil | | (w/DAP) | urea | ferrous | | |
| | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen | | | | | | | | |
| | | | Jun. 26, 2022 | | | | | | | | |
| Polyurethane | 16 | P. | Ph (100% ½ prop. Spores) A-3 (2) | 157 | 2:3 BoP | 5 | 1.52775 | 0.6878 g | 0.9825 g | None | None |
| foam shreds | | pulmonarius | 2^{nd} gen Jun. 26, 2022; (New) Ph-A-3 2^{nd} | | (baby oil | | (w/DAP) | urea | ferrous | | |
| | | | gen Mar. 2, 2022; (New) Ph spores-BoV8-A-2 | | to | | | | sulfate | | |
| | | | 3^{rd} gen Jun. 26, 2022; (new) Ph-BoV8-3 | | paraffin) | | | | | | |
| | | | 3^{rd} gen Jun. 26, 2022 | | | | | | | | |
| Polyurethane | 8 | P. | Ph (100% ½ prop. Spores) A-3 (2) | 157 | 2:3 BoP | 2.5 | 1.52775 | 0.6878 g | 0.9825 g | None | None |
| foam shreds | | pulmonarius | 2^{nd} gen Jun. 26, 2022; (New) Ph-A-3 2^{nd} | | (baby oil | | (w/DAP) | urea | ferrous | | |
| | | | gen Mar. 2, 2022; (New) Ph spores-BoV8-A-2 | | to | | | | sulfate | | |
| | | | 3^{rd} gen Jun. 26, 2022; (new) Ph-BoV8-3 | | paraffin) | | | | | | |
| | | | 3^{rd} gen Jun. 26, 2022 | | | | | | | | |
| Polyurethane | 8 | P. | Ph (100% ½ prop. Spores) A-3 (2) | 157 | 2:3 BoP | 2.5 | 1.52775 | 0.6878 g | 0.9825 g | None | None |
| foam shreds | | pulmonarius | 2^{nd} gen Jun. 26, 2022; (New) Ph-A-3 2^{nd} | | (baby oil | | (w/DAP) | urea | ferrous | | |
| | | | gen Mar. 2, 2022; (New) Ph spores-BoV8-A-2 | | to | | | | sulfate | | |
| | | | 3^{rd} gen Jun. 26, 2022; (new) Ph-BoV8-3 | | paraffin) | | | | | | |
| | | | 3^{rd} gen Jun. 26, 2022 | | | | | | | | |
| Polyurethane | 16 | P. | Ph (100% ½ prop. Spores) A-3 (2) | 157 | None | 0 | 1.52775 | 3.93 g | 0.9825 g | None | None |
| foam shreds | | pulmonarius | 2^{nd} gen Jun. 26, 2022; (New) Ph-A-3 2^{nd} | | | | (w/DAP) | peptone | ferrous | | |
| | | | gen Mar. 2, 2022; (New) Ph spores-BoV8-A-2 | | | | | | sulfate | | |
| | | | 3^{rd} gen Jun. 26, 2022; (new) Ph-BoV8-3 | | | | | | | | |
| | | | 3^{rd} gen Jun. 26, 2022 | | | | | | | | |
| Polyurethane | 16 | P. | Ph (100% ½ prop. Spores) A-3 (2) | 157 | None | 0 | 1.52775 | 3.93 g | 0.9825 g | None | None |
| foam shreds | | pulmonarius | 2^{nd} gen Jun. 26, 2022; (New) Ph-A-3 2^{nd} | | | | (w/DAP) | peptone | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Polyurethane | 8 | P. | Ph (100% ½ prop. Spores) A-3 (2) | 157 | None | 0 | 1.52775 | 3.93 g | 0.9825 g | None | None |
| foam shreds | | pulmonarius | 2^{nd} gen Jun. 26, 2022; (New) Ph-A-3 2^{nd} | | | | (w/DAP) | peptone | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Polyurethane | 8 | P. | Ph (100% ½ prop. Spores) A-3 (2) | 157 | None | 0 | 1.52775 | 3.93 g | 0.9825 g | None | None |
| foam shreds | | pulmonarius | 2^{nd} gen Jun. 26, 2022; (New) Ph-A-3 2^{nd} | | | | (w/DAP) | peptone | ferrous | | |
| | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Black | 16 | P. | Ph (100% ½ prop. Spores) A-3 (2) | 157 | None | 0 | 1.52775 | 0.6878 g | 0.9825 g | None | None |
| polyurethane | | pulmonarius | 2^{nd} gen Jun. 26, 2022; (New) Ph-A-3 2^{nd} | | | | (w/DAP) | urea | ferrous | | |
| foam cubes | | | gen Mar. 2, 2022; (New) Ph spores-BoV8-A-2 | | | | | | sulfate | | |
| | | | 3^{rd} gen Jun. 26, 2022; (new) Ph-BoV8-3 | | | | | | | | |
| | | | 3^{rd} gen Jun. 26, 2022 | | | | | | | | |
| Black | 16 | P. | Ph (100% ½ prop. Spores) A-3 (2) | 157 | None | 0 | 1.52775 | 0.6878 g | 0.9825 g | None | None |
| polyurethane | | pulmonarius | 2^{nd} gen Jun. 26, 2022; (New) Ph-A-3 2^{nd} | | | | (w/DAP) | urea | ferrous | | |
| foam cubes | | | gen Mar. 2, 2022; (New) Ph spores-BoV8-A-2 | | | | | | sulfate | | |
| | | | 3^{rd} gen Jun. 26, 2022; (new) Ph-BoV8-3 | | | | | | | | |
| | | | 3^{rd} gen Jun. 26, 2022 | | | | | | | | |
| Black | 8 | P. | Ph (100% ½ prop. Spores) A-3 (2) | 157 | None | 0 | 1.52775 | 0.6878 g | 0.9825 g | None | None |
| polyurethane | | pulmonarius | 2^{nd} gen Jun. 26, 2022; (New) Ph-A-3 2^{nd} | | | | (w/DAP) | urea | ferrous | | |
| foam cubes | | | gen Mar. 2, 2022; (New) Ph spores-BoV8-A-2 | | | | | | sulfate | | |
| | | | 3^{rd} gen Jun. 26, 2022; (new) Ph-BoV8-3 | | | | | | | | |
| | | | 3^{rd} gen Jun. 26, 2022 | | | | | | | | |
| Black | 8 | P. | Ph (100% ½ prop. Spores) A-3 (2) | 157 | None | 0 | 1.52775 | 0.6878 g | 0.9825 g | None | None |
| polyurethane | | pulmonarius | 2^{nd} gen Jun. 26, 2022; (New) Ph-A-3 2^{nd} | | | | (w/DAP) | urea | ferrous | | |
| foam cubes | | | gen Mar. 2, 2022; (New) Ph spores-BoV8-A-2 | | | | | | sulfate | | |
| | | | 3^{rd} gen Jun. 26, 2022; (new) Ph-BoV8-3 | | | | | | | | |
| | | | 3^{rd} gen Jun. 26, 2022 | | | | | | | | |
| Black | 16 | P. | Ph (100% ½ prop. Spores) A-3 (2) | 157 | None | 0 | 1.52775 | 3.93 g | 0.9825 g | None | None |
| polyurethane | | pulmonarius | 2^{nd} gen Jun. 26, 2022; (New) Ph-A-3 2^{nd} | | | | (w/DAP) | peptone | ferrous | | |
| foam cubes | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Black | 16 | P. | Ph (100% ½ prop. Spores) A-3 (2) | 157 | None | 0 | 1.52775 | 3.93 g | 0.9825 g | None | None |
| polyurethane | | pulmonarius | 2^{nd} gen Jun. 26, 2022; (New) Ph-A-3 2^{nd} | | | | (w/DAP) | peptone | ferrous | | |
| foam cubes | | | gen Mar. 2, 2022; (New) Ph spores-BoV8-A-2 | | | | | | sulfate | | |
| | | | 3^{rd} gen Jun. 26, 2022; (new) Ph-BoV8-3 | | | | | | | | |
| | | | 3^{rd} gen Jun. 26, 2022 | | | | | | | | |
| Black | 8 | P. | Ph (100% ½ prop. Spores) A-3 (2) | 157 | None | 0 | 1.52775 | 3.93 g | 0.9825 g | None | None |
| polyurethane | | pulmonarius | 2^{nd} gen Jun. 26, 2022; (New) Ph-A-3 2^{nd} | | | | (w/DAP) | peptone | ferrous | | |
| foam cubes | | | gen Mar. 2, 2022; (New) Ph spores-BoV8-A-2 | | | | | | sulfate | | |
| | | | 3^{rd} gen Jun. 26, 2022; (new) Ph-BoV8-3 | | | | | | | | |
| | | | 3^{rd} gen Jun. 26, 2022 | | | | | | | | |
| Black | 8 | P. | Ph (100% ½ prop. Spores) A-3 (2) | 157 | None | 0 | 1.52775 | 3.93 g | 0.9825 g | None | None |
| polyurethane | | pulmonarius | 2^{nd} gen Jun. 26, 2022; (New) Ph-A-3 2^{nd} | | | | (w/DAP) | peptone | ferrous | | |
| foam cubes | | | gen Mar. 2, 2022; (New) Ph spores- | | | | | | sulfate | | |
| | | | BoV8-A-2 3^{rd} gen Jun. 26, 2022; (new) | | | | | | | | |
| | | | Ph-BoV8-3 3^{rd} gen | | | | | | | | |
| | | | Jun. 26, 2022 | | | | | | | | |
| Polyurethane | 16 | P. | Ph (100% ½ prop. Spores) A-3 (2) | 157 | 2:3 BoP | 5 | 1.52775 | 3.93 g | 0.9825 g | None | None |
| foam shreds | | pulmonarius | 2^{nd} gen Jun. 26, 2022; (New) Ph-A-3 2^{nd} | | (baby oil | | (w/DAP) | peptone | ferrous | | |
| | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen | | | | | | | | |
| | | | Jun. 26, 2022 | | | | | | | | |
| Polyurethane | 16 | P. | Ph (100% ½ prop. Spores) A-3 (2) | 157 | 2:3 BoP | 5 | 1.52775 | 3.93 g | 0.9825 g | None | None |
| foam shreds | | pulmonarius | 2^{nd} gen Jun. 26, 2022; (New) Ph-A-3 2^{nd} | | (baby oil | | (w/DAP) | peptone | ferrous | | |
| | | | gen Mar. 2, 2022; (New) Ph spores- | | to | | | | sulfate | | |
| | | | BoV8-A-2 3^{rd} gen Jun. 26, 2022; (new) | | paraffin) | | | | | | |
| | | | Ph-BoV8-3 3^{rd} gen | | | | | | | | |
| | | | Jun. 26, 2022 | | | | | | | | |
| Polyurethane | 8 | P. | Ph (100% ½ prop. Spores) A-3 (2) 2^{nd} gen | 157 | 2:3 BoP | 2.5 | 1.52775 | 3.93 g | 0.9825 g | None | None |
| foam shreds | | pulmonarius | Jun. 26, 2022; (New) Ph-A-3 2^{nd} gen Mar. 2, 2022; | | (baby oil | | (w/DAP) | peptone | ferrous | | |
| | | | (New) Ph spores-BoV8-A-2 3^{rd} gen | | to | | | | sulfate | | |
| | | | Jun. 26, 2022; (new) Ph-BoV8-3 3^{rd} gen | | paraffin) | | | | | | |
| | | | Jun. 26, 2022 | | | | | | | | |
| Polyurethane | 8 | P. | Ph (100% ½ prop. Spores) A-3 (2) 2^{nd} gen | 157 | 2:3 BoP | 2.5 | 1.52775 | 3.93 g | 0.9825 g | None | None |
| foam shreds | | pulmonarius | Jun. 26, 2022; (New) Ph-A-3 2^{nd} gen Mar. 2, 2022; | | (baby oil | | (w/DAP) | peptone | ferrous | | |
| | | | (New) Ph spores-BoV8-A-2 3^{rd} gen | | to | | | | sulfate | | |
| | | | Jun. 26, 2022; (new) Ph-BoV8-3 3^{rd} gen | | paraffin) | | | | | | |
| | | | Jun. 26, 2022 | | | | | | | | |
| Black | 16 | P. | Ph (100% ½ prop. Spores) A-3 (2) 2^{nd} gen | 157 | 2:3 BoP | 5 | 1.52775 | 0.6878 g | 0.9825 g | None | None |
| polyurethane | | pulmonarius | Jun. 26, 2022; (New) Ph-A-3 2^{nd} gen Mar. 2, 2022; | | (baby oil | | (w/DAP) | urea | ferrous | | |
| foam cubes | | | (New) Ph spores-BoV8-A-2 3^{rd} gen | | to | | | | sulfate | | |
| | | | Jun. 26, 2022; (new) Ph-BoV8-3 3^{rd} gen | | paraffin) | | | | | | |
| | | | Jun. 26, 2022 | | | | | | | | |
| Black | 16 | P. | Ph (100% ½ prop. Spores) A-3 (2) 2^{nd} gen | 157 | 2:3 BoP | 5 | 1.52775 | 0.6878 g | 0.9825 g | None | None |
| polyurethane | | pulmonarius | Jun. 26, 2022; (New) Ph-A-3 2^{nd} gen Mar. 2, 2022; | | (baby oil | | (w/DAP) | urea | ferrous | | |
| foam cubes | | | (New) Ph spores-BoV8-A-2 3^{rd} gen | | to | | | | sulfate | | |
| | | | Jun. 26, 2022; (new) Ph-BoV8-3 3^{rd} gen | | paraffin) | | | | | | |
| | | | Jun. 26, 2022 | | | | | | | | |
| Black | 8 | P. | Ph (100% ½ prop. Spores) A-3 (2) 2^{nd} gen | 157 | 2:3 BoP | 2.5 | 1.52775 | 0.6878 g | 0.9825 g | None | None |
| polyurethane | | pulmonarius | Jun. 26, 2022; (New) Ph-A-3 2^{nd} gen Mar. 2, 2022; | | (baby oil | | (w/DAP) | urea | ferrous | | |
| foam cubes | | | (New) Ph spores-BoV8-A-2 3^{rd} gen | | to | | | | sulfate | | |
| | | | Jun. 26, 2022; (new) Ph-BoV8-3 3^{rd} gen | | paraffin) | | | | | | |
| | | | Jun. 26, 2022 | | | | | | | | |
| Black | 8 | P. | Ph (100% ½ prop. Spores) A-3 (2) 2^{nd} gen | 157 | 2:3 BoP | 2.5 | 1.52775 | 0.6878 g | 0.9825 g | None | None |
| polyurethane | | pulmonarius | Jun. 26, 2022; (New) Ph-A-3 2^{nd} gen | | (baby oil | | (w/DAP) | urea | ferrous | | |
| foam cubes | | | Mar. 2, 2022; (New) Ph spores-BoV8-A-2 3^{rd} | | to | | | | sulfate | | |
| | | | gen Jun. 26, 2022; (new) Ph-BoV8-3 3^{rd} gen | | paraffin) | | | | | | |
| | | | Jun. 26, 2022 | | | | | | | | |
| Black | 16 | P. | Ph (100% ½ prop. Spores) A-3 (2) 2^{nd} gen | 157 | 2:3 BoP | 5 | 1.52775 | 3.93 g | 0.9825 g | None | None |
| polyurethane | | pulmonarius | Jun. 26, 2022; (New) Ph-A-3 2^{nd} gen | | (baby oil | | (w/DAP) | peptone | ferrous | | |
| foam cubes | | | Mar. 2, 2022; (New) Ph spores-BoV8-A-2 3^{rd} | | to | | | | sulfate | | |
| | | | gen Jun. 26, 2022; (new) Ph-BoV8-3 3^{rd} gen | | paraffin) | | | | | | |
| | | | Jun. 26, 2022 | | | | | | | | |
| Black | 16 | P. | Ph (100% ½ prop. Spores) A-3 (2) 2^{nd} gen | 157 | 2:3 BoP | 5 | 1.52775 | 3.93 g | 0.9825 g | None | None |
| polyurethane | | pulmonarius | Jun. 26, 2022; (New) Ph-A-3 2^{nd} gen | | (baby oil | | (w/DAP) | peptone | ferrous | | |
| foam cubes | | | Mar. 2, 2022; (New) Ph spores-BoV8-A-2 3^{rd} | | to | | | | sulfate | | |
| | | | gen Jun. 26, 2022; (new) Ph-BoV8-3 3^{rd} gen | | paraffin) | | | | | | |
| | | | Jun. 26, 2022 | | | | | | | | |
| Black | 8 | P. | Ph (100% ½ prop. Spores) A-3 (2) 2^{nd} gen | 157 | 2:3 BoP | 2.5 | 1.52775 | 3.93 g | 0.9825 g | None | None |
| polyurethane | | pulmonarius | Jun. 26, 2022; (New) Ph-A-3 2^{nd} gen | | (baby oil | | (w/DAP) | peptone | ferrous | | |
| foam cubes | | | Mar. 2, 2022; (New) Ph spores-BoV8-A-2 3^{rd} | | to | | | | sulfate | | |
| | | | gen Jun. 26, 2022; (new) Ph-BoV8-3 3^{rd} gen | | paraffin) | | | | | | |
| | | | Jun. 26, 2022 | | | | | | | | |
| Black | 8 | P. | Ph (100% ½ prop. Spores) A-3 (2) 2^{nd} gen | 157 | 2:3 BoP | 2.5 | 1.52775 | 3.93 g | 0.9825 g | None | None |
| polyurethane | | pulmonarius | Jun. 26, 2022; (New) Ph-A-3 2^{nd} gen | | (baby oil | | (w/DAP) | peptone | ferrous | | |
| foam cubes | | | Mar. 2, 2022; (New) Ph spores-BoV8-A-2 3^{rd} | | to | | | | sulfate | | |
| | | | gen Jun. 26, 2022; (new) Ph-BoV8-3 3^{rd} gen | | paraffin) | | | | | | |
| | | | Jun. 26, 2022 | | | | | | | | |
| Polyurethane | 16 | P. | Ph (100% ½ prop. Spores) A-3 (2) 2^{nd} gen | 157 | 2:3 BoP | 5 | 1.52775 | None | None | None | None |
| foam shreds | | pulmonarius | Jun. 26, 2022; (New) Ph-A-3 2^{nd} gen | | (baby oil | | (w/DAP) | | | | |
| | | | Mar. 2, 2022; (New) Ph spores-BoV8-A-2 3^{rd} | | to | | | | | | |
| | | | gen Jun. 26, 2022; (new) Ph-BoV8-3 3^{rd} gen | | paraffin) | | | | | | |
| | | | Jun. 26, 2022 | | | | | | | | |
| Polyurethane | 16 | P. | Ph (100% ½ prop. Spores) A-3 (2) 2^{nd} gen | 157 | 2:3 BoP | 5 | 1.52775 | None | None | None | None |
| foam shreds | | pulmonarius | Jun. 26, 2022; (New) Ph-A-3 2^{nd} gen Mar. 2, 2022; | | (baby oil | | (w/DAP) | | | | |
| | | | (New) Ph spores-BoV8-A-2 3^{rd} gen | | to | | | | | | |
| | | | Jun. 26, 2022; (new) Ph-BoV8-3 3^{rd} gen | | paraffin) | | | | | | |
| | | | Jun. 26, 2022 | | | | | | | | |
| | | | Ph (100% ½ prop. Spores) A-3 (2) 2^{nd} gen | | | | | | | | |
| Polyurethane | 8 | P. | Ph (100% ½ prop. Spores) A-3 (2) 2^{nd} gen | 157 | 2:3 BoP | 2.5 | 1.52775 | None | None | None | None |
| foam shreds | | pulmonarius | Jun. 26, 2022; (New) Ph-A-3 2^{nd} gen Mar. 2, 2022; | | (baby oil | | (w/DAP) | | | | |
| | | | (New) Ph spores-BoV8-A-2 3^{rd} gen | | to | | | | | | |
| | | | Jun. 26, 2022; (new) Ph-BoV8-3 3^{rd} gen | | paraffin) | | | | | | |
| | | | Jun. 26, 2022 | | | | | | | | |
| Polyurethane | 8 | P. | Ph (100% ½ prop. Spores) A-3 (2) 2^{nd} gen | 157 | 2:3 BoP | 2.5 | 1.52775 | None | None | None | None |
| foam shreds | | pulmonarius | Jun. 26, 2022; (New) Ph-A-3 2^{nd} gen Mar. 2, 2022; | | (baby oil | | (w/DAP) | | | | |
| | | | (New) Ph spores-BoV8-A-2 3^{rd} gen | | to | | | | | | |
| | | | Jun. 26, 2022; (new) Ph-BoV8-3 3^{rd} gen | | paraffin) | | | | | | |
| | | | Jun. 26, 2022 | | | | | | | | |
| Polyurethane | 16 | P. | Ph (100% ½ prop. Spores) A-3 (2) 2^{nd} gen | 157 | None | 0 | 1.52775 | None | None | None | None |
| foam shreds | | pulmonarius | Jun. 26, 2022; (New) Ph-A-3 2^{nd} gen Mar. 2, 2022; | | | | (w/DAP) | | | | |
| | | | (New) Ph spores-BoV8-A-2 3^{rd} gen | | | | | | | | |
| | | | Jun. 26, 2022; (new) Ph-BoV8-3 3^{rd} gen | | | | | | | | |
| | | | Jun. 26, 2022 | | | | | | | | |
| Polyurethane | 16 | P. | Ph (100% ½ prop. Spores) A-3 (2) 2^{nd} gen | 157 | None | 0 | 1.52775 | None | None | None | None |
| foam shreds | | pulmonarius | Jun. 26, 2022; (New) Ph-A-3 2^{nd} gen Mar. 2, 2022; | | | | (w/DAP) | | | | |
| | | | (New) Ph spores-BoV8-A-2 3^{rd} gen | | | | | | | | |
| | | | Jun. 26, 2022; (new) Ph-BoV8-3 3^{rd} gen | | | | | | | | |
| | | | Jun. 26, 2022 | | | | | | | | |
| Polyurethane | 8 | P. | Ph (100% ½ prop. Spores) A-3 (2) 2^{nd} gen | 157 | None | 0 | 1.52775 | None | None | None | None |
| foam shreds | | pulmonarius | Jun. 26, 2022; (New) Ph-A-3 2^{nd} gen | | | | (w/DAP) | | | | |
| | | | Mar. 2, 2022; (New) Ph spores-BoV8-A-2 3^{rd} | | | | | | | | |
| | | | gen Jun. 26, 2022; (new) Ph-BoV8-3 3^{rd} gen | | | | | | | | |
| | | | Jun. 26, 2022 | | | | | | | | |
| Polyurethane | 8 | P. | Ph (100% ½ prop. Spores) A-3 (2) 2^{nd} gen | 157 | None | 0 | 1.52775 | None | None | None | None |
| foam shreds | | pulmonarius | Jun. 26, 2022; (New) Ph-A-3 2^{nd} gen Mar. 2, 2022; | | | | (w/DAP) | | | | |
| | | | (New) Ph spores-BoV8-A-2 3^{rd} gen | | | | | | | | |
| | | | Jun. 26, 2022; (new) Ph-BoV8-3 3^{rd} gen | | | | | | | | |
| | | | Jun. 26, 2022 | | | | | | | | |
| **Black | 3.6 | P. | Ph (100% ½ prop. Spores) A-3 (2) 2^{nd} gen | 72 | None | 0 | 0.6952 | 1.8 g | 0.45 g | None | None |
| polyurethane | | pulmonarius | Jun. 26, 2022; (New) Ph-A-3 2^{nd} gen Mar. 2, 2022; | | | | (w/DAP) | peptone | ferrous | | |
| foam cubes | | | (New) Ph spores-BoV8-A-2 3^{rd} gen | | | | | | sulfate | | |
| | | | Jun. 26, 2022; (new) Ph-BoV8-3 3^{rd} gen | | | | | | | | |
| | | | Jun. 26, 2022 | | | | | | | | |
| **Black | 3.6 | P. | Ph (100% ½ prop. Spores) A-3 (2) 2^{nd} gen | 72 | None | 0 | 0.6952 | 1.8 g | 0.45 g | None | None |
| polyurethane | | pulmonarius | Jun. 26, 2022; (New) Ph-A-3 2^{nd} gen Mar. 2, 2022; | | | | (w/DAP) | peptone | ferrous | | |
| foam cubes | | | (New) Ph spores-BoV8-A-2 3^{rd} gen | | | | | | sulfate | | |
| | | | Jun. 26, 2022; (new) Ph-BoV8-3 3^{rd} gen | | | | | | | | |
| | | | Jun. 26, 2022 | | | | | | | | |
| **Black | 3.6 | P. | Ph (100% ½ prop. Spores) A-3 (2) 2^{nd} gen | 72 | None | 0 | 0.6952 | 1.8 g | 0.45 g | None | None |
| polyurethane | | pulmonarius | Jun. 26, 2022; (new) Ph-BoV8-3 3^{rd} gen Jun. 26, 2022; | | | | (w/DAP) | peptone | ferrous | | |
| foam cubes | | | (New) Ph-A-3 2^{nd} gen Mar. 2, 2022; | | | | | | sulfate | | |
| | | | (New) Ph spores-BoV8-A-2 3^{rd} gen | | | | | | | | |
| | | | Jun. 26, 2022 | | | | | | | | |
| Black | 3.6 | P. | Ph (100% ½ prop. Spores) A-3 (2) 2^{nd} gen | 72 | None | 0 | 0.6952 | 1.8 g | 0.45 g | None | None |
| polyurethane | | pulmonarius | Jun. 26, 2022; (New) Ph-A-3 2^{nd} gen Mar. 2, 2022; | | | | (w/DAP) | peptone | ferrous | | |
| foam cubes | | | (New) Ph spores-BoV8-A-2 3^{rd} gen | | | | | | sulfate | | |
| | | | Jun. 26, 2022; (new) Ph-BoV8-3 3^{rd} gen | | | | | | | | |
| | | | Jun. 26, 2022 | | | | | | | | |
| Black | 16 | P. | Ph (100% ½ prop. Spores) A-3 (2) 2^{nd} gen | 157 | None | 0 | 1.52775 | None | None | None | None |
| polyurethane | | pulmonarius | Jun. 26, 2022; (New) Ph-A-3 2^{nd} gen Mar. 2, 2022; | | | | (w/DAP) | | | | |
| foam cubes | | | (New) Ph spores-BoV8-A-2 3^{rd} gen | | | | | | | | |
| | | | Jun. 26, 2022; (new) Ph-BoV8-3 3^{rd} gen | | | | | | | | |
| | | | Jun. 26, 2022 | | | | | | | | |
| Black | 16 | P. | Ph (100% ½ prop. Spores) A-3 (2) 2^{nd} gen | 157 | None | 0 | 1.52775 | None | None | None | None |
| polyurethane | | pulmonarius | Jun. 26, 2022; (New) Ph-A-3 2^{nd} gen Mar. 2, 2022; | | | | (w/DAP) | | | | |
| foam cubes | | | (New) Ph spores-BoV8-A-2 3^{rd} gen | | | | | | | | |
| | | | Jun. 26, 2022; (new) Ph-BoV8-3 3^{rd} gen | | | | | | | | |
| | | | Jun. 26, 2022 | | | | | | | | |
| Black | 8 | P. | Ph (100% ½ prop. Spores) A-3 (2) 2^{nd} gen | 157 | None | 0 | 1.52775 | None | None | None | None |
| polyurethane | | pulmonarius | Jun. 26, 2022; (New) Ph-A-3 2^{nd} gen Mar. 2, 2022; | | | | (w/DAP) | | | | |
| foam cubes | | | (New) Ph spores-BoV8-A-2 3^{rd} gen | | | | | | | | |
| | | | Jun. 26, 2022; (new) Ph-BoV8-3 3^{rd} gen | | | | | | | | |
| | | | Jun. 26, 2022 | | | | | | | | |
| Black | 8 | P. | Ph (100% ½ prop. Spores) A-3 (2) 2^{nd} gen | 157 | None | 0 | 1.52775 | None | None | None | None |
| polyurethane | | pulmonarius | Jun. 26, 2022; (New) Ph-A-3 2^{nd} gen Mar. 2, 2022; | | | | (w/DAP) | | | | |
| foam cubes | | | (New) Ph spores-BoV8-A-2 3^{rd} gen | | | | | | | | |
| | | | Jun. 26, 2022; (new) Ph-BoV8-3 3^{rd} gen | | | | | | | | |
| | | | Jun. 26, 2022 | | | | | | | | |
| Black | 16 | P. | Ph (100% ½ prop. Spores) A-3 (2) 2^{nd} gen | 157 | 2:3 BoP | 5 | 1.52775 | None | None | None | None |
| polyurethane | | pulmonarius | Jun. 26, 2022; (New) Ph-A-3 2^{nd} gen Mar. 2, 2022; | | (baby oil | | (w/DAP) | | | | |
| foam cubes | | | (New) Ph spores-BoV8-A-2 3^{rd} gen | | to | | | | | | |
| | | | Jun. 26, 2022; (new) Ph-BoV8-3 3^{rd} gen | | paraffin) | | | | | | |
| | | | Jun. 26, 2022 | | | | | | | | |
| Black | 16 | P. | Ph (100% ½ prop. Spores) A-3 (2) 2^{nd} gen | 157 | 2:3 BoP | 5 | 1.52775 | None | None | None | None |
| polyurethane | | pulmonarius | Jun. 26, 2022; (New) Ph-A-3 2^{nd} gen Mar. 2, 2022; | | (baby oil | | (w/DAP) | | | | |
| foam cubes | | | (New) Ph spores-BoV8-A-2 3^{rd} gen | | to | | | | | | |
| | | | Jun. 26, 2022; (new) Ph-BoV8-3 3^{rd} gen | | paraffin) | | | | | | |
| | | | Jun. 26, 2022 | | | | | | | | |
| Black | 8 | P. | Ph (100% ½ prop. Spores) A-3 (2) 2^{nd} gen | 157 | 2:3 BoP | 2.5 | 1.52775 | None | None | None | None |
| polyurethane | | pulmonarius | Jun. 26, 2022; (New) Ph-A-3 2^{nd} gen Mar. 2, 2022; | | (baby oil | | (w/DAP) | | | | |
| foam cubes | | | (New) Ph spores-BoV8-A-2 3^{rd} gen | | to | | | | | | |
| | | | Jun. 26, 2022; (new) Ph-BoV8-3 3^{rd} gen | | paraffin) | | | | | | |
| | | | Jun. 26, 2022 | | | | | | | | |
| Black | 8 | P. | Ph (100% ½ prop. Spores) A-3 (2) 2^{nd} gen | 157 | 2:3 BoP | 2.5 | 1.52775 | None | None | None | None |
| polyurethane | | pulmonarius | Jun. 26, 2022; (New) Ph-A-3 2^{nd} gen Mar. 2, 2022; | | (baby oil | | (w/DAP) | | | | |
| foam cubes | | | (New) Ph spores-BoV8-A-2 3^{rd} gen | | to | | | | | | |
| | | | Jun. 26, 2022; (new) Ph-BoV8-3 3^{rd} gen | | paraffin) | | | | | | |
| | | | Jun. 26, 2022 | | | | | | | | |
| Black | 3.6 | P. | Ph (100% ½ prop. Spores) A-3 (2) 2^{nd} gen | 72 | 2:3 BoP | 1.125 | 0.6952 | 0.3308 g | 0.45 g | None | None |
| polyurethane | | pulmonarius | Jun. 26, 2022; (New) Ph-A-3 2^{nd} gen Mar. 2, 2022; | | (baby oil | | (w/DAP) | urea | ferrous | | |
| foam cubes | | | (New) Ph spores-BoV8-A-2 3^{rd} gen | | to | | | | sulfate | | |
| | | | Jun. 26, 2022; (new) Ph-BoV8-3 3^{rd} gen | | paraffin) | | | | | | |
| | | | Jun. 26, 2022 | | | | | | | | |
| Black | 3.6 | P. | Ph (100% ½ prop. Spores) A-3 (2) 2^{nd} gen | 72 | 2:3 BoP | 1.125 | 0.6952 | 0.3308 g | 0.45 g | None | None |
| polyurethane | | pulmonarius | Jun. 26, 2022; (New) Ph-A-3 2^{nd} gen Mar. 2, 2022; | | (baby oil | | (w/DAP) | urea | ferrous | | |
| foam cubes | | | (New) Ph spores-BoV8-A-2 3^{rd} gen | | to | | | | sulfate | | |
| | | | Jun. 26, 2022; (new) Ph-BoV8-3 3^{rd} gen | | paraffin) | | | | | | |
| | | | Jun. 26, 2022 | | | | | | | | |
| Black | 3.6 | P. | Ph (100% ½ prop. Spores) A-3 (2) 2^{nd} gen | 72 | 2:3 BoP | 1.125 | 0.6952 | 0.3308 g | 0.45 g | None | None |
| polyurethane | | pulmonarius | Jun. 26, 2022; (New) Ph-A-3 2^{nd} gen Mar. 2, 2022; | | (baby oil | | (w/DAP) | urea | ferrous | | |
| foam cubes | | | (New) Ph spores-BoV8-A-2 3^{rd} gen | | to | | | | sulfate | | |
| | | | Jun. 26, 2022; (new) Ph-BoV8-3 3^{rd} gen | | paraffin) | | | | | | |
| | | | Jun. 26, 2022 | | | | | | | | |
| Black | 3.6 | P. | Ph (100% ½ prop. Spores) A-3 (2) 2^{nd} gen | 72 | 2:3 BoP | 1.125 | 0.6952 | 0.3308 g | 0.45 g | None | None |
| polyurethane | | pulmonarius | Jun. 26, 2022; (New) Ph-A-3 2^{nd} gen Mar. 2, 2022; | | (baby oil | | (w/DAP) | urea | ferrous | | |
| foam cubes | | | (New) Ph spores-BoV8-A-2 3^{rd} gen | | to | | | | sulfate | | |
| | | | Jun. 26, 2022; (new) Ph-BoV8-3 3^{rd} gen | | paraffin) | | | | | | |
| | | | Jun. 26, 2022 | | | | | | | | |
| Black | 3.6 | P. | Ph (100% ½ prop. Spores) A-3 (2) 2^{nd} gen | 72 | None | 0 | 0.6952 | 1.8 g | 0.60 g | None | None |
| polyurethane | | pulmonarius | Jun. 26, 2022; (New) Ph-A-3 2^{nd} gen Mar. 2, 2022; | | | | (w/DAP) | peptone | ferrous | | |
| foam cubes | | | (New) Ph spores-BoV8-A-2 3^{rd} gen | | | | | | sulfate | | |
| | | | Jun. 26, 2022; (new) Ph-BoV8-3 3^{rd} gen | | | | | | | | |
| | | | Jun. 26, 2022 | | | | | | | | |
| Black | 3.6 | P. | Ph (100% ½ prop. Spores) A-3 (2) 2^{nd} gen | 72 | None | 0 | 0.6952 | 1.8 g | 0.60 g | None | None |
| polyurethane | | pulmonarius | Jun. 26, 2022; (New) Ph-A-3 2^{nd} gen Mar. 2, 2022; | | | | (w/DAP) | peptone | ferrous | | |
| foam cubes | | | (New) Ph spores-BoV8-A-2 3^{rd} gen | | | | | | sulfate | | |
| | | | Jun. 26, 2022; (new) Ph-BoV8-3 3^{rd} gen | | | | | | | | |
| | | | Jun. 26, 2022 | | | | | | | | |
| Black | 3.6 | P. | Ph (100% ½ prop. Spores) A-3 (2) 2^{nd} gen | 72 | None | 0 | 0.6952 | 1.35 g | 0.45 g | None | None |
| polyurethane | | pulmonarius | Jun. 26, 2022; (New) Ph-A-3 2^{nd} gen Mar. 2, 2022; | | | | (w/DAP) | peptone | ferrous | | |
| foam cubes | | | (New) Ph spores-BoV8-A-2 3^{rd} gen | | | | | | sulfate | | |
| | | | Jun. 26, 2022; (new) Ph-BoV8-3 3^{rd} gen | | | | | | | | |
| | | | Jun. 26, 2022 | | | | | | | | |
| Black | 3.6 | P. | Ph (100% ½ prop. Spores) A-3 (2) 2^{nd} gen | 72 | None | 0 | 0.6952 | 1.35 g | 0.45 g | None | None |
| polyurethane | | pulmonarius | Jun. 26, 2022; (New) Ph-A-3 2^{nd} gen Mar. 2, 2022; | | | | (w/DAP) | peptone | ferrous | | |
| foam cubes | | | (New) Ph spores-BoV8-A-2 3^{rd} gen | | | | | | sulfate | | |
| | | | Jun. 26, 2022; (new) Ph-BoV8-3 3^{rd} gen | | | | | | | | |
| | | | Jun. 26, 2022 | | | | | | | | |
| Black | 3.6 | P. | Ph (100% ½ prop. Spores) A-3 (2) 2^{nd} gen | 72 | None | 0 | 0.6952 | 0.3308 g | 0.45 g | None | None |
| polyurethane | | pulmonarius | Jun. 26, 2022; (New) Ph-A-3 2^{nd} gen Mar. 2, 2022; | | | | (w/DAP) | urea | ferrous | | |
| foam cubes | | | (New) Ph spores-BoV8-A-2 3^{rd} gen | | | | | | sulfate | | |
| | | | Jun. 26, 2022; (new) Ph-BoV8-3 3^{rd} gen | | | | | | | | |
| | | | Jun. 26, 2022 | | | | | | | | |
| Black | 3.6 | P. | Ph (100% ½ prop. Spores) A-3 (2) 2^{nd} gen | 72 | None | 0 | 0.6952 | 0.3308 g | 0.45 g | None | None |
| polyurethane | | pulmonarius | Jun. 26, 2022; (New) Ph-A-3 2^{nd} gen | | | | (w/DAP) | urea | ferrous | | |
| foam cubes | | | Mar. 2, 2022; (New) Ph spores-BoV8-A-2 3^{rd} | | | | | | sulfate | | |
| | | | gen Jun. 26, 2022; (new) Ph-BoV8-3 3^{rd} gen | | | | | | | | |
| | | | Jun. 26, 2022 | | | | | | | | |
| Black | 3.6 | P. | Ph (100% ½ prop. Spores) A-3 (2) 2^{nd} gen | 72 | None | 0 | 0.6952 | 0.3308 g | 0.45 g | None | None |
| polyurethane | | pulmonarius | Jun. 26, 2022; (New) Ph-A-3 2^{nd} gen | | | | (w/DAP) | urea | ferrous | | |
| foam cubes | | | Mar. 2, 2022; (New) Ph spores-BoV8-A-2 3^{rd} | | | | | | sulfate | | |
| | | | gen Jun. 26, 2022; (new) Ph-BoV8-3 3^{rd} gen | | | | | | | | |
| | | | Jun. 26, 2022 | | | | | | | | |
| Black | 3.6 | P. | Ph (100% ½ prop. Spores) A-3 (2) 2^{nd} gen | 72 | None | 0 | 0.6952 | 0.3308 g | 0.45 g | None | None |
| polyurethane | | pulmonarius | Jun. 26, 2022; (New) Ph-A-3 2^{nd} gen | | | | (w/DAP) | urea | ferrous | | |
| foam cubes | | | Mar. 2, 2022; (New) Ph spores-BoV8-A-2 3^{rd} | | | | | | sulfate | | |
| | | | gen Jun. 26, 2022; (new) Ph-BoV8-3 3^{rd} gen | | | | | | | | |
| | | | Jun. 26, 2022 | | | | | | | | |
| Polyurethane | 12.79 | P. | Ph (100% ½ pr) Spores A-3 (2) 2^{nd} gen | 72 | None | 0 | 0.6952 | 0.3308 g | 0.45 g | None | None |
| Foam Shreds | | pulmonarius | Jun. 26, 2022; (New) Ph-A-3 2^{nd} gen Mar. 2, 2022; | | | | (w/DAP) | urea | ferrous | | |
| | | | (New) Ph-BoV8-3 3^{rd} gen Jun. 26, 2022; Ph | | | | | | sulfate | | |
| | | | spores BoV-A-2 3^{rd} gen Jun. 26, 2022 | | | | | | | | |
| Polyurethane | 12.79 | P. | Ph (100%, ½ pr) Spores A-3 (2) 2^{nd} gen | 72 | None | 0 | 0.6952 | 0.3308 g | 0.45 g | None | None |
| Foam Shreds | | Pulmonarius | Jun. 26, 2022; (New) Ph-A-3 2^{nd} gen Mar. 2, 2022; | | | | (w/DAP) | urea | ferrous | | |
| | | | (New) Ph-BoV8-3 3^{rd} gen Jun. 26, 2022; Ph | | | | | | sulfate | | |
| | | | spores BoV-A-2 3^{rd} gen Jun. 26, 2022 | | | | | | | | |
| Polyurethane | 3.6 | P. | Ph (100%, ½ pr) Spores A-3 (2) 2^{nd} gen | 72 | None | 0 | 0.6952 | 0.3308 g | 0.45 g | None | None |
| Foam Shreds | | Pulmonarius | Jun. 26, 2022; (New) Ph-A-3 2^{nd} gen Mar. 2, 2022; | | | | (w/DAP) | urea | ferrous | | |
| | | | (New) Ph-BoV8-3 3^{rd} gen Jun. 26, 2022; Ph | | | | | | sulfate | | |
| | | | spores BoV-A-2 3^{rd} gen Jun. 26, 2022 | | | | | | | | |
| Polyurethane | 3.6 | P. | Ph (100%, ½ pr) Spores A-3 (2) 2^{nd} gen | 72 | None | 0 | 0.6952 | 0.3308 g | 0.45 g | None | None |
| Foam Shreds | | Pulmonarius | Jun. 26, 2022; (New) Ph-A-3 2^{nd} gen Mar. 2, 2022; | | | | (w/DAP) | urea | ferrous | | |
| | | | (New) Ph-BoV8-3 3^{rd} gen Jun. 26, 2022; Ph | | | | | | sulfate | | |
| | | | spores BoV-A-2 3^{rd} gen Jun. 26, 2022 | | | | | | | | |
| Black | 16 | P. | Ph (100%, ½ pr) Spores A-3 (2) 2^{nd} gen | 157 | 2:3 BoP | 5 | 1.52775 | 0.6878 g | 0.9825 g | None | None |
| Polyurethane | | Pulmonarius | Jun. 26, 2022; (New) Ph-A-3 2^{nd} gen Mar. 2, 2022; | | (Baby oil | | (w/DAP) | urea | ferrous | | |
| Foam Cubes | | | (New) Ph-BoV8-3 3^{rd} gen Jun. 26, 2022; Ph | | to | | | | sulfate | | |
| | | | spores BoV-A-2 3^{rd} gen Jun. 26, 2022 | | paraffin) | | | | | | |
| Black | 16 | P. | Ph (100%, ½ pr) Spores A-3 (2) 2^{nd} gen | 157 | 2:3 BoP | 5 | 1.52775 | 0.6878 g | 0.9825 g | None | None |
| Polyurethane | | Pulmonarius | Jun. 26, 2022; (New) Ph-A-3 2^{nd} gen Mar. 2, 2022; | | (Baby oil | | (w/DAP) | urea | ferrous | | |
| Foam Cubes | | | (New) Ph-BoV8-3 3^{rd} gen Jun. 26, 2022; Ph | | to | | | | sulfate | | |
| | | | spores BoV-A-2 3^{rd} gen Jun. 26, 2022 | | paraffin) | | | | | | |
| Black | 8 | P. | Ph (100%, ½ pr) Spores A-3 (2) 2^{nd} gen | 157 | 2:3 BoP | 2.5 | 1.52775 | 0.6878 g | 0.9825 g | None | None |
| Polyurethane | | Pulmonarius | Jun. 26, 2022; (New) Ph-A-3 2^{nd} gen Mar. 2, 2022; | | (Baby oil | | (w/DAP) | urea | ferrous | | |
| Foam Cubes | | | (New) Ph-BoV8-3 3^{rd} gen Jun. 26, 2022; Ph | | to | | | | sulfate | | |
| | | | spores BoV-A-2 3^{rd} gen Jun. 26, 2022 | | paraffin) | | | | | | |
| Black | 8 | P. | Ph (100%, ½ pr) Spores A-3 (2) 2^{nd} gen | 157 | 2:3 BoP | 2.5 | 1.52775 | 0.6878 g | 0.9825 g | None | None |
| Polyurethane | | Pulmonarius | Jun. 26, 2022; (New) Ph-A-3 2^{nd} gen Mar. 2, 2022; | | (Baby oil | | (w/DAP) | urea | ferrous | | |
| Foam Cubes | | | (New) Ph-BoV8-3 3^{rd} gen Jun. 26, 2022; Ph | | to | | | | sulfate | | |
| | | | spores BoV-A-2 3^{rd} gen Jun. 26, 2022 | | paraffin) | | | | | | |
| Polyurethane | 12.79 | P. | Ph (100% ½ pr) Spores A-3 (2) 2^{nd} gen | 72 | 2:3 BoP | 1.125 | 0.6952 | 0.3308 g | 0.45 g | None | None |
| Foam Shreds | | Pulmonarius | Jun. 26, 2022; (New) Ph-A-3 2^{nd} gen Mar. 2, 2022; | | (Baby oil | | (w/DAP) | urea | ferrous | | |
| | | | (New) Ph-BoV8-3 3^{rd} gen Jun. 26, 2022; Ph | | to | | | | sulfate | | |
| | | | spores BoV-A-2 3^{rd} gen Jun. 26, 2022 | | paraffin) | | | | | | |
| Polyurethane | 12.79 | P. | Ph (100% ½ pr) Spores A-3 (2) 2^{nd} gen | 72 | 2:3 BoP | 1.125 | 0.6952 | 0.3308 g | 0.45 g | None | None |
| Foam Shreds | | Pulmonarius | Jun. 26, 2022; (New) Ph-A-3 2^{nd} gen Mar. 2, 2022; | | (Baby oil | | (w/DAP) | urea | ferrous | | |
| | | | (New) Ph-BoV8-3 3^{rd} gen Jun. 26, 2022; Ph | | to | | | | sulfate | | |
| | | | spores BoV-A-2 3^{rd} gen Jun. 26, 2022 | | paraffin) | | | | | | |
| Polyurethane | 3.6 | P. | Ph (100% ½ pr) Spores A-3 (2) 2^{nd} gen | 72 | 2:3 BoP | 1.125 | 0.6952 | 0.3308 g | 0.45 g | None | None |
| Foam Shreds | | Pulmonarius | Jun. 26, 2022; (New) Ph-A-3 2^{nd} gen Mar. 2, 2022; | | (Baby oil | | (w/DAP) | urea | ferrous | | |
| | | | (New) Ph-BoV8-3 3^{rd} gen Jun. 26, 2022; Ph | | to | | | | sulfate | | |
| | | | spores BoV-A-2 3^{rd} gen Jun. 26, 2022 | | paraffin) | | | | | | |
| Polyurethane | 3.6 | P. | Ph (100% ½ pr) Spores A-3 (2) 2^{nd} gen | 72 | 2:3 BoP | 1.125 | 0.6952 | 0.3308 g | 0.45 g | None | None |
| Foam Shreds | | Pulmonarius | Jun. 26, 2022; (New) Ph-A-3 2^{nd} gen Mar. 2, 2022; | | (Baby oil | | (w/DAP) | urea | ferrous | | |
| | | | (New) Ph-BoV8-3 3^{rd} gen Jun. 26, 2022; Ph | | to | | | | sulfate | | |
| | | | spores BoV-A-2 3^{rd} gen Jun. 26, 2022 | | paraffin) | | | | | | |
| Polyurethane | 12.79 | P. | Ph (100% ½ pr) Spores A-3 (2) 2^{nd} gen | 72 | 2:3 BoP | 1.125 | 0.6952 | None | None | None | None |
| Foam Shreds | | Pulmonarius | Jun. 26, 2022; (New) Ph-A-3 2^{nd} gen Mar. 2, 2022; | | (Baby oil | | (w/DAP) | | | | |
| | | | (New) Ph-BoV8-3 3^{rd} gen Jun. 26, 2022; Ph | | to | | | | | | |
| | | | spores BoV-A-2 3^{rd} gen Jun. 26, 2022 | | paraffin) | | | | | | |
| Polyurethane | 12.79 | P. | Ph (100% ½ pr) Spores A-3 (2) 2^{nd} gen | 72 | 2:3 BoP | 1.125 | 0.6952 | None | None | None | None |
| Foam Shreds | | Pulmonarius | Jun. 26, 2022; (New) Ph-A-3 2^{nd} gen Mar. 2, 2022; | | (Baby oil | | (w/DAP) | | | | |
| | | | (New) Ph-BoV8-3 3^{rd} gen Jun. 26, 2022; Ph | | to | | | | | | |
| | | | spores BoV-A-2 3^{rd} gen Jun. 26, 2022 | | paraffin) | | | | | | |
| Polyurethane | 3.6 | P. | Ph (100% ½ pr) Spores A-3 (2) 2^{nd} gen | 72 | 2:3 BoP | 1.125 | 0.6952 | None | None | None | None |
| Foam Shreds | | Pulmonarius | Jun. 26, 2022; (New) Ph-A-3 2^{nd} gen Mar. 2, 2022; | | (Baby oil | | (w/DAP) | | | | |
| | | | (New) Ph-BoV8-3 3^{rd} gen Jun. 26, 2022; Ph | | to | | | | | | |
| | | | spores BoV-A-2 3^{rd} gen Jun. 26, 2022 | | paraffin) | | | | | | |
| Polyurethane | 3.6 | P. | Ph (100% ½ pr) Spores A-3 (2) 2^{nd} gen | 72 | 2:3 BoP | 1.125 | 0.6952 | None | None | None | None |
| Foam Shreds | | Pulmonarius | Jun. 26, 2022; (New) Ph-A-3 2^{nd} gen Mar. 2, 2022; | | (Baby oil | | (w/DAP) | | | | |
| | | | (New) Ph-BoV8-3 3^{rd} gen Jun. 26, 2022; Ph | | to | | | | | | |
| | | | spores BoV-A-2 3^{rd} gen Jun. 26, 2022 | | paraffin) | | | | | | |
| Black | 3.6 | L. edodes, | Sh-BoV8 Apr. 14, 2021; C-A-4 Agar Apr. 7, 2021 (2); | 72 | 2:3 BoP | 1.125 | 0.6952 | 0.3308 g | 0.45 g | None | None |
| Polyurethane | | P. | S(4) Mar. 12, 2021; P-20M-2 drip (1) Mar. 19, 2021 | | (Baby oil | | (w/DAP) | urea | ferrous | | |
| Foam Cubes | | columbinus, | | | to | | | | sulfate | | |
| | | P. | | | paraffin) | | | | | | |
| | | ostreatus | | | | | | | | | |
| | | silver | | | | | | | | | |
| | | & | | | | | | | | | |
| | | pearl | | | | | | | | | |
| Black | 3.6 | L. edodes, | Sh-BoV8 Apr. 14, 2021; C-A-4 Agar Apr. 7, 2021 (2); | 72 | 2:3 BoP | 1.125 | 0.6952 | 0.3308 g | 0.45 g | None | None |
| Polyurethane | | P. | S(4) Mar. 12, 2021; P-20M-2 drip (1) Mar. 19, 2021 | | (Baby oil | | (w/DAP) | urea | ferrous | | |
| Foam Cubes | | columbinus, | | | to | | | | sulfate | | |
| | | P. | | | paraffin) | | | | | | |
| | | ostreatus | | | | | | | | | |
| | | silver | | | | | | | | | |
| | | & | | | | | | | | | |
| | | pearl | | | | | | | | | |
| Black | 3.6 | L. edodes, | Sh-BoV8 Apr. 14, 2021; C-A-4 Agar Apr. 7, 2021 (2); | 72 | 2:3 BoP | 1.125 | 0.6952 | 1.8 g | 0.60 g | None | None |
| Polyurethane | | P. | S(4) Mar. 12, 2021; P-20M-2 drip (1) Mar. 19, 2021 | | (Baby oil | | (w/DAP) | peptone | ferrous | | |
| Foam Cubes | | columbinus, | | | to | | | | sulfate | | |
| | | P. | | | paraffin) | | | | | | |
| | | ostreatus | | | | | | | | | |
| | | silver | | | | | | | | | |
| | | & | | | | | | | | | |
| | | pearl | | | | | | | | | |
| Black | 3.6 | L. edodes, | Sh-BoV8 Apr. 14, 2021; C-A-4 Agar Apr. 7, 2021 (2); | 72 | 2:3 BoP | 1.125 | 0.6952 | 1.8 g | 0.60 g | None | None |
| Polyurethane | | P. | S(4) Mar. 12, 2021; P-20M-2 drip (1) Mar. 19, 2021 | | (Baby oil | | (w/DAP) | peptone | ferrous | | |
| Foam Cubes | | columbinus, | | | to | | | | sulfate | | |
| | | P. | | | paraffin) | | | | | | |
| | | ostreatus | | | | | | | | | |
| | | silver | | | | | | | | | |
| | | & | | | | | | | | | |
| | | pearl | | | | | | | | | |
| Black | 16 | P. | Ph (100% ½ pr) Spores A-3 (2) 2^{nd} gen | 105 | None | 0 | 1.0218 | 0.46 g | 0.6571 g | None | None |
| Polyurethane | | Pulmonarius | Jun. 26, 2022; (New) Ph-A-3 2^{nd} gen Mar. 2, 2022; | | | | (w/DAP) | urea | ferrous | | |
| Foam Cubes | | | (New) Ph-BoV8-3 3^{rd} gen Jun. 26, 2022; Ph | | | | | | sulfate | | |
| | | | spores BoV-A-2 3^{rd} gen Jun. 26, 2022 | | | | | | | | |
| Black | 16 | P. | Ph (100% ½ pr) Spores A-3 (2) 2^{nd} gen | 105 | None | 0 | 1.0218 | 0.46 g | 0.6571 g | None | None |
| Polyurethane | | Pulmonarius | Jun. 26, 2022; (New) Ph-A-3 2^{nd} gen Mar. 2, 2022; | | | | (w/DAP) | urea | ferrous | | |
| Foam Cubes | | | (New) Ph-BoV8-3 3^{rd} gen Jun. 26, 2022; Ph | | | | | | sulfate | | |
| | | | spores BoV-A-2 3^{rd} gen Jun. 26, 2022 | | | | | | | | |
| Black | 8 | P. | Ph (100% ½ pr) Spores A-3 (2) 2^{nd} gen | 91 | None | 0 | 0.8855 | 0.3986 g | 0.5695 g | None | None |
| Polyurethane | | Pulmonarius | Jun. 26, 2022; (New) Ph-A-3 2^{nd} gen Mar. 2, 2022; | | | | (w/DAP) | urea | ferrous | | |
| Foam Cubes | | | (New) Ph-BoV8-3 3^{rd} gen Jun. 26, 2022; Ph | | | | | | sulfate | | |
| | | | spores BoV-A-2 3^{rd} gen Jun. 26, 2022 | | | | | | | | |
| Black | 8 | P. | Ph (100% ½ pr) Spores A-3 (2) 2^{nd} gen | 91 | None | 0 | 0.8855 | 0.3986 g | 0.5695 g | None | None |
| Polyurethane | | Pulmonarius | Jun. 26, 2022; (New) Ph-A-3 2^{nd} gen Mar. 2, 2022; | | | | (w/DAP) | urea | ferrous | | |
| Foam Cubes | | | (New) Ph-BoV8-3 3^{rd} gen Jun. 26, 2022; Ph | | | | | | sulfate | | |
| | | | spores BoV-A-2 3^{rd} gen Jun. 26, 2022 | | | | | | | | |
| Black | 3.6 | L. edodes, | Sh-BoV8 Apr. 14, 2021; C-A-4 Agar Apr. 7, 2021 (2); | 72 | None | 0 | 0.6952 | 0.3308 g | 0.45 g | None | None |
| Polyurethane | | P. | S(4) Mar. 12, 2021; P-20M-2 drip (1) Mar. 19, 2021 | | | | (w/DAP) | urea | ferrous | | |
| Foam Cubes | | columbinus, | | | | | | | sulfate | | |
| | | P. | | | | | | | | | |
| | | ostreatus | | | | | | | | | |
| | | silver | | | | | | | | | |
| | | & | | | | | | | | | |
| | | pearl | | | | | | | | | |
| Black | 3.6 | L. edodes, | Sh-BoV8 Apr. 14, 2021; C-A-4 Agar Apr. 7, 2021 (2); | 72 | None | 0 | 0.6952 | 0.3308 g | 0.45 g | None | None |
| Polyurethane | | P. | S(4) Mar. 12, 2021; P-20M-2 drip (1) Mar. 19, 2021 | | | | (w/DAP) | urea | ferrous | | |
| Foam Cubes | | columbinus, | | | | | | | sulfate | | |
| | | P. | | | | | | | | | |
| | | ostreatus | | | | | | | | | |
| | | silver | | | | | | | | | |
| | | & | | | | | | | | | |
| | | pearl | | | | | | | | | |
| Black | 3.6 | L. edodes, | Sh-BoV8 Apr. 14, 2021; C-A-4 Agar Apr. 7, 2021 (2); | 72 | None | 0 | 0.6952 | None | None | None | 11.25 g |
| Polyurethane | | P. | S(4) Mar. 12, 2021; P-20M-2 drip (1) Mar. 19, 2021 | | | | (w/DAP) | | | | corn |
| Foam Cubes | | columbinus, | | | | | | | | | starch |
| | | P. | | | | | | | | | |
| | | ostreatus | | | | | | | | | |
| | | silver | | | | | | | | | |
| | | & | | | | | | | | | |
| | | pearl | | | | | | | | | |
| Black | 16 | P. | Water PolyU Spores A-4 Dec. 2, 2022; Water | 105 | 2:3 BoP | 5 | 1.0218 | 0.46 g | 0.6571 g | None | None |
| Polyurethane | | Pulmonarius | PolyU Spores A-B10A-A2 Dec. 2, 2022 | | (Baby oil | | (w/DAP) | urea | ferrous | | |
| Foam Cubes | | | | | to | | | | sulfate | | |
| | | | | | paraffin) | | | | | | |
| Polyurethane | 16 | P. | C-A-4 Agar Apr. 7, 2021 (2); C-BoV16-3 | 105 | 2:3 BoP | 5 | 1.0218 | 0.46 g | 0.6571 g | None | None |
| Foam Shreds | | Columbinus | Mar. 19, 2021 (3); C-BoV16-BoV24-2 Mar. 24, 2021 | | (Baby oil | | (w/DAP) | urea | ferrous | | |
| | | | (1); C-M8-2 | | to | | | | sulfate | | |
| | | | drip Mar. 19, 2021 | | paraffin) | | | | | | |
| Polyurethane | 16 | P. | C-A-4 Agar Apr. 7, 2021 (2); C-BoV16-3 | 105 | 2:3 BoP | 5 | 1.0218 | 0.46 g | 0.6571 g | None | None |
| Foam Shreds | | Columbinus | Mar. 19, 2021 (3); C-BoV16-BoV24-2 Mar. 24, 2021 | | (Baby oil | | (w/DAP) | urea | ferrous | | |
| | | | (1); C-M8-2 | | to | | | | sulfate | | |
| | | | drip Mar. 19, 2021 | | paraffin) | | | | | | |
| Polyurethane | 8 | P. | C-A-4 Agar Apr. 7, 2021 (2); C-BoV16-3 | 91 | 2:3 BoP | 2.5 | 0.8855 | 0.3986 g | 0.5695 g | None | None |
| Foam Shreds | | Columbinus | Mar. 19, 2021 (3); C-BoV16-BoV24-2 Mar. 24, 2021 | | (Baby oil | | (w/DAP) | urea | ferrous | | |
| | | | (1); C-M8-2 | | to | | | | sulfate | | |
| | | | drip Mar. 19, 2021 | | paraffin) | | | | | | |
| Polyurethane | 8 | P. | C-A-4 Agar Apr. 7, 2021 (2); C-BoV16-3 | 91 | 2:3 BoP | 2.5 | 0.8855 | 0.3986 g | 0.5695 g | None | None |
| Foam Shreds | | Columbinus | Mar. 19, 2021 (3); C-BoV16-BoV24-2 Mar. 24, 2021 | | (Baby oil | | (w/DAP) | urea | ferrous | | |
| | | | (1); C-M8-2 | | to | | | | sulfate | | |
| | | | drip Mar. 19, 2021 | | paraffin) | | | | | | |
| Polyurethane | 16 | P. | P-20M-2 Mar. 19, 2021 (2); P-20M02 Mar. 19, 2021 | 105 | 2:3 BoP | 5 | 1.0218 | 0.46 g | 0.6571 g | None | None |
| Foam Shreds | | Ostreatus | (3); P-20M-2 Mar. 19, 2021 (4); P-20M-2 drip 3- | | (Baby oil | | (w/DAP) | urea | ferrous | | |
| | | pearl | 19 | | to | | | | sulfate | | |
| | | | 21 (1) | | paraffin) | | | | | | |
| Polyurethane | 16 | P. | P-20M-2 Mar. 19, 2021 (2); P-20M02 Mar. 19, 2021 | 105 | 2:3 BoP | 5 | 1.0218 | 0.46 g | 0.6571 g | None | None |
| Foam Shreds | | Ostreatus | (3); P-20M-2 Mar. 19, 2021 (4); P-20M-2 drip 3- | | (Baby oil | | (w/DAP) | urea | ferrous | | |
| | | pearl | 19 | | to | | | | sulfate | | |
| | | | 21 (1) | | paraffin) | | | | | | |
| Polyurethane | 8 | P. | P-20M-2 Mar. 19, 2021 (2); P-20M02 Mar. 19, 2021 | 91 | 2:3 BoP | 2.5 | 0.8855 | 0.3986 g | 0.5695 g | None | None |
| Foam Shreds | | Ostreatus | (3); P-20M-2 Mar. 19, 2021 (4); P-20M-2 drip 3- | | (Baby oil | | (w/DAP) | urea | ferrous | | |
| | | pearl | 19 | | to | | | | sulfate | | |
| | | | 21 (1) | | paraffin) | | | | | | |
| Polyurethane | 8 | P. | P-20M-2 Mar. 19, 2021 (2); P-20M02 Mar. 19, 2021 | 91 | 2:3 BoP | 2.5 | 0.8855 | 0.3986 g | 0.5695 g | None | None |
| Foam Shreds | | Ostreatus | (3); P-20M-2 Mar. 19, 2021 (4); P-20M-2 drip 3- | | (Baby oil | | (w/DAP) | urea | ferrous | | |
| | | pearl | 19 | | to | | | | sulfate | | |
| | | | 21 (1) | | paraffin) | | | | | | |
| Polyurethane | 16 | P. | Water PolyU Spores A-4 Dec. 2, 2022; Water | 105 | 2:3 BoP | 5 | 1.0218 | 0.46 g | 0.6571 g | None | None |
| Foam Shreds | | Pulmonarius | PolyU Spores A-B10A-A2 Dec. 2, 2022; Water | | (Baby oil | | (w/DAP) | urea | ferrous | | |
| | | | PolyU Spores A-5 Dec. 16, 2022; Water PolyU | | to | | | | sulfate | | |
| | | | Spores A-B10A-A-3 Dec. 16, 2022 | | paraffin) | | | | | | |
| Polyurethane | 16 | P. | Water PolyU Spores A-4 Dec. 2, 2022; Water | 105 | 2:3 BoP | 5 | 1.0218 | 0.46g | 0.6571 | None | None |
| Foam Shreds | | Pulmonarius | PolyU Spores A-B10A-A2 Dec. 2, 2022; Water | | (Baby oil | | (w/DAP) | urea | g | | |
| | | | PolyU Spores A-5 Dec. 16, 2022; Water PolyU | | to | | | | ferrous | | |
| | | | Spores A-B10A-A-3 Dec. 16, 2022 | | paraffin) | | | | sulfate | | |
| Polyurethane | 8 | P. | Water PolyU Spores A-4 Dec. 2, 2022; Water | 91 | 2:3 BoP | 2.5 | 0.8855 | 0.3986 g | 0.5695 g | None | None |
| Foam Shreds | | Pulmonarius | PolyU Spores A-B10A-A2 Dec. 2, 2022; Water | | (Baby oil | | (w/DAP) | urea | ferrous | | |
| | | | PolyU Spores A-5 Dec. 16, 2022; Water PolyU | | to | | | | sulfate | | |
| | | | Spores A-B10A-A-3 Dec. 16, 2022 | | paraffin) | | | | | | |
| Polyurethane | 8 | P. | Water PolyU Spores A-4 Dec. 2, 2022; Water | 91 | 2:3 BoP | 2.5 | 0.8855 | 0.3986 g | 0.5695 g | None | None |
| Foam Shreds | | Pulmonarius | PolyU Spores A-B10A-A2 Dec. 2, 2022; Water | | (Baby oil | | (w/DAP) | urea | ferrous | | |
| | | | PolyU Spores A-5 Dec. 16, 2022; Water PolyU | | to | | | | sulfate | | |
| | | | Spores A-B10A-A-3 Dec. 16, 2022 | | paraffin) | | | | | | |
| Black | 16 | P. | Ph spores-BoV8-A-2 | 105 | 2:3 BoP | 22 | 1.0218 | 0.46 g | 0.6571 g | None | In |
| Polyurethane | | Pulmonarius | | | (Baby oil | | (w/DAP) | urea | ferrous | | bag |
| Foam Cubes | | | | | to | | | | sulfate | | |
| | | | | | paraffin) | | | | | | |
| Black | 16 | P. | P-20-M-2 (1) drip Mar. 19, 2021 | 105 | 2:3 BoP | 22 | 1.0218 | 0.46 g | 0.6571 g | None | In |
| Polyurethane | | Ostreatus | | | (Baby oil | | (w/DAP) | urea | ferrous | | bag |
| Foam Cubes | | pearl | | | to | | | | sulfate | | |
| | | | | | paraffin) | | | | | | |
| Black | 16 | P. | Ph spores-BoV8-A-2 | 105 | None | 0 | 1.0218 | 0.46 g | 0.6571 g | None | In |
| Polyurethane | | Pulmonarius | | | | | (w/DAP) | urea | ferrous | | bag |
| Foam Cubes | | | | | | | | | sulfate | | |
| Black | 16 | P. | P-20-M-2 (1) drip Mar. 19, 2021 | 105 | None | 0 | 1.0218 | 0.46 g | 0.6571 g | None | In |
| Polyurethane | | Ostreatus | | | | | (w/DAP) | urea | ferrous | | bag |
| Foam Cubes | | pearl | | | | | | | sulfate | | |
| Polyurethane | 16 | P. | C-A-4 Agar Apr. 7, 2021 (2); C-BoV16-3 | 105 | 2:3 BoP | 22 | 1.0218 | 2.63 g | 0.8761 g | None | None |
| Foam Shreds | | Columbinus | Mar. 19, 2021 (3); C-BoV16-BoV24-2 Mar. 24, 2021 | | (Baby oil | | (w/DAP) | peptone | ferrous | | |
| | | | (1); C-M8-2 | | to | | | | sulfate | | |
| | | | drip Mar. 19, 2021 | | paraffin) | | | | | | |
| Polyurethane | 16 | P. | C-A-4 Agar Apr. 7, 2021 (2); C-BoV16-3 | 105 | 2:3 BoP | 22 | 1.0218 | 2.63 g | 0.8761 g | None | None |
| Foam Shreds | | Columbinus | Mar. 19, 2021 (3); C-BoV16-BoV24-2 Mar. 24, 2021 | | (Baby oil | | (w/DAP) | peptone | ferrous | | |
| | | | (1); C-M8-2 | | to | | | | sulfate | | |
| | | | drip Mar. 19, 2021 | | paraffin) | | | | | | |
| Polyurethane | 8 | P. | C-A-4 Agar Apr. 7, 2021 (2); C-BoV16-3 | 91 | 2:3 BoP | 11 | 0.8855 | 2.28 g | 0.7593 g | None | None |
| Foam Shreds | | Columbinus | Mar. 19, 2021 (3); C-BoV16-BoV24-2 Mar. 24, 2021 | | (Baby oil | | (w/DAP) | peptone | ferrous | | |
| | | | (1); C-M8-2 | | to | | | | sulfate | | |
| | | | drip Mar. 19, 2021 | | paraffin) | | | | | | |
| Polyurethane | 8 | P. | C-A-4 Agar Apr. 7, 2021 (2); C-BoV16-3 | 91 | 2:3 BoP | 11 | 0.8855 | 2.28 g | 0.7593 g | None | None |
| Foam Shreds | | Columbinus | Mar. 19, 2021 (3); C-BoV16-BoV24-2 Mar. 24, 2021 | | (Baby oil | | (w/DAP) | peptone | ferrous | | |
| | | | (1); C-M8-2 | | to | | | | sulfate | | |
| | | | drip Mar. 19, 2021 | | paraffin) | | | | | | |
| Black | 8 | P. | Ph (100% ½ pr) Spores A-3 (2) 2^{nd} gen | 91 | 2:3 BoP | 11 | 0.8855 | 0.3986 g | 0.5695 g | None | 1 g |
| Polyurethane | | Pulmonarius | Jun. 26, 2022; (New) Ph-A-3 2^{nd} gen Mar. 2, 2022; | | (Baby oil | | (w/DAP) | urea | ferrous | | corn |
| Foam Cubes | | | (New) Ph-BoV8-3 3^{rd} gen Jun. 26, 2022; Ph | | to | | | | sulfate | | starc h |
| | | | spores BoV-A-2 3^{rd} gen Jun. 26, 2022 | | paraffin) | | | | | | |
| Black | 8 | P. | Ph (100% ½ pr) Spores A-3 (2) 2^{nd} gen | 91 | 2:3 BoP | 11 | 0.8855 | 0.3986 g | 0.5695 g | None | 1 g |
| Polyurethane | | Pulmonarius | Jun. 26, 2022; (New) Ph-A-3 2^{nd} gen Mar. 2, 2022; | | (Baby oil | | (w/DAP) | urea | ferrous | | corn |
| Foam Cubes | | | (New) Ph-BoV8-3 3^{rd} gen Jun. 26, 2022; Ph | | to | | | | sulfate | | starc h |
| | | | spores BoV-A-2 3^{rd} gen Jun. 26, 2022 | | paraffin) | | | | | | |
| Black | 8 | P. | Ph (100% ½ pr) Spores A-3 (2) 2^{nd} gen | 91 | 2:3 BoP | 11 | 0.8855 | 0.3986 g | 0.5695 g | None | 1 g |
| Polyurethane | | Pulmonarius | Jun. 26, 2022; (New) Ph-A-3 2^{nd} gen Mar. 2, 2022; | | (Baby oil | | (w/DAP) | urea | ferrous | | corn |
| Foam Cubes | | | (New) Ph-BoV8-3 3^{rd} gen Jun. 26, 2022; Ph | | to | | | | sulfate | | starc h |
| | | | spores BoV-A-2 3^{rd} gen Jun. 26, 2022 | | paraffin) | | | | | | |
| Black | 8 | P. | Ph (100% ½ pr) Spores A-3 (2) 2^{nd} gen | 91 | 2:3 BoP | 11 | 0.8855 | 0.3986 g | 0.5695 g | None | 1 g |
| Polyurethane | | Pulmonarius | Jun. 26, 2022; (New) Ph-A-3 2^{nd} gen Mar. 2, 2022; | | (Baby oil | | (w/DAP) | urea | ferrous | | corn |
| Foam Cubes | | | (New) Ph-BoV8-3 3^{rd} gen Jun. 26, 2022; Ph | | to | | | | sulfate | | starch |
| | | | spores BoV-A-2 3^{rd} gen Jun. 26, 2022 | | paraffin) | | | | | | |
| Black | 16 | P. | Ph spores-BoV8-A-2 4^{th} gen Dec. 16, 2022 | 105 | 2:3 BoP | 22 | 1.0218 | 0.46 g | 0.6571 g | None | In |
| Polyurethane | | Pulmonarius | | | (Baby oil | | (w/DAP) | urea | ferrous | | bag |
| Foam Cubes | | | | | to | | | | sulfate | | |
| | | | | | paraffin) | | | | | | |
| Black | 16 | P. | P-20M-2 (1) drip Mar. 19, 2021 | 105 | 2:3 BoP | 22 | 1.0218 | 0.46 g | 0.6571 g | None | In |
| Polyurethane | | Ostreatus | | | (Baby oil | | (w/DAP) | urea | ferrous | | bag |
| Foam Cubes | | pearl | | | to | | | | sulfate | | |
| | | | | | paraffin) | | | | | | |
| Black | 16 | P. | Ph spores-BoV8-A-2 4^{th} gen Dec. 16, 2022 | 105 | None | 0 | 1.0218 | 0.46 g | 0.6571 g | None | In |
| Polyurethane | | Pulmonarius | | | | | (w/DAP) | urea | ferrous | | bag |
| Foam Cubes | | | | | | | | | sulfate | | |
| Black | 16 | P. | P-20M-2 (1) drip Mar. 19, 2021 | 105 | None | 0 | 1.0218 | 0.46 g | 0.6571 g | None | In |
| Polyurethane | | Ostreatus | | | | | (w/DAP) | urea | ferrous | | bag |
| Foam Cubes | | pearl | | | | | | | sulfate | | |
| Black | 16 | P. | Water PolyU Spores A-4 Dec. 2, 2022; Water | 105 | 2:3 BoP | 22 | 1.0218 | 0.46 g | 0.6571 g | None | None |
| Polyurethane | | Pulmonarius | PolyU Spores A-B10A-A2 Dec. 2, 2022; Water | | (Baby oil | | (w/DAP) | urea | ferrous | | |
| Foam Cubes | | | PolyU Spores A-5 Dec. 16, 2022; Water PolyU | | to | | | | sulfate | | |
| | | | Spores A-B10A-A-3 Dec. 16, 2022 | | paraffin) | | | | | | |
| Black | 16 | P. | Water PolyU Spores A-4 Dec. 2, 2022; Water | 105 | 2:3 BoP | 22 | 1.0218 | 0.46 g | 0.6571 g | None | None |
| Polyurethane | | Pulmonarius | PolyU Spores A-B10A-A2 Dec. 2, 2022; Water | | (Baby oil | | (w/DAP) | urea | ferrous | | |
| Foam Cubes | | | PolyU Spores A-5 Dec. 16, 2022; Water PolyU | | to | | | | sulfate | | |
| | | | Spores A-B10A-A-3 Dec. 16, 2022 | | paraffin) | | | | | | |
| Black | 8 | P. | Water PolyU Spores A-4 Dec. 2, 2022; Water | 91 | 2:3 BoP | 11 | 0.8855 | 0.3986 g | 0.5695 g | None | None |
| Polyurethane | | Pulmonarius | PolyU Spores A-B10A-A2 Dec. 2, 2022; Water | | (Baby oil | | (w/DAP) | urea | ferrous | | |
| Foam Cubes | | | PolyU Spores A-5 Dec. 16, 2022; Water PolyU | | to | | | | sulfate | | |
| | | | Spores A-B10A-A-3 Dec. 16, 2022 | | paraffin) | | | | | | |
| Black | 8 | P. | Water PolyU Spores A-4 Dec. 2, 2022; Water | 91 | 2:3 BoP | 11 | 0.8855 | 0.3986 g | 0.5695 g | None | None |
| Polyurethane | | Pulmonarius | PolyU Spores A-B10A-A2 Dec. 2, 2022; Water | | (Baby oil | | (w/DAP) | urea | ferrous | | |
| Foam Cubes | | | PolyU Spores A-5 Dec. 16, 2022; Water PolyU | | to | | | | sulfate | | |
| | | | Spores A-B10A-A-3 Dec. 16, 2022 | | paraffin) | | | | | | |
| Black | 16 | P. | Water PolyU Spores A-4 Dec. 2, 2022; Water | 105 | None | 0 | 1.0218 | 0.46 g | 0.6571 g | None | None |
| Polyurethane | | Pulmonarius | PolyU Spores A-B10A-A2 Dec. 2, 2022; Water | | | | (w/DAP) | urea | ferrous | | |
| Foam Cubes | | | PolyU Spores A-5 Dec. 16, 2022; Water PolyU | | | | | | sulfate | | |
| | | | Spores A-B10A-A-3 Dec. 16, 2022 | | | | | | | | |
| Black | 16 | P. | Water PolyU Spores A-4 Dec. 2, 2022; Water | 105 | None | 0 | 1.0218 | 0.46 g | 0.6571 g | None | None |
| Polyurethane | | Pulmonarius | PolyU Spores A-B10A-A2 Dec. 2, 2022; Water | | | | (w/DAP) | urea | ferrous | | |
| Foam Cubes | | | PolyU Spores A-5 Dec. 16, 2022; Water PolyU | | | | | | sulfate | | |
| | | | Spores A-B10A-A-3 Dec. 16, 2022 | | | | | | | | |
| Black | 8 | P. | Water PolyU Spores A-4 Dec. 2, 2022; Water | 91 | None | 0 | 0.8855 | 0.3986 g | 0.5695 g | None | None |
| Polyurethane | | Pulmonarius | PolyU Spores A-B10A-A2 Dec. 2, 2022; Water | | | | (w/DAP) | urea | ferrous | | |
| Foam Cubes | | | PolyU Spores A-5 Dec. 16, 2022; Water PolyU | | | | | | sulfate | | |
| | | | Spores A-B10A-A-3 Dec. 16, 2022 | | | | | | | | |
| Black | 8 | P. | Water PolyU Spores A-4 Dec. 2, 2022; Water | 91 | None | 0 | 0.8855 | 0.3986 g | 0.5695 g | None | None |
| Polyurethane | | Pulmonarius | PolyU Spores A-B10A-A2 Dec. 2, 2022; Water | | | | (w/DAP) | urea | ferrous | | |
| Foam Cubes | | | PolyU Spores A-5 Dec. 16, 2022; Water PolyU | | | | | | sulfate | | |
| | | | Spores A-B10A-A-3 Dec. 16, 2022 | | | | | | | | |
| Black | 1.6 | P. | P. Pulmonariusculture | 13.45 | 2:3 BoP | 2.2 | 0.1309 | 0.0589 g | 0.0842 g | None | None |
| Polyurethane | | Pulmonarius | | | (Baby oil | | (w/DAP) | urea | ferrous | | |
| Foam Cubes | | | | | to | | | | sulfate | | |
| | | | | | paraffin) | | | | | | |
| Black | 1.6 | P. | P. Pulmonariusculture | 13.45 | 2:3 BoP | 2.2 | 0.1309 | 0.0589 g | 0.0842 g | None | None |
| Polyurethane | | Pulmonarius | | | (Baby oil | | (w/DAP) | urea | ferrous | | |
| Foam Cubes | | | | | to | | | | sulfate | | |
| | | | | | paraffin) | | | | | | |
| Black | 1.6 | P. | P. Pulmonariusculture | 13.45 | 2:3 BoP | 2.2 | 0.1309 | 0.0589 g | 0.0842 g | None | None |
| Polyurethane | | Pulmonarius | | | (Baby oil | | (w/DAP) | urea | ferrous | | |
| Foam Cubes | | | | | to | | | | sulfate | | |
| | | | | | paraffin) | | | | | | |
| Black | 1.6 | P. | P. Pulmonariusculture | 13.45 | 2:3 BoP | 2.2 | 0.1309 | 0.0589 g | 0.0842 g | None | None |
| Polyurethane | | Pulmonarius | | | (Baby oil | | (w/DAP) | urea | ferrous | | |
| Foam Cubes | | | | | to | | | | sulfate | | |
| | | | | | paraffin) | | | | | | |
| Black | 16 | P. | S(1) Mar. 13, 2021; S(2) Mar. 13, 2021; S(3) Mar. 13, 2021; | 105 | None | None | 1.0218 | 0.46 g | 0.6571 g | None | None |
| Polyurethane | | Ostreatus | S(4) Mar. 12, 2021 | | | | (w/DAP) | urea | ferrous | | |
| Foam Cubes | | silver | | | | | | | sulfate | | |
| Black | 16 | P. | S(1) Mar. 13, 2021; S(2) Mar. 13, 2021; S(3) Mar. 13, 2021; | 105 | None | None | 1.0218 | 0.46 g | 0.6571 g | None | None |
| Polyurethane | | Ostreatus | S(4) Mar. 12, 2021 | | | | (w/DAP) | urea | ferrous | | |
| Foam Cubes | | silver | | | | | | | sulfate | | |
| Black | 8 | P. | S(1) Mar. 13, 2021; S(2) Mar. 13, 2021; S(3) Mar. 13, 2021; | 91 | None | None | 0.8855 | 0.3986 g | 0.5695 g | None | None |
| Polyurethane | | Ostreatus | S(4) Mar. 12, 2021 | | | | (w/DAP) | urea | ferrous | | |
| Foam Cubes | | silver | | | | | | | sulfate | | |
| Black | 8 | P. | S(1) Mar. 13, 2021; S(2) Mar. 13, 2021; S(3) Mar. 13, 2021; | 91 | None | None | 0.8855 | 0.3986 g | 0.5695 g | None | None |
| Polyurethane | | Ostreatus | S(4) Mar. 12, 2021 | | | | (w/DAP) | urea | ferrous | | |
| Foam Cubes | | silver | | | | | | | sulfate | | |
| Black | 16 | P. | P-20M-2 Mar. 19, 2021 (2); P-20M02 Mar. 19, 2021 | 105 | 2:3 BoP | 22 | 1.0218 | 0.46 g | 0.6571 g | None | None |
| Polyurethane | | Ostreatus | (3); P-20M-2 Mar. 19, 2021 (4); P-20M-2 drip 3- | | (Baby oil | | (W / DAP) | urea | ferrous | | |
| Foam Cubes | | pearl | 19 | | to | | | | sulfate | | |
| | | | 21 (1) | | paraffin) | | | | | | |
| Black | 16 | P. | P-20M-2 Mar. 19, 2021 (2); P-20M02 Mar. 19, 2021 | 105 | 2:3 BoP | 22 | 1.0218 | 0.46 g | 0.6571 g | None | None |
| Polyurethane | | Ostreatus | (3); P-20M-2 Mar. 19, 2021 (4); P-20M-2 drip 3- | | (Baby oil | | (w/DAP) | urea | ferrous | | |
| Foam Cubes | | pearl | 19 | | to | | | | sulfate | | |
| | | | 21 (1) | | paraffin) | | | | | | |
| Black | 8 | P. | P-20M-2 Mar. 19, 2021 (2); P-20M02 Mar. 19, 2021 | 91 | 2:3 BoP | 11 | 0.8855 | 0.3986 g | 0.5695 g | None | None |
| Polyurethane | | Ostreatus | (3); P-20M-2 Mar. 19, 2021 (4); P-20M-2 drip 3- | | (Baby oil | | (w/DAP) | urea | ferrous | | |
| Foam Cubes | | pearl | 19 | | to | | | | sulfate | | |
| | | | 21 (1) | | paraffin) | | | | | | |
| Black | 8 | P. | P-20M-2 Mar. 19, 2021 (2); P-20M02 Mar. 19, 2021 | 91 | 2:3 BoP | 11 | 0.8855 | 0.3986 g | 0.5695 g | None | None |
| Polyurethane | | Ostreatus | (3); P-20M-2 Mar. 19, 2021 (4); P-20M-2 drip 3- | | (Baby oil | | (w/DAP) | urea | ferrous | | |
| Foam Cubes | | pearl | 19 | | to | | | | sulfate | | |
| | | | 21 (1) | | paraffin) | | | | | | |
| Black | 8 | P. | Ph spores-BoV8-A-2 4^{th} gen Dec. 6, 2022 | 91 | 2:3 BoP | 11 | 0.8855 | 0.3986 g | 0.5695 g | None | In |
| Polyurethane | | Pulmonarius | | | (Baby oil | | (w/DAP) | urea | ferrous | | bag |
| Foam Cubes | | | | | to | | | | sulfate | | |
| | | | | | paraffin) | | | | | | |
| Black | 8 | P. | Ph spores-BoV8-A-2 4^{th} gen Dec. 6, 2022 | 91 | 2:3 BoP | 11 | 0.8855 | 0.3986 g | 0.5695 g | None | In |
| Polyurethane | | Pulmonarius | | | (Baby oil | | (w/DAP) | urea | ferrous | | bag |
| Foam Cubes | | | | | to | | | | sulfate | | |
| | | | | | paraffin) | | | | | | |
| Black | 8 | P. | P-20M-2 drip (1) Mar. 19, 2021 | 91 | 2:3 BoP | 11 | 0.8855 | 0.3986 g | 0.5695 g | None | In |
| Polyurethane | | Ostreatus | | | (Baby oil | | (w/DAP) | urea | ferrous | | bag |
| Foam Cubes | | pearl | | | to | | | | sulfate | | |
| | | | | | paraffin) | | | | | | |
| Black | 8 | P. | P-20M-2 drip (1) Mar. 19, 2021 | 91 | 2:3 BoP | 11 | 0.8855 | 0.3986 g | 0.5695 g | None | In |
| Polyurethane | | Ostreatus | | | (Baby oil | | (w/DAP) | urea | ferrous | | bag |
| Foam Cubes | | pearl | | | to | | | | sulfate | | |
| | | | | | paraffin) | | | | | | |
| Black | 8 | P. | Water PolyU Spores A-B10A-A2 Dec. 2, 2022; | 91 | 2:3 BoP | 11 | 0.8855 | 0.3986 g | 0.5695 g | None | None |
| Polyurethane | | Pulmonarius | Water PolyU Spores A-4-B10-A Dec. 16, 2022;91 | | (Baby oil | | (w/DAP) | urea | ferrous | | |
| Foam Cubes | | | Water PolyU Spores A-4 2^{nd} gen Jan. 27, 2023; | | to | | | | sulfate | | |
| | | | Water PolyU Spores A-5 2^{nd} gen Jan. 27, 2023 | | paraffin) | | | | | | |
| Black | 8 | P. | Water PolyU Spores A-B10A-A2 Dec. 2, 2022; | 91 | 2:3 BoP | 11 | 0.8855 | 0.3986 g | 0.5695 g | None | None |
| Polyurethane | | Pulmonarius | Water PolyU Spores A-4-B10-A Dec. 16, 2022; | | (Baby oil | | (w/DAP) | urea | ferrous | | |
| Foam Cubes | | | Water PolyU Spores A-4 2^{nd} gen Jan. 27, 2023; | | to | | | | sulfate | | |
| | | | Water PolyU Spores A-5 2^{nd} gen Jan. 27, 2023 | | paraffin) | | | | | | |
| Polyurethane | 8 | P. | Water PolyU Spores A-B10A-A2 Dec. 2, 2022; | 91 | 2:3 BoP | 11 | 0.8855 | 0.3986 g | 0.5695 g | None | None |
| Foam Shreds | | Pulmonarius | Water PolyU Spores A-4-B10-A Dec. 16, 2022; | | (Baby oil | | (w/DAP) | urea | ferrous | | |
| | | | Water PolyU Spores A-4 2^{nd} gen Jan. 27, 2023; | | to | | | | sulfate | | |
| | | | Water PolyU Spores A-5 2^{nd} gen Jan. 27, 2023 | | paraffin) | | | | | | |
| Polyurethane | 8 | P. | Water PolyU Spores A-B10A-A2 Dec. 2, 2022; | 91 | 2:3 BoP | 11 | 0.8855 | 0.3986 g | 0.5695 g | None | None |
| Foam Shreds | | Pulmonarius | Water PolyU Spores A-4-B10-A Dec. 16, 2022; | | (Baby oil | | (w/DAP) | urea | ferrous | | |
| | | | Water PolyU Spores A-4 2^{nd} gen Jan. 27, 2023; | | to | | | | sulfate | | |
| | | | Water PolyU Spores A-5 2^{nd} gen Jan. 27, 2023 | | paraffin) | | | | | | |
| Polyurethane | 10 | P. | Water PolyU Spores A-B10A-A2 Dec. 2, 2022; | 72 | 2:3 BoP | 13 | 0.6952 | 0.3308 g | 0.45 g | None | Non |
| Foam Shreds | | Pulmonarius | Water PolyU Spores A-4-B10-A-A3 | | (Baby oil | | (w/DAP) | urea | ferrous | | ID |
| | | | Dec. 16, 2022; Water PolyU Spores A-4 2^{nd} | | to | | | | sulfate | | |
| | | | gen Jan. 27, 2023; Water PolyU Spores A-5 | | paraffin) | | | | | | |
| | | | Dec. 16, 2022 | | | | | | | | |
| Polyurethane | 10 | P. | Water PolyU Spores A-B10A-A2 Dec. 2, 2022; | 72 | 2:3 BoP | 13 | 0.6952 | 0.3308 g | 0.45 g | None | None |
| Foam Shreds | | Pulmonarius | Water PolyU Spores A-4-B10-A-A3 | | (Baby oil | | (w/DAP) | urea | ferrous | | |
| | | | Dec. 16, 2022; Water PolyU Spores A-4 2^{nd} | | to | | | | sulfate | | |
| | | | gen Jan. 27, 2023; Water PolyU Spores A-5 | | paraffin) | | | | | | |
| | | | Dec. 16, 2022 | | | | | | | | |
| Polyurethane | 10 | P. | gen Jan. 27, 2023; Water PolyU Spores A-5 Water PolyU Spores | 72 | 2:3 BoP | 13 | 0.6952 | 0.3308 g | 0.45 g | None | None |
| Foam Shreds | | Pulmonarius | A-B10A-A2 Dec. 2, 2022; | | (Baby oil | | (w/DAP) | urea | ferrous | | |
| | | | Water PolyU Spores A-4-B10-A-A3 | | to | | | | sulfate | | |
| | | | Dec. 16, 2022; Water PolyU Spores A-4 2^{nd} | | paraffin) | | | | | | |
| | | | Dec. 16, 2022 | | | | | | | | |
| Polyurethane | 10 | P. | gen Jan. 27, 2023; Water PolyU Spores A-5 Water PolyU Spores | 72 | 2:3 BoP | 13 | 0.6952 | 0.3308 g | 0.45 g | None | None |
| Foam Shreds | | Pulmonarius | A-B10A-A2 Dec. 2, 2022; | | (Baby oil | | (w/DAP) | urea | ferrous | | |
| | | | Water PolyU Spores A-4-B10-A-A3 | | to | | | | sulfate | | |
| | | | Dec. 16, 2022; Water PolyU Spores A-4 2^{nd} | | paraffin) | | | | | | |
| | | | Dec. 16, 2022 | | | | | | | | |
| Black | 3.6 | P. | gen Jan. 27, 2023; Water PolyU Spores A-5 Water PolyU Spores | 72 | 2:3 BoP | 5 | 0.6952 | 0.3308 g | 0.45 g | None | None |
| Polyurethane | | Pulmonarius | A-B10A-A2 Dec. 2, 2022; | | ( Baby oil | | (w/DAP) | urea | ferrous | | |
| Foam Cubes | | | Water PolyU Spores A-4-B10-A-A3 | | to | | | | sulfate | | |
| | | | Dec. 16, 2022; Water PolyU Spores A-4 2^{nd} | | paraffin) | | | | | | |
| | | | Dec. 16, 2022 | | | | | | | | |
| Black | 3.6 | P. | gen Jan. 27, 2023; Water PolyU Spores A-5 Water PolyU Spores | 72 | 2:3 BoP | 5 | 0.6952 | 0.3308 g | 0.45 g | None | None |
| Polyurethane | | Pulmonarius | A-B10A-A2 Dec. 2, 2022; | | (Baby oil | | (w/DAP) | urea | ferrous | | |
| Foam Cubes | | | Water PolyU Spores A-4-B10-A-A3 | | to | | | | sulfate | | |
| | | | Dec. 16, 2022; Water PolyU Spores A-4 2^{nd} | | paraffin) | | | | | | |
| | | | Dec. 16, 2022 | | | | | | | | |
| Black | 3.6 | P. | gen Jan. 27, 2023; Water PolyU Spores A-5 Water PolyU Spores | 72 | 2:3 BoP | 5 | 0.6952 | 0.3308 g | 0.45 g | None | None |
| Polyurethane | | Pulmonarius | A-B10A-A2 Dec. 2, 2022; | | (Baby oil | | (w/DAP) | urea | ferrous | | |
| Foam Cubes | | | Water PolyU Spores A-4-B10-A-A3 | | to | | | | sulfate | | |
| | | | Dec. 16, 2022; Water PolyU Spores A-4 2^{nd} | | paraffin) | | | | | | |
| | | | Dec. 16, 2022 | | | | | | | | |
| Black | 3.6 | P. | Water PolyU Spores A-B10A-A2 Dec. 2, 2022; | 72 | 2:3 BoP | 5 | 0.6952 | 0.3308 g | 0.45 g | None | None |
| Polyurethane | | Pulmonarius | Water PolyU Spores A-4-B10-A-A3 | | (Baby oil | | (w/DAP) | urea | ferrous | | |
| Foam Cubes | | | Dec. 16, 2022; Water PolyU Spores A-4 2^{nd} | | to | | | | sulfate | | |
| | | | gen Jan. 27, 2023; Water PolyU Spores A-5 | | paraffin) | | | | | | |
| | | | Dec. 16, 2022 | | | | | | | | |
| Black | 2 | P. | P. Ostreatus pearl culture | 22.75 | 2:3 BoP | 2.75 | 0.2213 | 0.0827 g | 0.1424 g | None | None |
| Polyurethane | | Ostreatus | | | (Baby oil | | (w/DAP) | urea | ferrous | | |
| Foam Cubes | | pearl | | | to | | | | sulfate | | |
| | | | | | paraffin) | | | | | | |
| Black | 2 | P. | P. Ostreatus pearl culture | 22.75 | 2:3 BoP | 2.75 | 0.2213 | 0.0827 g | 0.1424 g | None | None |
| Polyurethane | | Ostreatus | | | (Baby oil | | (w/DAP) | urea | ferrous | | |
| Foam Cubes | | pearl | | | to | | | | sulfate | | |
| | | | | | paraffin) | | | | | | |
| Black | 2 | P. | P. Ostreatus pearl culture | 22.75 | 2:3 BoP | 2.75 | 0.2213 | 0.0827 g | 0.1424 g | None | None |
| Polyurethane | | Ostreatus | | | (Baby oil | | (w/DAP) | urea | ferrous | | |
| Foam Cubes | | pearl | | | to | | | | sulfate | | |
| | | | | | paraffin) | | | | | | |
| Black | 2 | P. | P. Ostreatus pearl culture | 22.75 | 2:3 BoP | 2.75 | 0.2213 | 0.0827 g | 0.1424 g | None | None |
| Polyurethane | | Ostreatus | | | (Baby oil | | (w/DAP) | urea | ferrous | | |
| Foam Cubes | | pearl | | | to | | | | sulfate | | |
| | | | | | paraffin) | | | | | | |
| Black | 1 | P. | P. Columbinus culture | 9.09 | 1:1 BoP | 1 | 0.0885 | 0.2277 g | 0.0758 g | None | None |
| Polyurethane | | Columbinus | | | (Baby oil | | (w/DAP) | peptone | ferrous | | |
| Foam Cubes | | | | | to | | | | sulfate | | |
| | | | | | paraffin) | | | | | | |
| Black | 1 | P. | P. Columbinus culture | 9.09 | 1:1 BoP | 1 | 0.0885 | 0.2277 g | 0.0758 g | None | None |
| Polyurethane | | Columbinus | | | (Baby oil | | (w/DAP) | peptone | ferrous | | |
| Foam Cubes | | | | | to | | | | sulfate | | |
| | | | | | paraffin) | | | | | | |
| Black | 8 | P. | Water PolyU Spores A-B10A-A3 Dec. 16, 2022 | 91 | 2:3 BoP | 11 | 0.8855 | 0.3986 g | 0.5695 g | None | In |
| Polyurethane | | Pulmonarius | | | (Baby oil | | (w/DAP) | urea | ferrous | | bag |
| Foam Cubes | | | | | to | | | | sulfate | | |
| | | | | | paraffin) | | | | | | |
| Black | 8 | P. | Water PolyU Spores A-B10A-A3 Dec. 16, 2022 | 91 | 2:3 BoP | 11 | 0.8855 | 0.3986 g | 0.5695 g | None | In |
| Polyurethane | | Pulmonarius | | | (Baby oil | | (w/DAP) | urea | ferrous | | bag |
| Foam Cubes | | | | | to | | | | sulfate | | |
| | | | | | paraffin) | | | | | | |
| Black | 8 | P. | Water PolyU Spores A-4 2^{nd} gen Jan. 27, 2023 | 91 | 2:3 BoP | 11 | 0.8855 | 0.3986 g | 0.5695 g | None | In |
| Polyurethane | | Pulmonarius | | | (Baby oil | | (w/DAP) | urea | ferrous | | bag |
| Foam Cubes | | | | | to | | | | sulfate | | |
| | | | | | paraffin) | | | | | | |
| Black | 8 | P. | Water PolyU Spores A-4 2^{nd} gen Jan. 27, 2023 | 91 | 2:3 BoP | 11 | 0.8855 | 0.3986 g | 0.5695 g | None | In |
| Polyurethane | | Pulmonarius | | | (Baby oil | | (w/DAP) | urea | ferrous | | bag |
| Foam Cubes | | | | | to | | | | sulfate | | |
| | | | | | paraffin) | | | | | | |
| Polyurethane | 10 | P. | Water PolyU Spores A-B10A-A2 Dec. 2, 2022; | 72 | None | 0 | 0.6952 | 0.3308 g | 0.45 g | None | None |
| Foam Shreds | | Pulmonarius | Water PolyU Spores A-4-B10-A-A3 | | | | (w/DAP) | urea | ferrous | | |
| | | | Dec. 16, 2022; Water PolyU Spores A-4 2^{nd} | | | | | | sulfate | | |
| | | | gen Jan. 27, 2023; Water PolyU Spores A-5 | | | | | | | | |
| | | | Dec. 16, 2022 | | | | | | | | |
| Polyurethane | 10 | P. | Water PolyU Spores A-B10A-A2 Dec. 2, 2022; | 72 | None | 0 | 0.6952 | 0.3308 g | 0.45 g | None | None |
| Foam Shreds | | Pulmonarius | Water PolyU Spores A-4-B10-A-A3 | | | | (w/DAP) | urea | ferrous | | |
| | | | Dec. 16, 2022; Water PolyU Spores A-4 2^{nd} | | | | | | sulfate | | |
| | | | gen Jan. 27, 2023; Water PolyU Spores A-5 | | | | | | | | |
| | | | Dec. 16, 2022 | | | | | | | | |
| Polyurethane | 10 | P. | Water PolyU Spores A-B10A-A2 Dec. 2, 2022; | 72 | None | 0 | 0.6952 | 0.3308 g | 0.45 g | None | None |
| Foam Shreds | | Pulmonarius | Water PolyU Spores A-4-B10-A-A3 | | | | (w/DAP) | urea | ferrous | | |
| | | | Dec. 16, 2022; Water PolyU Spores A-4 2^{nd} | | | | | | sulfate | | |
| | | | gen Jan. 27, 2023; Water PolyU Spores A-5 | | | | | | | | |
| | | | Dec. 16, 2022 | | | | | | | | |
| Polyurethane | 10 | P. | Water PolyU Spores A-B10A-A2 Dec. 2, 2022; | 72 | None | 0 | 0.6952 | 0.3308 g | 0.45 g | None | None |
| Foam Shreds | | Pulmonarius | Water PolyU Spores A-4-B10-A-A3 | | | | (w/DAP) | urea | ferrous | | |
| | | | Dec. 16, 2022; Water PolyU Spores A-4 2^{nd} | | | | | | sulfate | | |
| | | | gen Jan. 27, 2023; Water PolyU Spores A-5 | | | | | | | | |
| | | | Dec. 16, 2022 | | | | | | | | |
| Black | 3.6 | P. | Water PolyU Spores A-B10A-A2 Dec. 2, 2022; | 72 | None | 0 | 0.6952 | 0.3308 g | 0.45 g | None | None |
| Polyurethane | | Pulmonarius | Water PolyU Spores A-4-B10-A-A3 | | | | (w/DAP) | urea | ferrous | | |
| Foam Cubes | | | Dec. 16, 2022; Water PolyU Spores A-4 2^{nd} | | | | | | sulfate | | |
| | | | gen Jan. 27, 2023; Water PolyU Spores A-5 | | | | | | | | |
| | | | Dec. 16, 2022 | | | | | | | | |
| Black | 3.6 | P. | Water PolyU Spores A-B10A-A2 Dec. 2, 2022; | 72 | None | 0 | 0.6952 | 0.3308 g | 0.45 g | None | None |
| Polyurethane | | Pulmonarius | Water PolyU Spores A-4-B10-A-A3 | | | | (w/DAP) | urea | ferrous | | |
| Foam Cubes | | | Dec. 16, 2022; Water PolyU Spores A-4 2^{nd} | | | | | | sulfate | | |
| | | | gen Jan. 27, 2023; Water PolyU Spores A-5 | | | | | | | | |
| | | | Dec. 16, 2022 | | | | | | | | |
| Black | 3.6 | P. | Water PolyU Spores A-B10A-A2 Dec. 2, 2022; | 72 | None | 0 | 0.6952 | 0.3308 g | 0.45 g | None | None |
| Polyurethane | | Pulmonarius | Water PolyU Spores A-4-B10-A-A3 | | | | (w/DAP) | urea | ferrous | | |
| Foam Cubes | | | Dec. 16, 2022; Water PolyU Spores A-4 2^{nd} | | | | | | sulfate | | |
| | | | gen Jan. 27, 2023; Water PolyU Spores A-5 | | | | | | | | |
| | | | Dec. 16, 2022 | | | | | | | | |
| Black | 3.6 | P. | Water PolyU Spores A-B10A-A2 Dec. 2, 2022; | 72 | None | 0 | 0.6952 | 0.3308 g | 0.45 g | None | None |
| Polyurethane | | Pulmonarius | Water PolyU Spores A-4-B10-A-A3 | | | | (w/DAP) | urea | ferrous | | |
| Foam Cubes | | | Dec. 16, 2022; Water PolyU Spores A-4 2^{nd} | | | | | | sulfate | | |
| | | | gen Jan. 27, 2023; Water PolyU Spores A-5 | | | | | | | | |
| | | | Dec. 16, 2022 | | | | | | | | |
| Black | 8 | P. | C-A-4 Agar Apr. 7, 2021 (3); C-BoV16-3 | 91 | None | 0 | 0.8855 | 2.28 g | 0.7593 g | None | None |
| Polyurethane | | Columbinus | Mar. 19, 2021 (4); C-BoV16-BoV24-2 Mar. 24, 2021 | | | | (w/DAP) | peptone | ferrous | | |
| Foam Cubes | | | (1); C-M8-2 | | | | | | sulfate | | |
| | | | drip Mar. 19, 2021 (2) | | | | | | | | |
| Black | 8 | P. | C-A-4 Agar Apr. 7, 2021 (3); C-BoV16-3 | 91 | None | 0 | 0.8855 | 2.28 g | 0.7593 g | None | None |
| Polyurethane | | Columbinus | Mar. 19, 2021 (4); C-BoV16-BoV24-2 Mar. 24, 2021 | | | | (w/DAP) | peptone | ferrous | | |
| Foam Cubes | | | (1); C-M8-2 | | | | | | sulfate | | |
| | | | drip Mar. 19, 2021 (2) | | | | | | | | |
| Black | 8 | P. | C-A-4 Agar Apr. 7, 2021 (3); C-BoV16-3 | 91 | None | 0 | 0.8855 | 2.28 g | 0.7593 g | None | None |
| Polyurethane | | Columbinus | Mar. 19, 2021 (4); C-BoV16-BoV24-2 Mar. 24, 2021 | | | | (w/DAP) | peptone | ferrous | | |
| Foam Cubes | | | (1); C-M8-2 | | | | | | sulfate | | |
| | | | drip Mar. 19, 2021 (2) | | | | | | | | |
| Black | 8 | P. | C-A-4 Agar Apr. 7, 2021 (3); C-BoV16-3 | 91 | None | 0 | 0.8855 | 2.28 g | 0.7593 g | None | None |
| Polyurethane | | Columbinus | Mar. 19, 2021 (4); C-BoV16-BoV24-2 Mar. 24, 2021 | | | | (w/DAP) | peptone | ferrous | | |
| Foam Cubes | | | (1); C-M8-2 | | | | | | sulfate | | |
| | | | drip Mar. 19, 2021 (2) | | | | | | | | |
| Black | 8 | P. | C-A-4 Agar Apr. 7, 2021 (3); C-BoV16-3 | 91 | 2:3 BoP | 11 | 0.8855 | 2.28 g | 0.7593 g | None | None |
| Polyurethane | | Columbinus | Mar. 19, 2021 (4); C-BoV16-BoV24-2 Mar. 24, 2021 | | (Baby oil | | (w/DAP) | peptone | ferrous | | |
| Foam Cubes | | | (1); C-M8-2 | | to | | | | sulfate | | |
| | | | drip Mar. 19, 2021 (2) | | paraffin) | | | | | | |
| Black | 8 | P. | C-A-4 Agar Apr. 7, 2021 (3); C-BoV16-3 | 91 | 2:3 BoP | 11 | 0.8855 | 2.28 g | 0.7593 g | None | None |
| Polyurethane | | Columbinus | Mar. 19, 2021 (4); C-BoV16-BoV24-2 Mar. 24, 2021 | | (Baby oil | | (w/DAP) | peptone | ferrous | | |
| Foam Cubes | | | (1); C-M8-2 | | to | | | | sulfate | | |
| | | | drip Mar. 19, 2021 (2) | | paraffin) | | | | | | |
| Black | 8 | P. | C-A-4 Agar Apr. 7, 2021 (3); C-BoV16-3 | 91 | 2:3 BoP | 11 | 0.8855 | 2.28 g | 0.7593 g | None | None |
| Polyurethane | | Columbinus | Mar. 19, 2021 (4); C-BoV16-BoV24-2 Mar. 24, 2021 | | (Baby oil | | (w/DAP) | peptone | ferrous | | |
| Foam Cubes | | | (1); C-M8-2 | | to | | | | sulfate | | |
| | | | drip Mar. 19, 2021 (2) | | paraffin) | | | | | | |
| Black | 8 | P. | C-A-4 Agar Apr. 7, 2021 (3); C-BoV16-3 | 91 | 2:3 BoP | 11 | 0.8855 | 2.28 g | 0.7593 g | None | None |
| Polyurethane | | Columbinus | Mar. 19, 2021 (4); C-BoV16-BoV24-2 Mar. 24, 2021 | | (Baby oil | | (w/DAP) | peptone | ferrous | | |
| Foam Cubes | | | (1); C-M8-2 | | to | | | | sulfate | | |
| | | | drip Mar. 19, 2021 (2) | | paraffin) | | | | | | |
| \ | | | | | | | | | | | |
| Black | 4 | P. | P-20M-2 Mar. 19, 2021 (2); P-20M02 Mar. 19, 2021 | 45.5 | None | 0 | 0.4428 | 0.1993 g | 0.225 g | None | None |
| Polyurethane | | Ostreatus | (3); P-20M-2 Mar. 19, 2021 (4); P-20M-2 drip | | | | (w/DAP) | urea | ferrous | | |
| Foam Cubes | | pearl | 3-19 | | | | | | sulfate | | |
| | | | 21 (1) | | | | | | | | |
| Black | 4 | P. | P-20M-2 Mar. 19, 2021 (2); P-20M02 Mar. 19, 2021 | 45.5 | None | 0 | 0.4428 | 0.1993 g | 0.225 g | None | None |
| Polyurethane | | Ostreatus | (3); P-20M-2 Mar. 19, 2021 (4); P-20M-2 drip | | | | (w/DAP) | urea | ferrous | | |
| Foam Cubes | | pearl | 3-19 | | | | | | sulfate | | |
| | | | 21 (1) | | | | | | | | |
| Black | 4 | P. | P-20M-2 Mar. 19, 2021 (2); P-20M02 Mar. 19, 2021 | 45.5 | None | 0 | 0.4428 | 0.1993 g | 0.225 g | None | None |
| Polyurethane | | Ostreatus | (3); P-20M-2 Mar. 19, 2021 (4); P-20M-2 drip | | | | (w/DAP) | urea | ferrous | | |
| Foam Cubes | | pearl | 3-19 | | | | | | sulfate | | |
| | | | 21 (1) | | | | | | | | |
| Black | 4 | P. | P-20M-2 Mar. 19, 2021 (2); P-20M02 Mar. 19, 2021 | 45.5 | None | 0 | 0.4428 | 0.1993 g | 0.225 g | None | None |
| Polyurethane | | Ostreatus | (3); P-20M-2 Mar. 19, 2021 (4); P-20M-2 drip | | | | (w/DAP) | urea | ferrous | | |
| Foam Cubes | | pearl | 3-19 | | | | | | sulfate | | |
| | | | 21 (1) | | | | | | | | |
| Polyurethane | 8 | P. | Water PolyU Spores A-B10A-A2 | 91 | None | 0 | 0.8855 | 0.3986 g | 0.5695 g | None | None |
| Foam Shreds | | Pulmonarius | Dec. 2, 2022; Water PolyU Spores A-4-B10- | | | | (w/DAP) | urea | ferrous | | |
| | | | A-A3 | | | | | | sulfate | | |
| | | | Dec. 16, 2022; Water PolyU Spores A-4 | | | | | | | | |
| | | | Dec. 2, 2022; Water PolyU Spores A-5 | | | | | | | | |
| | | | Dec. 16, 2022 | | | | | | | | |
| Polyurethane | 8 | P. | Water PolyU Spores A-B10A-A2 | 91 | None | 0 | 0.8855 | 0.3986 g | 0.5695 g | None | None |
| Foam Shreds | | Pulmonarius | Dec. 2, 2022; Water PolyU Spores A-4-B10- | | | | (w/DAP) | urea | ferrous | | |
| | | | A-A3 | | | | | | sulfate | | |
| | | | Dec. 16, 2022; Water PolyU Spores A-4 | | | | | | | | |
| | | | Dec. 2, 2022; Water PolyU Spores A-5 | | | | | | | | |
| | | | Dec. 16, 2022 | | | | | | | | |
| Polyurethane | 8 | P. | Water PolyU Spores A-B10A-A2 | 91 | None | 0 | 0.8855 | 0.3986 g | 0.5695 g | None | None |
| Foam Shreds | | Pulmonarius | Dec. 2, 2022; Water PolyU Spores A-4-B10- | | | | (w/DAP) | urea | ferrous | | |
| | | | A-A3 | | | | | | sulfate | | |
| | | | Dec. 16, 2022; Water PolyU Spores A-4 | | | | | | | | |
| | | | Dec. 2, 2022; Water PolyU Spores A-5 | | | | | | | | |
| | | | Dec. 16, 2022 | | | | | | | | |
| Polyurethane | 8 | P. | Water PolyU Spores A-B10A-A2 | 91 | None | 0 | 0.8855 | 0.3986 g | 0.5695 g | None | None |
| Foam Shreds | | Pulmonarius | Dec. 2, 2022; Water PolyU Spores A-4-B10- | | | | (w/DAP) | urea | ferrous | | |
| | | | A-A3 | | | | | | sulfate | | |
| | | | Dec. 16, 2022; Water PolyU Spores A-4 | | | | | | | | |
| | | | Dec. 2, 2022; Water PolyU Spores A-5 | | | | | | | | |
| | | | Dec. 16, 2022 | | | | | | | | |
| Polyurethane | 8 | P. | Water PolyU Spores A-B10A-A2 2nd gen | 50 | Baby oil | 1.5 | 0.4054 | 0.042 g | 0.06 g | 0.015 g | 0.15 g |
| Foam Shreds | | Pulmonarius | Mar. 3, 2023; Water PolyU Spores A-4-B10-A | | | | (w/DAP) | urea | ferrous | vanillin | BTMS-25; |
| | | | 2nd gen Mar. 3, 2023; Water PolyU Spores A- | | | | | | sulfate | | 0.035 g |
| | | | 4 2nd gen Jan. 27, 2023; Water PolyU Spores | | | | | | | | PG |
| | | | A-5 2nd | | | | | | | | oil |
| | | | gen Jan. 27, 2023 | | | | | | | | paint |
| Polyurethane | 8 | P. | P-20M-2 Mar. 19, 2021 (2); P-20M02 Mar. 19, 2021 | 50 | Baby oil | 1.5 | 0.4054 | 0.042 g | 0.06 g | 0.015 g | 0.15 g |
| Foam Shreds | | Ostreatus | (3); P-20M-2 Mar. 19, 2021 (4); P-20M-2 drip | | | | (w/DAP) | urea | ferrous | vanillin | BTMS-25; |
| | | pearl | 3-19 | | | | | | sulfate | | 0.035 g |
| | | | 21 (1) | | | | | | | | PG |
| | | | | | | | | | | | oil |
| | | | | | | | | | | | paint |
| Polyurethane | 8 | P. | Water PolyU Spores A-B10A-A2 2nd gen | 50 | Baby oil | 1.5 | 0.4645 | 0.056 g | 0.06 g | 0.02 g | 0.15 g |
| Foam Shreds | | Pulmonarius | Mar. 3, 2023; Water PolyU Spores A-4-B10-A | | | | (w/DAP) | urea | ferrous | vanillin | BTMS-25; |
| | | | 2nd gen Mar. 3, 2023; Water PolyU Spores A- | | | | | | sulfate | | 0.035 g |
| | | | 4 2nd gen Jan. 27, 2023; Water PolyU Spores | | | | | | | | PG |
| | | | A-5 2nd | | | | | | | | oil |
| | | | gen Jan. 27, 2023 | | | | | | | | paint |
| Polyurethane | 8 | P. | P-20M-2 Mar. 19, 2021 (2); P-20M02 Mar. 19, 2021 | 50 | Baby oil | 1.5 | 0.4645 | 0.056 g | 0.06 g | 0.02 g | 0.15 g |
| Foam Shreds | | Ostreatus | (3); P-20M-2 Mar. 19, 2021 (4); P-20M-2 drip | | | | (w/DAP) | urea | ferrous | vanillin | BTMS-25; |
| | | pearl | 3-19 | | | | | | sulfate | | 0.035 g |
| | | | 21 (1) | | | | | | | | PG oil |
| | | | | | | | | | | | paint |
| Polyurethane | 8 | P. | Water PolyU Spores A-B10A-A2 2nd gen | 50 | Baby oil | 1.5 | 0.4054 | 0.042 g | 0.06 g | 0.015 g | 0.15 g |
| Foam Shreds | | Pulmonarius | Mar. 3, 2023; Water PolyU Spores A-4-B10-A | | | | (w/DAP) | urea | ferrous | vanillin | BTM |
| | | | 2nd gen Mar. 3, 2023; Water PolyU Spores A- | | | | | | sulfate | | S-25 |
| | | | 4 2nd gen Jan. 27, 2023; Water PolyU Spores | | | | | | | | |
| | | | A-5 2nd | | | | | | | | |
| | | | gen Jan. 27, 2023 | | | | | | | | |
| Polyurethane | 8 | P. | Water PolyU Spores A-B10A-A2 2nd gen | 50 | Baby oil | 1.5 | 0.4054 | 0.042 g | 0.06 g | 0.015 g | 0.15 g |
| Foam Shreds | | Pulmonarius | Mar. 3, 2023; Water PolyU Spores A-4-B10-A | | | | (w/DAP) | urea | ferrous | vanillin | BTM |
| | | | 2nd gen Mar. 3, 2023; Water PolyU Spores A- | | | | | | sulfate | | S-25 |
| | | | 4 2nd gen Jan. 27, 2023; Water PolyU Spores | | | | | | | | |
| | | | A-5 2nd | | | | | | | | |
| | | | gen Jan. 27, 2023 | | | | | | | | |
| Polyurethane | 8 | P. | P-20M-2 Mar. 19, 2021 (2); P-20M02 Mar. 19, 2021 | 50 | Baby oil | 1.5 | 0.4054 | 0.042 g | 0.06 g | 0.015 g | 0.15 g |
| Foam Shreds | | Ostreatus | (3); P-20M-2 Mar. 19, 2021 (4); P-20M-2 drip | | | | (w/DAP) | urea | ferrous | vanillin | BTM |
| | | pearl | 3-19 | | | | | | sulfate | | S-25 |
| | | | 21 (1) | | | | | | | | |
| Polyurethane | 8 | P. | P-20M-2 Mar. 19, 2021 (2); P-20M02 Mar. 19, 2021 | 50 | Baby oil | 1.5 | 0.4054 | 0.042 g | 0.06 g | 0.015 g | 0.15 g |
| Foam Shreds | | Ostreatus | (3); P-20M-2 Mar. 19, 2021 (4); P-20M-2 drip | | | | (w/DAP) | urea | ferrous | vanillin | BTM |
| | | pearl | 3-19 | | | | | | sulfate | | S-25 |
| | | | 21 (1) | | | | | | | | |
| Black | 4 | P. | Water PolyU Spores A-B10A-A2 2nd gen | 50 | Baby oil | 1.5 | 0.4054 | 0.042 g | 0.06 g | 0.015 g | 0.15 g |
| Polyurethane | | Pulmonarius | Mar. 3, 2023; Water PolyU Spores A-4-B10-A | | | | (w/DAP) | urea | ferrous | vanillin | BTM |
| Foam Cubes | | | 2nd gen Mar. 3, 2023; Water PolyU Spores A- | | | | | | sulfate | | S-25 |
| | | | 4 2nd gen Jan. 27, 2023; Water PolyU Spores | | | | | | | | |
| | | | A-5 2nd | | | | | | | | |
| | | | gen Jan. 27, 2023 | | | | | | | | |
| Black | 4 | P. | Water PolyU Spores A-B10A-A2 2nd gen | 50 | Baby oil | 1.5 | 0.4054 | 0.042 g | 0.06 g | 0.015 g | 0.15 g |
| Polyurethane | | Pulmonarius | Mar. 3, 2023; Water PolyU Spores A-4-B10-A | | | | (w/DAP) | urea | ferrous | vanillin | BTM |
| Foam Cubes | | | 2nd gen Mar. 3, 2023; Water PolyU Spores A- | | | | | | sulfate | | S-25 |
| | | | 4 2nd gen Jan. 27, 2023; Water PolyU Spores | | | | | | | | |
| | | | A-5 2nd | | | | | | | | |
| | | | gen Jan. 27, 2023 | | | | | | | | |
| Black | 4 | P. | Water PolyU Spores A-B10A-A2 2nd gen | 50 | Baby oil | 1.5 | 0.4054 | 0.042 g | 0.06 g | 0.015 g | 0.15 g |
| Polyurethane | | Pulmonarius | Mar. 3, 2023; Water PolyU Spores A-4-B10-A | | | | (w/DAP) | urea | ferrous | vanillin | BTM |
| Foam Cubes | | | 2nd gen Mar. 3, 2023; Water PolyU Spores A- | | | | | | sulfate | | S-25 |
| | | | 4 2nd gen Jan. 27, 2023; Water PolyU Spores | | | | | | | | |
| | | | A-5 2nd | | | | | | | | |
| | | | gen Jan. 27, 2023 | | | | | | | | |
| Black | 4 | P. | Water PolyU Spores A-B10A-A2 2nd gen | 50 | Baby oil | 1.5 | 0.4054 | 0.042 g | 0.06 g | 0.015 g | 0.15 g |
| Polyurethane | | Pulmonarius | Mar. 3, 2023; Water PolyU Spores A-4-B10-A | | | | (w/DAP) | urea | ferrous | vanillin | BTM |
| Foam Cubes | | | 2nd gen Mar. 3, 2023; Water PolyU Spores A- | | | | | | sulfate | | S-25 |
| | | | 4 2nd gen Jan. 27, 2023; Water PolyU Spores | | | | | | | | |
| | | | A-5 2nd | | | | | | | | |
| | | | gen Jan. 27, 2023 | | | | | | | | |
| Polyurethane | 8 | P. | Water PolyU Spores A-B10A-A2 2nd gen | 50 | Baby oil | 1.5 | 0.4054 | 0.042 g | 0.06 g | 0.015 g | 0.105 g |
| Foam Shreds | | Pulmonarius | Mar. 3, 2023; Water PolyU Spores A-4-B10-A | | | | (w/DAP) | urea | ferrous | vanillin | BTM |
| | | | 2nd gen Mar. 3, 2023; Water PolyU Spores A- | | | | | | sulfate | | S-25 |
| | | | 4 2nd gen Jan. 27, 2023; Water PolyU Spores | | | | | | | | |
| | | | A-5 2nd | | | | | | | | |
| | | | gen Jan. 27, 2023 | | | | | | | | |
| Polyurethane | 8 | P. | Water PolyU Spores A-B10A-A2 2nd gen | 50 | Baby oil | 1.5 | 0.4054 | 0.042 g | 0.06 g | 0.015 g | 0.105 g |
| Foam Shreds | | Pulmonarius | Mar. 3, 2023; Water PolyU Spores A-4-B10-A | | | | (w/DAP) | urea | ferrous | vanillin | BTM |
| | | | 2nd gen Mar. 3, 2023; Water PolyU Spores A- | | | | | | sulfate | | S-25 |
| | | | 4 2nd gen Jan. 27, 2023; Water PolyU Spores | | | | | | | | |
| | | | A-5 2nd | | | | | | | | |
| | | | gen Jan. 27, 2023 | | | | | | | | |
| Polyurethane | 8 | P. | Water PolyU Spores A-B10A-A2 2nd gen | 50 | Baby oil | 1.5 | 0.4054 | 0.042 g | 0.06 g | 0.015 g | 0.105 g |
| Foam Shreds | | Pulmonarius | Mar. 3, 2023; Water PolyU Spores A-4-B10-A | | | | (w/DAP) | urea | ferrous | vanillin | BTM |
| | | | 2nd gen Mar. 3, 2023; Water PolyU Spores A- | | | | | | sulfate | | S-25 |
| | | | 4 2nd gen Jan. 27, 2023; Water PolyU Spores | | | | | | | | |
| | | | A-5 2nd | | | | | | | | |
| | | | gen Jan. 27, 2023 | | | | | | | | |
| Polyurethane | 8 | P. | Water PolyU Spores A-B10A-A2 2nd gen | 50 | Baby oil | 1.5 | 0.4054 | 0.042 g | 0.06 g | 0.015 g | 0.105 g |
| Foam Shreds | | Pulmonarius | Mar. 3, 2023; Water PolyU Spores A-4-B10-A | | | | (w/DAP) | urea | ferrous | vanillin | BTM |
| | | | 2nd gen Mar. 3, 2023; Water PolyU Spores A- | | | | | | sulfate | | S-25 |
| | | | 4 2nd gen Jan. 27, 2023; Water PolyU Spores | | | | | | | | |
| | | | A-5 2nd | | | | | | | | |
| | | | gen Jan. 27, 2023 | | | | | | | | |

**indicates no growth

Those skilled in the art will recognize, or be able to ascertain, using no more than routine experimentation, numerous equivalents to the specific substances and procedures described herein. Such equivalents are considered to be within the scope of this invention and are covered by the following claims.

### EQUIVALENTS

Those skilled in the art will recognize, or be able to ascertain, using no more than routine experimentation, numerous equivalents to the specific substances and procedures described herein. Such equivalents are considered to be within the scope of this invention and are covered by the following claims.

What is claimed is:

1. A non-biomass nutrient-cultivating substrate comprising an inorganic carrier material and an abiotic nutrient mixture, wherein the nutrient mixture comprises water and at least one non-biomass carbon source.

2. The substrate of claim 1, wherein the inorganic carrier material comprises a porous material.

3. The substrate of claim 1, wherein the inorganic carrier material comprises mineral wool, zeolite, mesoporous metal oxides, fiberglass, vermiculite, a synthetic polymer, or a combination thereof.

4. The substrate of claim 3, wherein the synthetic polymer comprises polyurethane.

5. The substrate of claim 1, wherein the nutrient mixture further comprises a nitrogen source, a promoter, an emulsifier, a micronutrient source, an acidifier, or a combination thereof.

6. The substrate of claim 1, wherein the carbon source comprises a hydrocarbon.

7. The substrate of claim 6, wherein the hydrocarbon comprises mineral oil, paraffin, petroleum, a petroleum product, or a combination thereof.

8. The substrate of claim 5, wherein the nitrogen source comprises urea.

9. The substrate of claim 5, wherein the micronutrient source comprises an iron source, a phosphorus source, a calcium source, a potassium source, a sodium source, a chloride source, a magnesium source, a zinc source, an iodine source, a sulfur source, a cobalt source, a copper source, a fluoride source, a manganese source, a selenium source, a boron source, or a combination thereof.

10. The substrate of claim 5, wherein the promoter comprises non-biomass vanillin, iron, or a combination thereof.

11. The substrate of claim 5, wherein the acidifier comprises ferrous sulfate.

12. A nutrient production system comprising an inorganic carrier material, an abiotic nutrient mixture, and a metabolization source, wherein the abiotic nutrient mixture comprises water and at least one non-biomass carbon source.

13. The system of claim 12, wherein the inorganic carrier material comprises mineral wool, zeolite, mesoporous metal oxides, fiberglass, vermiculite, or a synthetic polymer.

14. The system of claim 12, wherein the abiotic nutrient mixture further comprises a nitrogen source, a promoter, an emulsifier, a mineral source, or a combination thereof.

15. The system of claim 12, wherein the metabolization source comprises source comprises a saprophytic organism.

16. The system of claim 15, wherein the saprophytic organism comprises mold, mushroom, yeast, penicillium, and mucor, or a combination thereof.

17. The system of claim 16, wherein the mushroom comprises an oyster mushroom, Pleurotus ostreatus, Pleurotus pulmonarius, Ganoderma lucidum, Pleurotus columbinus, Pleurotus diamor, Pleurotus eryngii, Amillaria gallica, Cantharellus cibarius, honey mushroom, white-rot fungi, Lentinula edodes, or a shiitake mushroom.

18. A method of producing a food product, the method comprising:
producing the nutrient mixture of claim 1, wherein the nutrient mixture comprises a non-biomass carbon source;
soaking the inorganic carrier material of claim 1 in the nutrient mixture to create a cultivation substrate; and
cultivating at least one saprophytic organism on the cultivation substrate, wherein the saprophytic organism metabolizes the cultivation substrate to produce a food product.

19. The method of claim 18, wherein the food product comprises the saprophytic organism, a derivative thereof, or a product thereof.

20. The method of claim 19, wherein the derivative or product thereof comprises an oil, a liquid, a gel, a powder, or a combination thereof.
